(19) United States
(12) Patent Application Publication
(10) Pub. No.: US 2017/0050080 A1
(43) Pub. Date: Feb. 23, 2017

(54) PEDALING MEASUREMENT APPARATUS, PEDALING MEASUREMENT SYSTEM, PEDALING MEASUREMENT METHOD, AND RECORDING MEDIUM

(71) Applicant: SEIKO EPSON CORPORATION, Tokyo (JP)

(72) Inventor: Shunichi MIZUOCHI, Matsumoto-shi (JP)

(73) Assignee: SEIKO EPSON CORPORATION, Tokyo (JP)

(21) Appl. No.: 15/233,644

(22) Filed: Aug. 10, 2016

(30) Foreign Application Priority Data
Aug. 19, 2015 (JP) 2015-161614
Sep. 25, 2015 (JP) 2015-187914
Oct. 2, 2015 (JP) 2015-196621

(51) Int. Cl. A63B 24/00; A63B 71/06; G01D 5/00; G01P 15/00; G01P 3/00

(52) U.S. Cl. CPC A63B 24/0062; G01P 15/00; G01P 3/00; G01D 5/00; A63B 71/0619; A63B 2220/44; A63B 2220/833

(57) ABSTRACT

A pedaling measurement apparatus includes an acquisition portion that acquires measured data regarding rotation motion of pedaling, a calculation portion that calculates indexes based on the measured data in correlation with information regarding a rotation angle of the rotation motion, and a display processing portion that displays the indexes in a coordinate system which indicates the rotation angle by using a position in a circumferential direction of a circle centering on the origin, and which indicates the magnitude of a value by using a distance from the origin.

### BACKGROUND

1. Technical Field

The present invention relates to a pedaling measurement apparatus, a pedaling measurement system, a pedaling measurement method, and a recording medium.

2. Related Art

JP-A-2014-8789 discloses a pedaling state measurement apparatus which measures a rotation angle and rotation angular velocity by using a sensor unit provided on a crank of a bicycle, and displays variations in rotation angular velocity and variations in rotation angular acceleration which vary at each rotation angle as indexes. In this device, angular velocity or the like for each angle of the crank is computed, and is displayed in a graph in which the angle of the crank is expressed on a transverse axis, and the angular velocity or the like of the crank is expressed on a longitudinal axis (refer to FIG. 7 in JP-A-2014-8789).

The graph in JP-A-2014-8789 exhibits variations in the rotation angular acceleration at each rotation angle of the crank in a time series in a horizontal direction. However, it is hard for a user to intuitively understand a relationship between the crank rotation angular acceleration, and positions and attitudes of the legs performing pedaling, from such a graph. It is hard for the user to image positions and attitudes of the legs, for example, when the crank rotation angular acceleration is abnormal.

Acceleration is applied to the crank in order to change a traveling speed of a bicycle at the time of starting or stopping the bicycle. However, since the acceleration is not taken into consideration in the device disclosed in JP-A-2014-8789, there is a problem in that the device is applicable to only a bicycle whose body is stationary, such as an ergometer, or cannot present a highly accurate index.

From the graph in JP-A-2014-8789, the user can check whether or not there is rotation unevenness (rotation unevenness of the crank) in the user's pedaling, but hardly knows a cause of the rotation unevenness.

### SUMMARY

An advantage of some aspects of the invention is to solve at least a part of the problems described above, and the invention can be implemented as the following aspects or application examples.

### Application Example 1

A pedaling measurement apparatus according to this application example includes an acquisition portion that acquires measured data regarding rotation motion of pedaling; a calculation portion that calculates indexes based on the measured data in correlation with information regarding a rotation angle of the rotation motion; and a display processing portion that displays the indexes in a coordinate system which indicates the rotation angle by using a position in a circumferential direction of a circle centering on the origin, and which indicates the magnitude of a value by using a distance from the origin.

According to this application example, indexes at each rotation angle, regarding rotation motion of pedaling are annularly displayed, and thus a user can intuitively and easily understand a pedaling action. The user can intuitively and easily recognize the magnitude of values of the indexes at each rotation angle.

### Application Example 2

In the pedaling measurement apparatus according to the application example, a reference position for a rotation angle of a crank may match a reference position for a rotation angle in the coordinate system.

According to this application example, a user can intuitively and easily image a position or an attitude of the leg thereof used for pedaling.

### Application Example 3

In the pedaling measurement apparatus according to the application example, the indexes may include an angular velocity, and the distance from the origin may indicate the angular velocity.

According to this application example, a user can intuitively and easily recognize an angular velocity at each rotation angle.

### Application Example 4

In the pedaling measurement apparatus according to the application example, the indexes may include an angular acceleration, and the distance from the origin may indicate the angular acceleration.

According to this application example, a user can intuitively and easily recognize an angular acceleration at each rotation angle.

### Application Example 5

In the pedaling measurement apparatus according to the application example, the calculation portion may calculates at least one of an average value, a median, and a most frequent value of the indexes at each rotation angle for a plurality of rotations, and the display processing portion may dispose at least one of the average value, the median, and the most frequent value of the indexes in the coordinate system.

According to this application example, a user can intuitively and easily recognize an average value or the like of angular velocities or angular accelerations at each rotation angle.

### Application Example 6

The pedaling measurement apparatus according to the application example may further include a determination portion that determines a first index which is more than or less than a predetermined threshold value among the indexes for the respective rotation angles, and the display processing portion may perform a notification of a position of the first index in the coordinate system.

According to this application example, a user can easily recognize a rotation angle at which an index is abnormal.

### Application Example 7

In the pedaling measurement apparatus according to the application example, the display processing portion may display an image for specifying a rotation angle corresponding to the position of the first index.

According to this application example, a user can easily recognize a rotation angle at which an index is abnormal among 360 degrees.

### Application Example 8

In the pedaling measurement apparatus according to the application example, the display processing portion may display the first index in an aspect which is different from aspects of other indexes.

According to this application example, a user can easily recognize a position of an abnormal index among indexes which are annularly displayed.

### Application Example 9

In the pedaling measurement apparatus according to the application example, the acquisition portion may acquire a comparative target index for a rotation, and the display processing portion may dispose the comparative target index in the coordinate system.

According to this application example, for example, indexes regarding a pedaling action of a user and indexes regarding a pedaling action of other users can be comparatively presented to the user.

### Application Example 10

In the pedaling measurement apparatus according to the application example, the calculation portion may calculate the indexes for a plurality of rotations, and the display processing portion may dispose the indexes for the plurality of rotations in the coordinate system.

According to this application example, a user can intuitively and easily recognize pedaling actions for a plurality of rotations.

### Application Example 11

In the pedaling measurement apparatus according to the application example, the calculation portion may calculate an offset target value on the basis of the indexes, and offset the indexes by using the offset target value, and the display processing portion may correlate the origin with the offset target value.

According to this application example, it is possible to more clearly display a difference between magnitudes of indexes at each rotation angle.

### Application Example 12

In the pedaling measurement apparatus according to the application example, the calculation portion may calculate variation extents of the indexes at each rotation angle for a plurality of rotations, and the display processing portion may display the variation extents in correlation with the rotation angles.

According to this application example, a user can objectively recognize a variation in an index.

### Application Example 13

The pedaling measurement apparatus according to the application example may further include a determination portion that determines a first variation extent which is larger than or less than a predetermined threshold value among the variation extents, and the display processing portion may perform a notification of a position of a rotation angle corresponding to the first variation extent.

According to this application example, a user can easily recognize a rotation angle at which a variation is abnormal.

### Application Example 14

The pedaling measurement apparatus according to the application example may further include a determination portion that determines whether or not at least some of the plurality of indexes satisfy a predetermined condition, and the display processing portion may output advice information corresponding to the predetermined condition in a case where there is an index satisfying the predetermined condition.

According to this application example, a user can recognize points to be improved by the user depending on the way of pedaling.

### Application Example 15

In the pedaling measurement apparatus according to the application example, the acquisition portion may acquire second measured data related to motion of a user or a bicycle, the calculation portion may calculate a second index regarding the motion of the user or the bicycle on the basis of the second measured data, and the display processing portion may display the second index.

According to this application example, a user can recognize motion of a part of the user's body regarding pedaling action.

### Application Example 16

In the pedaling measurement apparatus according to the application example, the calculation portion may correlate the indexes at the rotation angles and the second index with time points, and the display processing portion may display a position of the second index in correlation with the position of the first index on the basis of the time points.

According to this application example, a user can recognize motion of a part of the user's body at each rotation angle.

### Application Example 17

A pedaling measurement method according to this application example includes acquiring measured data regarding rotation motion of pedaling; calculating indexes based on the measured data in correlation with information regarding a rotation angle of the rotation motion; and displaying the indexes in a coordinate system which indicates the rotation angle by using a position in a circumferential direction of a circle centering on the origin, and which indicates the magnitude of a value by using a distance from the origin.

According to this application example, indexes at each rotation angle, regarding rotation motion of pedaling are annularly displayed, and thus a user can intuitively and easily understand a pedaling action. The user can intuitively and easily recognize the magnitude of values of the indexes at each rotation angle.

### Application Example 18

A pedaling measurement system according to this application example includes a sensor unit that measures rotation motion of pedaling; and a measurement apparatus, in which the measurement apparatus includes an acquisition portion that acquires measured data regarding the rotation motion from the sensor unit; a calculation portion that calculates indexes based on the measured data in correlation with information regarding a rotation angle of the rotation motion; and a display processing portion that displays the indexes in a coordinate system which indicates the rotation angle by using a position in a circumferential direction of a circle centering on the origin, and which indicates the magnitude of a value by using a distance from the origin.

According to this application example, indexes at each rotation angle, regarding rotation motion of pedaling are annularly displayed, and thus a user can intuitively and easily understand a pedaling action. The user can intuitively and easily recognize the magnitude of values of the indexes at each rotation angle.

### Application Example 19

A recording medium storing program according to this application example causes a computer to execute a procedure of acquiring measured data regarding rotation motion of pedaling; a procedure of calculating indexes based on the measured data in correlation with information regarding a rotation angle of the rotation motion; and a procedure of displaying the indexes in a coordinate system which indicates the rotation angle by using a position in a circumferential direction of a circle centering on the origin, and which indicates the magnitude of a value by using a distance from the origin.

According to this application example, indexes at each rotation angle, regarding rotation motion of pedaling are annularly displayed, and thus a user can intuitively and easily understand a pedaling action. The user can intuitively and easily recognize the magnitude of values of the indexes at each rotation angle.

### Application Example 20

A pedaling measurement apparatus according to this application example includes an acquisition portion that acquires outputs from an acceleration sensor and an angular velocity sensor detecting motion of a crank of a bicycle; a calculation portion that calculates an angle of the crank on the basis of the outputs from the angular velocity sensor; and an angle correction portion that corrects an angle of the crank on the basis of the outputs from the acceleration sensor at stoppage or during constant velocity traveling of the bicycle.

An angle based on outputs from the angular velocity sensor requires an integration process. Thus, if calculation of an angle is continuously performed (that is, the number of integration processes increases), an angle error may possibly be accumulated. On the other hand, the outputs from the acceleration sensor do not indicate an angle of the crank when the bicycle is accelerated, but may accurately indicate an angle of the crank when the bicycle is not accelerated. Therefore, the angle correction portion corrects the angle of the crank on the basis of the outputs from the acceleration sensor at stoppage or during constant velocity traveling of the bicycle. As a result, the pedaling measurement apparatus can reduce an angle error accumulated in the angle at least at a timing at which the bicycle is stopped or is traveling at a constant velocity. Therefore, the pedaling measurement apparatus can measure rotation motion of the crank of the bicycle accompanied by acceleration, that is, rotation motion of the crank of the bicycle which is traveling on a field, with high accuracy.

### Application Example 21

A pedaling measurement apparatus according to this application example includes an acquisition portion that acquires outputs from an acceleration sensor and an angular velocity sensor detecting motion of a crank of a bicycle; a calculation portion that calculates an angle of the crank on the basis of the outputs from the angular velocity sensor; and a bias correction portion that performs bias correction on the outputs from the angular velocity sensor on the basis of the outputs from the acceleration sensor at stoppage or during constant velocity traveling of the bicycle.

Outputs from the angular velocity sensor may include a bias. Thus, if calculation of an angle is continuously performed (that is, the number of integration processes increases), an angle error may possibly be accumulated. On the other hand, the outputs from the acceleration sensor do not indicate an angle of the crank when the bicycle is accelerated, but may accurately indicate the extent of the bias when the bicycle is not accelerated. Therefore, the bias correction portion performs bias correction on the outputs from the angular velocity sensor on the basis of the outputs from the acceleration sensor at stoppage or during constant velocity traveling of the bicycle. As a result, the pedaling measurement apparatus can reduce a bias occurring in the outputs from the angular velocity sensor at least at a timing at which the bicycle is stopped or is traveling at a constant velocity. Therefore, the pedaling measurement apparatus can measure rotation motion of the crank of the bicycle accompanied by acceleration, that is, rotation motion of the crank of the bicycle which is traveling on a field, with high accuracy.

### Application Example 22

In the pedaling measurement apparatus according to the application example, the angle correction potion may obtain an average value or a weighted average value of an angle of the crank calculated on the basis of the outputs from the acceleration sensor and an angle of the crank calculated on the basis of the outputs from the angular velocity sensor at stoppage or during constant velocity traveling of the bicycle, as a corrected angle of the crank.

As mentioned above, if an average value or a weighted average value of the angle of the crank calculated on the basis of the outputs from the acceleration sensor and an angle of the crank calculated on the basis of the outputs from the angular velocity sensor is obtained as a corrected angle of the crank, it is possible to reduce the occurrence of a steep step difference in a temporal change curve of the angle of the crank.

### Application Example 23

In the pedaling measurement apparatus according to the application example, the bias correction potion may obtain a change amount per unit time of a difference between an angle of the crank calculated on the basis of the outputs from the acceleration sensor and an angle of the crank calculated on the basis of the outputs from the angular velocity sensor at stoppage or during constant velocity traveling of the bicycle, as a bias value included in the outputs from the angular velocity sensor.

As mentioned above, if a change amount per unit time of a difference between an angle of the crank calculated on the basis of the outputs from the acceleration sensor and an angle of the crank calculated on the basis of the output from the angular velocity sensor is obtained as a bias value, it is possible to perform bias correction with high accuracy.

### Application Example 24

The pedaling measurement apparatus according to the application example may further include a determination portion that determines that the bicycle is stopped or is traveling at a constant velocity in a case of detecting that accelerations other than the gravitational acceleration are not generated in the crank on the basis of the outputs from the acceleration sensor.

Therefore, it is possible to use the outputs from the acceleration sensor for determination of whether or not the bicycle is stopped or is traveling at a constant velocity.

### Application Example 25

In the pedaling measurement apparatus according to the application example, the acquisition portion may further acquire a velocity of the bicycle calculated on the basis of a positioning signal, and the pedaling measurement apparatus may further include a determination portion that determines that the bicycle is stopped or is traveling at a constant velocity in a case of detecting that a velocity of the bicycle is equal to or less than a predetermined threshold value or an acceleration of the bicycle is equal to or less than a predetermined threshold value.

Therefore, it is possible to use the positioning signal for determination of whether or not the bicycle is stopped or is traveling at a constant velocity.

### Application Example 26

In the pedaling measurement apparatus according to the application example, detection axes of the acceleration sensor and the angular velocity sensor may be present on a rotation shaft of the crank or an extension line of the rotation shaft.

Therefore, it is possible to obtain an angle of the crank based on outputs from the acceleration sensor, an angle of the crank based on outputs from the angular velocity sensor, or a state of the bicycle based on the outputs from the acceleration sensor, through simple computation.

### Application Example 27

According to this application example, there is provided a pedaling measurement system including the pedaling measurement apparatus; and the acceleration sensor and the angular velocity sensor.

### Application Example 28

A pedaling measurement method according to this application example includes an acquisition procedure of acquiring outputs from an acceleration sensor and an angular velocity sensor detecting motion of a crank of a bicycle; a calculation procedure of calculating an angle of the crank on the basis of the outputs from the angular velocity sensor; and an angle correction procedure of correcting an angle of the crank on the basis of the outputs from the acceleration sensor at stoppage or during constant velocity traveling of the bicycle.

### Application Example 29

A pedaling measurement method according to this application example includes an acquisition procedure of acquiring outputs from an acceleration sensor and an angular velocity sensor detecting motion of a crank of a bicycle; a calculation procedure of calculating an angle of the crank on the basis of the outputs from the angular velocity sensor; and a bias correction procedure of performing bias correction on the outputs from the angular velocity sensor on the basis of the outputs from the acceleration sensor at stoppage or during constant velocity traveling of the bicycle.

### Application Example 30

A pedaling measurement program according to this application example causes a computer to execute an acquisition procedure of acquiring outputs from an acceleration sensor and an angular velocity sensor detecting motion of a crank of a bicycle; a calculation procedure of calculating an angle of the crank on the basis of the outputs from the angular velocity sensor; and an angle correction procedure of correcting an angle of the crank on the basis of the outputs from the acceleration sensor at stoppage or during constant velocity traveling of the bicycle.

### Application Example 31

A pedaling measurement program according to this application example causes a computer to execute an acquisition procedure of acquiring outputs from an acceleration sensor and an angular velocity sensor detecting motion of a crank of a bicycle; a calculation procedure of calculating an angle of the crank on the basis of the outputs from the angular velocity sensor; and a bias correction procedure of performing bias correction on the outputs from the angular velocity sensor on the basis of the outputs from the acceleration sensor at stoppage or during constant velocity traveling of the bicycle.

### Application Example 32

A recording medium according to this application example stores a pedaling measurement program causing a computer to execute an acquisition procedure of acquiring outputs from an acceleration sensor and an angular velocity sensor detecting motion of a crank of a bicycle; a calculation procedure of calculating an angle of the crank on the basis of the outputs from the angular velocity sensor; and an angle correction procedure of correcting an angle of the crank on the basis of the outputs from the acceleration sensor at stoppage or during constant velocity traveling of the bicycle.

### Application Example 33

A recording medium according to this application example stores a pedaling measurement program causing a computer to execute an acquisition procedure of acquiring outputs from an acceleration sensor and an angular velocity sensor detecting motion of a crank of a bicycle; a calculation procedure of calculating an angle of the crank on the basis of the outputs from the angular velocity sensor; and a bias correction procedure of performing bias correction on the outputs from the angular velocity sensor on the basis of the outputs from the acceleration sensor at stoppage or during constant velocity traveling of the bicycle.

### Application Example 34

A pedaling measurement apparatus according to this application example includes an acquisition portion that acquires outputs from an inertial sensor detecting motion of a pedal of a bicycle; and a first calculation portion that calculates an attitude of the pedal by using angular velocity information which is output from the inertial sensor.

Rotation unevenness of a crank occurring during pedaling of the bicycle may be related to fluctuation in an attitude of the ankle occurring during the pedaling. There is a strong relation between an attitude of the ankle and an attitude of the pedal. Therefore, the first calculation portion calculates an attitude of the pedal by using outputs from the inertial sensor. Thus, the pedaling measurement apparatus can acquire an index useful for analysis of pedaling. A mounting location (fixation location) of the inertial sensor is, for example, the pedal of the bicycle or the foot of a user.

### Application Example 35

The pedaling measurement apparatus according to the application example may further include a second calculation portion that calculates a position of the pedal on the basis of the attitude of the pedal and acceleration information which is output from the inertial sensor.

Therefore, the pedaling measurement apparatus can calculate not only an attitude of the pedal but also a position of the pedal.

### Application Example 36

The pedaling measurement apparatus according to the application example may further include a third calculation portion that calculates the rotation center of a crank of the bicycle on the basis of positions of the pedal at a plurality of time points.

Therefore, the pedaling measurement apparatus can calculate the rotation center of the crank without using an inertial sensor which directly detects motion of the crank.

### Application Example 37

The pedaling measurement apparatus according to the application example may further include a fourth calculation portion that calculates an attitude of the crank on the basis of the rotation center and the position of the pedal.

Therefore, the pedaling measurement apparatus can calculate an attitude of the crank without using an inertial sensor which directly detects motion of the crank.

### Application Example 38

The pedaling measurement apparatus according to the application example may further include a fifth calculation portion that calculates a rotation angular velocity of the crank on the basis of time differentiation of the attitude of the crank.

Therefore, the pedaling measurement apparatus can calculate a rotation angular velocity of the crank without using an inertial sensor which directly detects motion of the crank.

### Application Example 39

The pedaling measurement apparatus according to the application example may further include a sixth calculation portion calculates a rotation angular velocity of the crank on the basis of the centripetal acceleration of the pedal obtained by using the acceleration information output from the inertial sensor, the attitude of the crank, and the attitude of the pedal, and a distance from the rotation center to the inertial sensor.

Therefore, the pedaling measurement apparatus can calculate a rotation angular velocity of the crank without using an inertial sensor which directly detects motion of the crank.

### Application Example 40

The pedaling measurement apparatus according to the application example may further include a presentation portion that presents at least some information calculated by the calculation portion to a user.

Therefore, the pedaling measurement apparatus can present at least one of the attitude of the pedal, the position of the pedal, the rotation center of the crank, the attitude of the crank, and the rotation angular velocity of the crank to the user.

### Application Example 41

A pedaling measurement system according to this application example includes the pedaling measurement apparatus; and the inertial sensor.

Therefore, for example, if a user mounts the inertial sensor on the pedal or the foot of the user, the pedaling measurement system can acquire an index (an attitude of the pedal) useful for analysis of pedaling.

### Application Example 42

A pedaling measurement method according to this application example includes an acquisition procedure of acquiring outputs from an inertial sensor detecting motion of a pedal of a bicycle; and a first calculation procedure of calculating an attitude of the pedal by using angular velocity information which is output from the inertial sensor.

Rotation unevenness of a crank occurring during pedaling of the bicycle may be related to fluctuation in an attitude of the ankle occurring during the pedaling. There is a strong relation between an attitude of the ankle and an attitude of the pedal. Therefore, in the first calculation procedure, an attitude of the pedal is calculated by using outputs from the inertial sensor. Thus, according to the pedaling measurement method, it is possible to acquire an index useful for analysis of pedaling.

### Application Example 43

A pedaling measurement program according to this application example causes a computer to execute an acquisition procedure of acquiring outputs from an inertial sensor detecting motion of a pedal of a bicycle; and a first calculation procedure of calculating an attitude of the pedal by using angular velocity information which is output from the inertial sensor.

Rotation unevenness of a crank occurring during pedaling of the bicycle may be related to fluctuation in an attitude of the ankle occurring during the pedaling. There is a strong relation between an attitude of the ankle and an attitude of the pedal. Therefore, in the first calculation procedure, an attitude of the pedal is calculated by using outputs from the inertial sensor. Thus, the computer can acquire an index useful for analysis of pedaling.

### Application Example 44

A recording medium according to this application example stores a pedaling measurement program causing a computer to execute an acquisition procedure of acquiring outputs from an inertial sensor detecting motion of a pedal of a bicycle; and a first calculation procedure of calculating an attitude of the pedal by using angular velocity information which is output from the inertial sensor.

Rotation unevenness of a crank occurring during pedaling of the bicycle may be related to fluctuation in an attitude of the ankle occurring during the pedaling. There is a strong relation between an attitude of the ankle and an attitude of the pedal. Therefore, in the first calculation procedure, an attitude of the pedal is calculated by using outputs from the inertial sensor. Thus, the computer can acquire an index useful for analysis of pedaling.

### Application Example 45

A display apparatus according to this application example includes a display portion that simultaneously displays information indicating an attitude of a pedal of a bicycle and information indicating rotation unevenness of a crank of the bicycle on the same screen by using angular velocity information which is output from an inertial sensor detecting motion of the pedal of the bicycle.

Rotation unevenness of a crank occurring during pedaling of the bicycle may be related to fluctuation in an attitude of the ankle occurring during the pedaling. There is a strong relation between an attitude of the ankle and an attitude of the pedal. Therefore, the display portion simultaneously displays the rotation unevenness of the crank and the attitude of the pedal on the same screen by using the outputs from the inertial sensor. Thus, the display apparatus of the application example can present an index useful for analysis of pedaling.

### Application Example 46

A display method according to this application example includes a display procedure of simultaneously displaying information indicating an attitude of a pedal of a bicycle and information indicating rotation unevenness of a crank of the bicycle on the same screen by using angular velocity information which is output from an inertial sensor detecting motion of the pedal of the bicycle.

Rotation unevenness of a crank occurring during pedaling of the bicycle may be related to fluctuation in an attitude of the ankle occurring during the pedaling. There is a strong relation between an attitude of the ankle and an attitude of the pedal. Therefore, in the display procedure, the rotation unevenness of the crank and the attitude of the pedal are simultaneously displayed on the same screen by using the outputs from the inertial sensor. Thus, according to the display method of the application example, it is possible to present an index useful for analysis of pedaling.

### Application Example 47

A display program according to this application example causes a computer to execute a display procedure of simultaneously displaying information indicating an attitude of a pedal of a bicycle and information indicating rotation unevenness of a crank of the bicycle on the same screen by using angular velocity information which is output from an inertial sensor detecting motion of the pedal of the bicycle.

Rotation unevenness of a crank occurring during pedaling of the bicycle may be related to fluctuation in an attitude of the ankle occurring during the pedaling. There is a strong relation between an attitude of the ankle and an attitude of the pedal. Therefore, in the display procedure, the rotation unevenness of the crank and the attitude of the pedal are simultaneously displayed on the same screen by using the outputs from the inertial sensor. Thus, the computer can present an index useful for analysis of pedaling.

### Application Example 48

A recording medium according to this application example stores a display program causing a computer to execute a display procedure of simultaneously displaying information indicating an attitude of a pedal of a bicycle and information indicating rotation unevenness of a crank of the bicycle on the same screen by using angular velocity information which is output from an inertial sensor detecting motion of the pedal of the bicycle.

Rotation unevenness of a crank occurring during pedaling of the bicycle may be related to fluctuation in an attitude of the ankle occurring during the pedaling. There is a strong relation between an attitude of the ankle and an attitude of the pedal. Therefore, in the display procedure, the rotation unevenness of the crank and the attitude of the pedal are simultaneously displayed on the same screen by using the outputs from the inertial sensor. Thus, the computer can present an index useful for analysis of pedaling.

### BRIEF DESCRIPTION OF THE DRAWINGS

The invention will be described with reference to the accompanying drawings, wherein like numbers reference like elements.

FIG. 1 is a diagram illustrating an example of a configuration of a pedaling measurement system according to a first embodiment of the invention.

FIG. 2 is a block diagram illustrating an example of a functional configuration of the pedaling measurement system.

FIG. 3 is a diagram for explaining an example of a rotation angle of a crank.

FIG. 4 is a diagram illustrating an example of a screen displayed by a measurement apparatus.

FIG. 5 is a diagram illustrating another example of a screen displayed by the measurement apparatus.

FIG. 6 is a diagram illustrating still another example of a screen displayed by the measurement apparatus.

FIG. 7 is a diagram illustrating still another example of a screen displayed by the measurement apparatus.

FIG. 8 is a diagram illustrating still another example of a screen displayed by the measurement apparatus.

FIG. 9 is a flowchart illustrating an example of a calculation process in the measurement apparatus.

FIG. 10 is a flowchart illustrating an example of a display process in the measurement apparatus.

FIG. 11 is a diagram illustrating an example of a configuration of a pedaling measurement system according to a second embodiment of the invention.

FIG. 12 is a block diagram illustrating an example of a functional configuration of the pedaling measurement system.

FIG. 13 is a diagram illustrating an example of a screen displayed by a measurement apparatus.

FIG. 14 is a diagram illustrating another example of a screen displayed by the measurement apparatus.

FIG. 15 is a diagram illustrating an outline of a pedaling analysis system according to a third embodiment.

FIG. 16 is a diagram illustrating examples of a position at which and a direction in which a sensor unit is mounted on a crank.

FIG. 17 is a diagram illustrating procedures of actions performed by a user.

FIG. 18 is a diagram illustrating a configuration example of the pedaling analysis system according to the third embodiment.

FIG. 19 is a diagram illustrating a state of the crank at a reference angle.

FIG. 20 is a diagram illustrating an example of an angle Θ of the crank.

FIG. 21 is a diagram illustrating a display example of a pedaling analysis result.

FIG. 22 is a flowchart illustrating examples of procedures of a pedaling analysis process.

FIG. 23 is a flowchart illustrating examples of procedures of a process of determining a stoppage state or a constant velocity traveling state.

FIG. 24 is a flowchart illustrating examples of procedures of an angle correction process.

FIG. 25 is a flowchart illustrating examples of procedures of a bias value calculation process.

FIG. 26 is a diagram illustrating a configuration example of a pedaling analysis system according to a fourth embodiment.

FIG. 27 is a flowchart illustrating examples of procedures of determining a stoppage state or a constant velocity traveling state.

FIG. 28 is a diagram illustrating an outline of a pedaling analysis system according to a fifth embodiment.

FIG. 29 is a diagram illustrating examples of a position at which and a direction in which a sensor unit is mounted on a pedal.

FIG. 30 is a diagram illustrating procedures of actions performed by a user.

FIG. 31 is a diagram illustrating a configuration example of the pedaling analysis system according to the fifth embodiment.

FIG. 32 is a diagram for explaining an angle θₚ of the pedal and an angle θ_{c} of a crank.

FIG. 33 is a diagram for explaining a rotation center position x₀ of the crank, and a distance (rotation radius r) from the rotation center position x₀ to a sensor unit.

FIG. 34 is a diagram illustrating a relationship among a direction of the centripetal acceleration, a direction of the gravitational acceleration, and the angles θ_{c} and θₚ.

FIG. 35 is a diagram illustrating an example of a display screen of pedaling analysis data.

FIG. 36 is a diagram illustrating another example of a display screen of pedaling analysis data.

FIG. 37 is a flowchart illustrating examples of procedures of a pedaling analysis process.

FIG. 38 is a flowchart illustrating examples of procedures of a process of calculating indexes regarding the crank and the pedal.

FIG. 39 is a diagram illustrating a configuration example of a pedaling analysis system according to a sixth embodiment.

FIG. 40 is a flowchart illustrating examples of procedures of a process of calculating indexes regarding a crank and/or a pedal according to the sixth embodiment.

FIG. 41 is a diagram illustrating a mounting example of a sensor unit according to a seventh embodiment.

FIG. 42 is a diagram illustrating an example of measurable information according to the seventh embodiment.

### DESCRIPTION OF EXEMPLARY EMBODIMENTS

Hereinafter, preferred embodiments of the invention will be described in detail with reference to the drawings. The embodiments described below are not intended to improperly limit the content of the invention disclosed in the appended claims. It cannot be said that all constituent elements described below are essential constituent elements of the invention.

### 1. First Embodiment

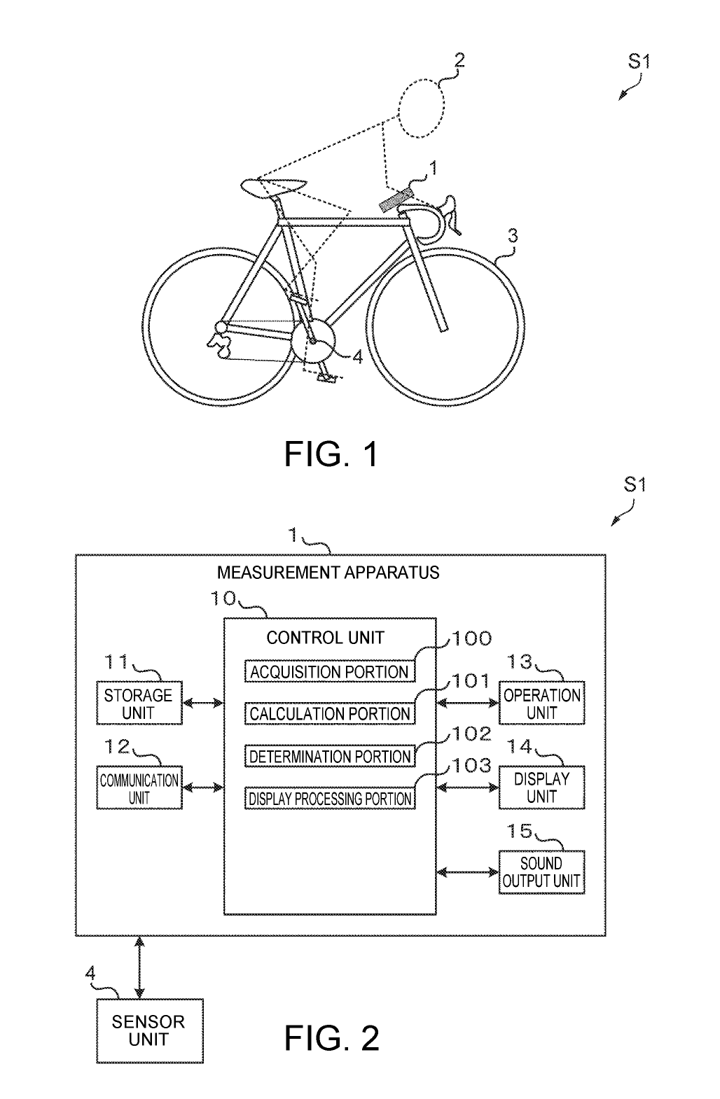

FIG. 1 is a diagram illustrating an example of a configuration of a pedaling measurement system according to a first embodiment. FIG. 1 illustrates a bicycle 3 and a user (driver) 2 riding the bicycle 3.

A pedaling measurement system S1 includes a measurement apparatus 1 (corresponding to a pedaling measurement apparatus according to the invention) and a sensor unit 4. The measurement apparatus 1 and the sensor unit 4 are mounted on the bicycle 3. The measurement apparatus 1 may be mounted on the user 2, and may be provided at a location separated from the bicycle 3. The measurement apparatus 1 is communicably connected to the sensor unit 4.

The sensor unit 4 measures acceleration and angular velocity caused by motion of a crank of the bicycle 3. The sensor unit 4 is mounted on, for example, a shaft of the crank of the bicycle 3. The sensor unit 4 may be mounted on other locations such as the crank or a pedal of the bicycle 3 as long as the motion of the crank can be measured. The sensor unit 4 includes, for example, an acceleration sensor (not illustrated) and an angular velocity sensor (not illustrated). The sensor unit 4 measures acceleration and angular velocity, for example, at a set sampling cycle, and transmits measured data including the measured acceleration and angular velocity to the measurement apparatus 1.

The measurement apparatus 1 may be constituted of a portable terminal such as a smart phone or a tablet terminal. The measurement apparatus 1 receives the measured data from the sensor unit 4. The measurement apparatus 1 calculates a rotation angle of the crank on the basis of the received measured data. The measurement apparatus 1 calculates an index such as angular velocity or angular acceleration at each rotation angle. The measurement apparatus 1 displays an image in which calculated indexes are annularly disposed in a time series. Consequently, the user can intuitively and easily understand a pedaling action.

FIG. 2 is a block diagram illustrating an example of a functional configuration of the pedaling measurement system.

The measurement apparatus 1 includes a control unit 10, a storage unit 11, a communication unit 12, an operation unit 13, a display unit 14, and a sound output unit 15.

The storage unit 11 stores data and the like used for a process in the control unit 10. The storage unit 11 may be implemented by a nonvolatile storage device such as a flash read only memory (ROM).

The communication unit 12 receives measured data from the sensor unit 4 and outputs the received measured data to the control unit 10. The communication unit 12 may be implemented by, for example, a communication interface controlling wireless communication.

The operation unit 13 receives an input operation performed by the user 2 such as a driver, and outputs an operation signal corresponding to the operation to the control unit 10. The operation unit 13 may be implemented by an input device such as a key, a touch sensor, or a touch panel.

The display unit 14 displays a processing result in the control unit 10 as text, a graph, a table, animation, and other images. The display unit 14 may be implemented by, for example, a liquid crystal display (LCD) or an organic electroluminescence display (OLED).

The sound output unit 15 outputs a processing result in the control unit 10 as a voice or a buzzer sound. The sound output unit 15 may be implemented by, for example, a speaker or a buzzer.

The control unit 10 integrally controls the measurement apparatus 1. The control unit 10 includes an acquisition portion 100, a calculation portion 101, a determination portion 102, and a display processing portion 103.

The control unit 10 is may be implemented by, for example, a computer including a central processing unit (CPU) which is a calculation device, a random access memory (RAM) which is a volatile storage device, a ROM which is a nonvolatile storage device, an interface (I/F) circuit which connects the control unit 10 to other units, a bus connecting the elements to each other, and the like. The computer may be provided with various processing circuits such as an image processing circuit. The control unit 10 may be implemented by an application specific integrated circuit (ASIC) or the like.

At least some functions of the control unit 10 may be realized by, for example, the CPU reading a predetermined program stored in the ROM to the RAM, and executing the program. The predetermined program is application program which operates on an operating system (OS), and may be read from a portable recording medium so as to be installed in the measurement apparatus 1, or may be downloaded from a server on a network so as to be installed in the measurement apparatus 1. At least some functions of the control unit 10 may be realized by, for example, a dedicated processing circuit. At least some functions of the control unit 10 may be realized by, for example, both of the CPU and the dedicated processing circuit.

The acquisition portion 100 receives measured data from the sensor unit 4 via the communication unit 12. The acquisition portion 100 receives measured data including acceleration and angular velocity, for example, at a set sampling cycle, and stores the measured data in the storage unit 11. The measured data is not limited to the storage unit 11, and may be stored in a storage device such as the above-described RAM.

The calculation portion 101 calculates indexes regarding rotation motion (also referred to as a pedaling action) of the crank on the basis of the received measured data. The indexes are angular velocity and angular acceleration.

The calculation portion 101 calculates a rotation angle on the basis of, for example, the received acceleration. The rotation angle may be determined by using, for example, the magnitude of acceleration in the gravitational direction. A method of calculating the rotation angle is not limited to the method using the gravity. The calculation portion 101 calculates, for example, the received angular velocity as angular velocity at the calculated rotation angle. In the above-described way, the rotation angle and the angular velocity are calculated at each sampling timing.

The calculation portion 101 calculates angular velocity per unit rotation angle (for example, 1 degree) on the basis of, for example, the rotation angle and the angular velocity at each sampling timing. For example, angular velocity at x degrees may be calculated by using an average of angular velocities at respective rotation angles included from x−0.5 degrees to x+0.5 degrees. A method of calculating angular velocity per unit rotation angle is not limited to the method of obtaining an average. In this way, the angular velocity per unit rotation angle is calculated.

The calculation portion 101 calculates angular acceleration per unit rotation angle on the basis of, for example, angular velocities at two consecutive unit rotation angles. For example, angular acceleration at x degrees may be calculated by using a difference between angular velocity at x−1 degrees and angular velocity at x degrees. A method of calculating angular acceleration is not limited to the method of obtaining a difference. In the above-described way, the angular acceleration per unit rotation angle is calculated.

The calculation portion 101 calculates angular velocity at each rotation angle (sampling timing), and angular velocity and angular acceleration per unit rotation angle, for a plurality of rotations, in the above-described manner. The calculation portion 101 may calculate a rotation angle average and an angular acceleration average per unit rotation angle on the basis of the angular velocity and the angular acceleration per unit rotation angle for a plurality of rotations.

The calculation portion 101 may calculate the variation extent of angular velocity per unit rotation angle for a plurality of rotations. As the variation extent of angular velocity, for example, a standard deviation of a plurality of angular velocities at the same angle may be used. A method of calculating the variation extent is not limited to using a standard deviation. The calculation portion 101 may calculate the variation extent of angular acceleration per unit rotation angle for a plurality of rotations.

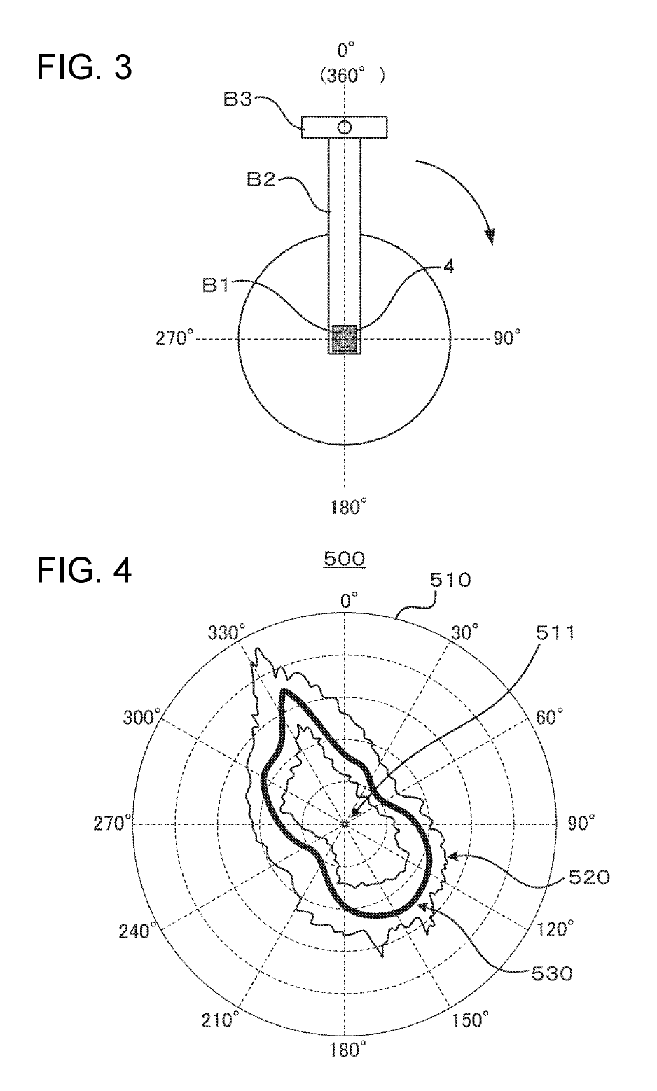

The calculation portion 101 converts the above-described rotation angle into a rotation angle with a predetermined position of the crank as a reference. For example, as illustrated in FIG. 3 (diagram for explaining an example of a rotation angle of the crank), a case is assumed in which the sensor unit 4 is mounted on a crank shaft B1 on the right side of the bicycle 3 (the right side of the user 2). A crank B2 is rotated clockwise with the crank shaft B1 as a central axis. A pedal B3 is provided at the crank B2 on an opposite side to the crank shaft B1.

As a reference position (a direction of 0 degrees) of the crank B2, a position where the pedal B3 comes uppermost may be used. This position is also a position where the right foot of the user 2 comes uppermost (a position where the left foot comes lowermost). The calculation portion 101 specifies a rotation angle corresponding to 0 degrees which is a reference among the respective rotation angles calculated as described above, and sets rotation angles with 0 degrees as a start position in the respective rotation angles. The calculation portion 101 may specify an angle at which acceleration in the gravitational direction is the maximum on the basis of, for example, acceleration, and may specify the angle as a rotation angle at 0 degrees. The sensor unit 4 may be mounted on the crank shaft B1 so that one axis of the acceleration sensor is along the vertical direction when the crank B2 is at 0 degrees. A method of determining a reference position is not limited to the method using the gravity. In the above-described way, indexes such as angular velocity or angular acceleration are correlated with an actual rotation angle of the crank with 0 degrees as a reference.

The calculation portion 101 calculates offset target values of the angular velocity and the angular acceleration per unit rotation angle. The offset target values are used for a display process of the angular velocity and the angular acceleration. The calculation portion 101 selects the lowest value from among angular velocities per unit rotation angle within a predetermined period of time such as the latest one minute, and sets the lowest value as the offset target value of the angular velocity. The calculation portion 101 selects the lowest value from among angular accelerations per unit rotation angle within a predetermined period of time such as the latest one minute, and sets the lowest value as the offset target value of the angular acceleration. The offset target value is not limited to the lowest value, and may be, for example, a value such as an average value within a period of time, a set threshold value. The threshold value may be set by the user 2 via, for example, the operation unit 13. The offset target value of the angular velocity may be set on the basis of angular velocity at each rotation angle (sampling timing).

The determination portion 102 determines whether or not the calculated index satisfies a predetermined condition. The determination portion 102 determines whether or not an index at each rotation angle during one rotation is more than a predetermined threshold value. The predetermined threshold value is used as a reference value for determining whether or not, for example, angular velocity or angular acceleration is abnormal. This threshold value is separately set for angular velocity and angular acceleration. The threshold value may be set by the user via, for example, the operation unit 13. In a case where the index is more than the predetermined threshold value, the determination portion 102 stores a determination result indicating the fact in the storage unit 11 in correlation with the rotation angle. The determination result indicates one of the content that angular velocity at the rotation angle is more than the threshold value and the content that angular acceleration at the rotation angle is more than the threshold value. The determination portion 102 may perform determination for each of a plurality of rotations. The determination portion 102 may perform the same determination on average angular velocity or average angular acceleration.

The determination portion 102 may determine whether or not, for example, the variation extent of angular velocity at each rotation angle during a plurality of rotations is more than a predetermined threshold value. The determination portion 102 may determine whether or not, for example, the variation extent of angular acceleration at each rotation angle during a plurality of rotations is more than a predetermined threshold value.

The determination portion 102 may determine whether or not the indexes such as angular velocity, angular acceleration, and the variation extent are less than a predetermined threshold value. The predetermined threshold value is a used as a reference value for determining whether or not the indexes such as angular velocity, angular acceleration, and the variation extent are abnormal. A determination result indicates that an index at a rotation angle is less than the threshold value. The predetermined threshold value may be separately set depending on a range of the rotation angle.

The display processing portion 103 displays an image in which the indexes are annularly disposed in a time series on the basis of the indexes calculated as described above. The display processing portion 103 generates, for example, image data including the indexes and outputs the image data to the display unit 14. The display processing portion 103 may output the generated image data to, for example, an external device such as a personal computer (PC), a tablet PC, a smart phone, or a head mounted display (HMD).

FIG. 4 is a diagram illustrating an example of a screen displayed by the measurement apparatus. A screen 500 includes an image 510, an image 520, and an image 530. The image 510 indicates a coordinate system. The image 510 is a circular region centering on the origin 511. The image 510 indicates a rotation angle with a position in a circumferential direction, and indicates the magnitude of a value with a distance from the origin 511. This coordinate system may also be referred to as a polar coordinate system. An upper end and a lower end of an axis in a vertical direction respectively correspond to 0 degrees and 180 degrees of a rotation angle of the crank, and a right end and a left end of an axis in a horizontal direction respectively correspond to 90 degrees and 270 degrees of a rotation angle of the crank. The image 520 indicating angular velocity at each rotation angle (sampling timing) and the image 530 indicating an average of angular velocities per unit rotation angle are plotted on a coordinate plane indicated by the image 510. In FIG. 4, rotation angles with 0 degrees as a reference are displayed at intervals of 30 degrees in the image 510. In FIG. 4, two images 520 corresponding to two rotations are displayed, but one or three or more images may be displayed.

The display processing portion 103 acquires calculated angular velocity at each rotation angle for each rotation, and subtracts an offset target value therefrom. The display processing portion 103 plots angular velocity at each rotation angle obtained by subtracting the offset target value at a corresponding position on the coordinate plane, so as to generate the image 520 for each rotation. The display processing portion 103 acquires acquired average angular velocity per unit rotation angle, and subtracts an offset target value therefrom. The display processing portion 103 plots average angular velocity per unit rotation angle obtained by subtracting the offset target value at a corresponding position on the coordinate plane, so as to generate the image 530. A value of the origin 511 corresponds to the offset target value of the angular velocity. The display processing portion 103 may acquire calculated angular velocity per unit rotation angle, subtract the offset target value therefrom, and plot angular velocity per unit rotation angle obtained by subtracting the offset target value at a corresponding position on the coordinate plane so as to generate the image 520 for each rotation.

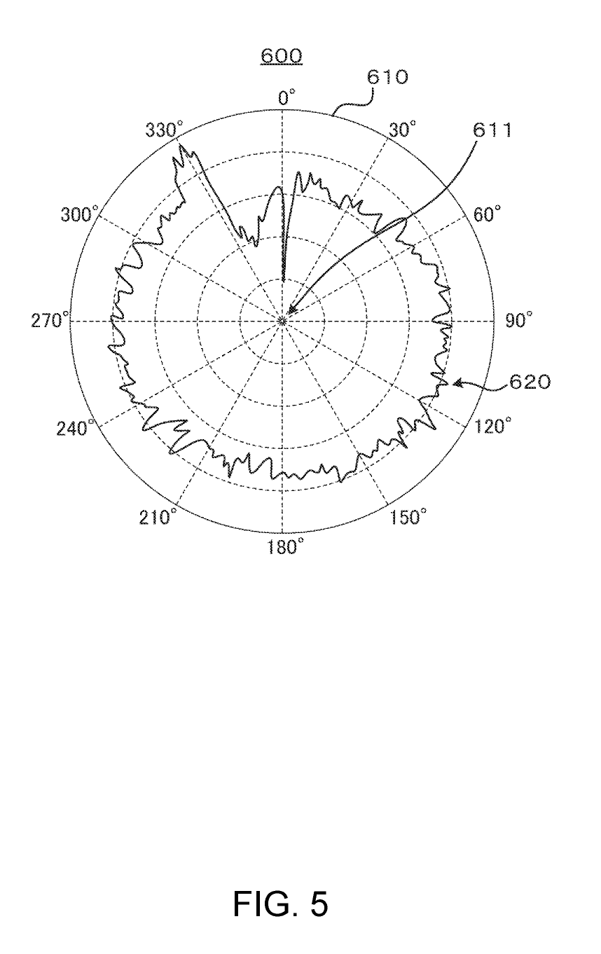

FIG. 5 is a diagram illustrating another example displayed by the measurement apparatus. A screen 600 includes an image 610 and an image 620. The image 610 and the origin 611 are the same as the image 510 and the origin 511 (refer to FIG. 4) and thus description thereof will be omitted. The image 620 indicating angular acceleration per unit rotation angle is plotted on a coordinate plane indicated by the image 610. In FIG. 5, the single image 620 corresponding to one rotation is displayed, but two or more images may be displayed.

The display processing portion 103 acquires calculated angular acceleration per unit rotation angle for each rotation, and subtracts an offset target value therefrom. The display processing portion 103 plots angular acceleration per unit rotation angle obtained by subtracting the offset target value at a corresponding position on the coordinate plane, so as to generate the image 620 for each rotation. The display processing portion 103 may acquire calculated average angular acceleration per unit rotation angle, and subtracts an offset target value therefrom. The display processing portion 103 may plot average angular acceleration per unit rotation angle obtained by subtracting the offset target value at a corresponding position on the coordinate plane, so as to display the image. A value of the origin 611 corresponds to the offset target value of the angular acceleration.

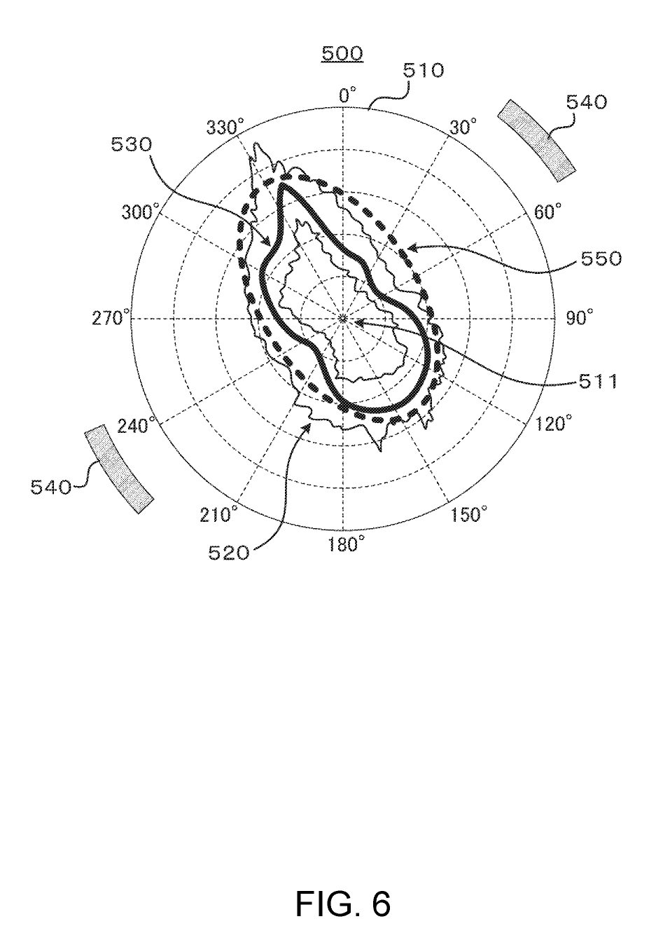

FIG. 6 is a diagram illustrating still another example of a screen displayed by the measurement apparatus. A screen 500 in FIG. 6 includes the same images as the screen 500 in FIG. 4, and further includes images 540 and an image 550. The images 540 indicate a determination result (indicating that angular velocity is less than the predetermined threshold value) of angular velocity. In FIG. 6, the images 540 are displayed around the image 510. The image 550 indicates angular velocity at each rotation angle in a comparative target rotation. Indexes of one or more comparative target rotations may be stored in, for example, the storage unit 11 in advance, and the display processing portion 103 may receive setting from the user via the operation unit 13.

The display processing portion 103 acquires a determination result of angular velocity at each rotation angle for each rotation, and generates the image 540 at a position corresponding to a rotation angle of angular velocity with respect to the angular velocity less than the predetermined threshold value. The display processing portion 103 acquires angular velocity for a set comparative target rotation, and plots the acquired angular velocity at a corresponding position on the coordinate plane so as to generate the image 550. The display processing portion 103 may adjust the angular velocity for the comparative target rotation by using an offset target value. The display processing portion 103 may plot an image indicating angular velocity less than the predetermined threshold value, at a corresponding position on the coordinate plane. In this case, the display processing portion 103 displays an image of angular velocity less than the threshold value and an image of angular velocity more than the threshold value in different aspects. In the example illustrated in FIG. 6, positions of indexes less than the threshold value are displayed, but positions of indexes more than the threshold value may be displayed.

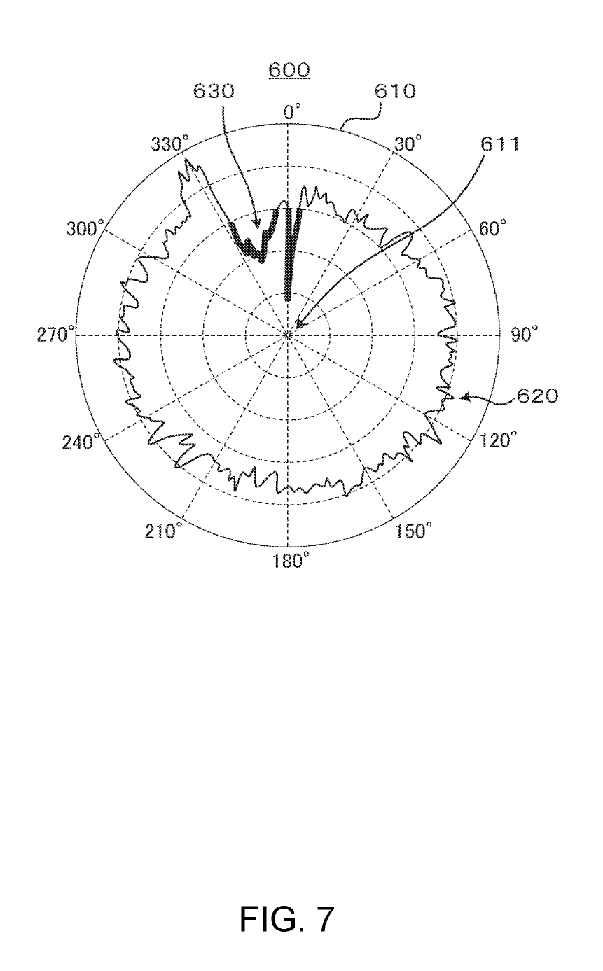

FIG. 7 is a diagram illustrating still another example of a screen displayed by the measurement apparatus. A screen 600 in FIG. 7 includes the same images as the screen 600 in FIG. 5, and further includes an image 630. The image 630 indicates a determination result (indicating that angular acceleration is less than the predetermined threshold value) of angular acceleration. The image 630 is displayed in an aspect which is different from the image 620. In FIG. 7, the image 630 is displayed in a thicker line than that of the image 620.

The display processing portion 103 acquires a determination result of angular acceleration per unit rotation angle for each rotation, and generates the image 630 at a position corresponding to a rotation angle of angular acceleration with respect to the angular acceleration less than the predetermined threshold value. The display processing portion 103 may generate images positions corresponding to a rotation angle of angular acceleration around the image 610 with respect to the angular acceleration less than the predetermined threshold value in the same manner as in the images 540 in FIG. 6. The display processing portion 103 may acquire angular acceleration for a comparative target rotation, and may plot the acquired angular acceleration at a corresponding position on the coordinate plane. The display processing portion 103 may adjust the angular acceleration for the comparative target rotation by using an offset target value. In the example illustrated in FIG. 7, positions of indexes less than the threshold value are displayed, but positions of indexes more than the threshold value may be displayed.

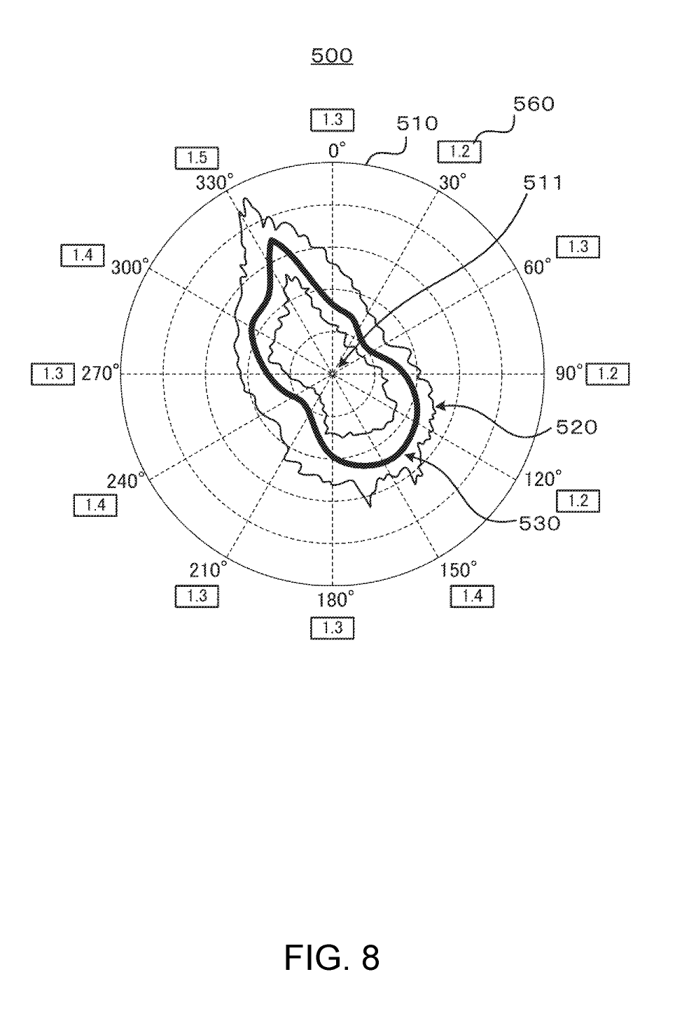

FIG. 8 is a diagram illustrating still another example of a screen displayed the measurement apparatus. A screen 500 in FIG. 8 includes the same images as the screen 500 in FIG. 4, and further includes images 560. The images 560 indicate the variation extent of angular velocity for a plurality of rotations. In FIG. 8, the images 560 are displayed around the image 510 so as to correspond to predetermined angles (at intervals of 30 degrees from 0 degrees).

The display processing portion 103 acquires the variation extent calculated with respect to predetermined angles for a plurality of rotations, and generates the images 560 at corresponding positions of rotation angles of the variation extent around the image 510. The display processing portion 103 may acquire a determination result of the variation extent of predetermined angles, and may display the image 560 corresponding to an angle of which the variation extent is more than the predetermined threshold value in an aspect which is different from the image 560 corresponding to an angle of which the variation extent is less than the predetermined threshold value. The display processing portion 103 may display the variation extent of angular acceleration for a plurality of rotations around the image 610 illustrated in FIG. 5. In FIG. 5, the display processing portion 103 may display an image corresponding to an angle of which the variation extent is more than the predetermined threshold value in an aspect which is different from an image corresponding to an angle of which the variation extent is less than the predetermined threshold value.

Referring to FIG. 2 again, for example, in a case where any rotation has an index more than (or less than) the threshold value on the basis of a determination result, the display processing portion 103 may generate a message for notifying that there is the rotation for which an index is more than (or less than) the threshold value, as sound data, and may output the sound data to the sound output unit 15 so as to output a sound. A message for notifying that there is a rotation angle at which an index is more than (or less than) the threshold value may be generated as sound data. The display processing portion 103 may output the generated sound data to an external device such as a PC, a tablet PC, a smart phone, or an HMD. For example, the display processing portion 103 may cause a light emitting portion (for example, an LED) provided in the measurement apparatus 1 to emit light in a predetermined light emission color or a predetermined light emission pattern in order to notify the user 2 that there is a rotation for which an index is more than (or less than) the threshold value, or that there is a rotation angle at which an index is more than (or less than) the threshold value.

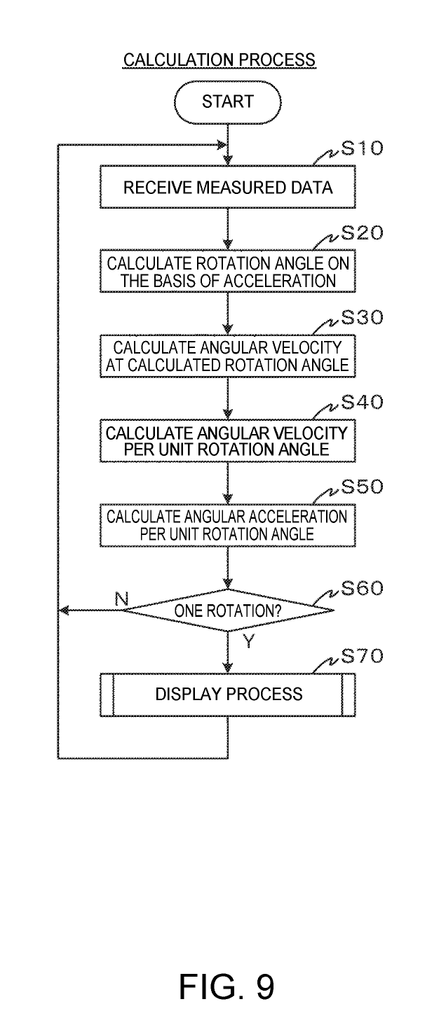

FIG. 9 is a flowchart illustrating an example of a calculation process in the measurement apparatus. FIG. 9 illustrates a principal flow of the calculation process in the above-described control unit 10.

The acquisition portion 100 receives measured data from the sensor unit 4 (step S10). The acquisition portion 100 receives the measured data including acceleration and angular velocity, for example, at a set sampling cycle. The calculation portion 101 calculates a rotation angle on the basis of the acceleration received in step S10 (step S20). The calculation portion 101 calculates the angular velocity received in step S10 as angular velocity at the rotation angle calculated in step S20 (step S30).

The processes in steps S10 to S30 are performed every sampling timing, for example. A rotation angle and angular velocity at each sampling timing are calculated through the processes in steps S10 to S30.

The calculation portion 101 calculates angular velocity (for example, average angular velocity for every one degree) per unit rotation angle on the basis of the rotation angle and the angular velocity at each sampling timing, calculated in step S30 (step S40). The calculation portion 101 calculates angular acceleration (for example, angular acceleration for every one degree) per unit rotation angle on the basis of the angular velocity per unit rotation angle, calculated in step S40 (step S50).

The calculation portion 101 determines whether or not a rotation angle at which index is calculated reaches one rotation (360 degrees) (step S60). In a case where it is determined that the rotation angle does not reach one rotation (N in step S60), the acquisition portion 100 performs the process in step S10 again.

In a case where the rotation angle reaches one rotation (Y in step S60), a display process for the one rotation is performed (step S70). After the process in step S70, the acquisition portion 100 performs the process in step S10 again.

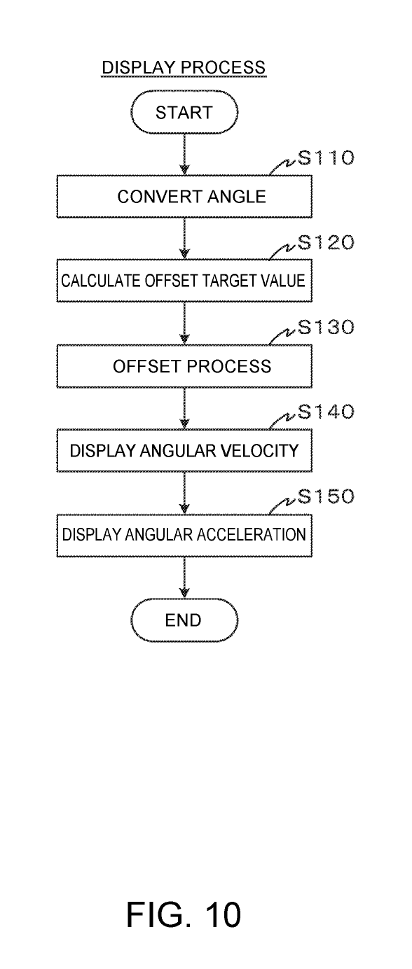

FIG. 10 is a flowchart illustrating an example of the display process in the measurement apparatus. FIG. 10 illustrates details of the display process in step S70 in FIG. 9. FIG. 10 illustrates a principal flow of the display process in the above-described control unit 10.

The calculation portion 101 converts rotation angles for display target one rotation into rotation angles with a predetermined position of the crank as a reference (step S110). The calculation portion 101 calculates an offset target value of angular velocity and an offset target value of angular acceleration on the basis of the angular velocity and the angular acceleration within a predetermined period of time (step S120).

The display processing portion 103 offsets the angular velocity and the angular acceleration for the display target one rotation by using the offset target values calculated in step S120 (step S130).

The display processing portion 103 displays the angular velocity for the display target one rotation (step S140). The display processing portion 103 plots, for example, the angular velocity at each rotation angle, offset in step S130, in a predetermined coordinate system. In the above-described way, an image in which angular velocities for one rotation are annularly disposed in a time series is displayed.

The display processing portion 103 displays the angular acceleration for the display target one rotation (step S150). The display processing portion 103 plots, for example, the angular acceleration per unit rotation angle, offset in step S130, in a predetermined coordinate system. In the above-described way, an image in which angular accelerations for one rotation are annularly disposed in a time series is displayed.

The display processing portion 103 displays indexes for one rotation as described above, and finishes the process shown in the flowchart of FIG. 10.

As mentioned above, the first embodiment of the invention has been described. The measurement apparatus of the first embodiment annularly displays, for example, the indexes (angular velocity, angular acceleration, or an average thereof) regarding rotation motion of pedaling in a time series on a predetermined coordinate plane. The coordinate system indicates a rotation angle with a position in a circumferential direction with the origin as the center, and indicates the magnitude of a value by using a distance from the origin. Consequently, since the indexes at each rotation angle for a rotation are annularly displayed, the user can intuitively and easily understand a pedaling action. A reference position (a direction of 0 degrees) of the rotation angle in this coordinate system matches an actual reference position (a direction of 0 degrees) of a rotation angle of the crank. Consequently, the user can intuitively and easily image positions and attitudes of the legs thereof.

For example, the measurement apparatus of the first embodiment outputs a determination result of an index for each rotation angle as an image or a sound. Consequently, for example, the user can easily recognize a rotation angle at which an index is abnormal. The user can intuitively and easily image positions and attitudes of the legs thereof when the index is abnormal.

The measurement apparatus of the first embodiment performs an offset process of an index at each rotation angle. Consequently, for example, in a case where pedaling for stable traveling is performed at a predetermined speed, a difference in the magnitude of an index at each rotation angle can be more clearly exhibited (emphasized) than in a case where the origin is set to 0. The user can easily recognize a change in an index at each rotation angle.

### 2. Second Embodiment

In a second embodiment, measured data from a sensor unit mounted on the user (driver) 2 is used in addition to measured data from the sensor unit 4 mounted on the crank of the bicycle 3. Hereinafter, the same constituent elements as in the first embodiment are given the same reference numerals and description thereof will be omitted, and a description will be made focusing on differences from the first embodiment.

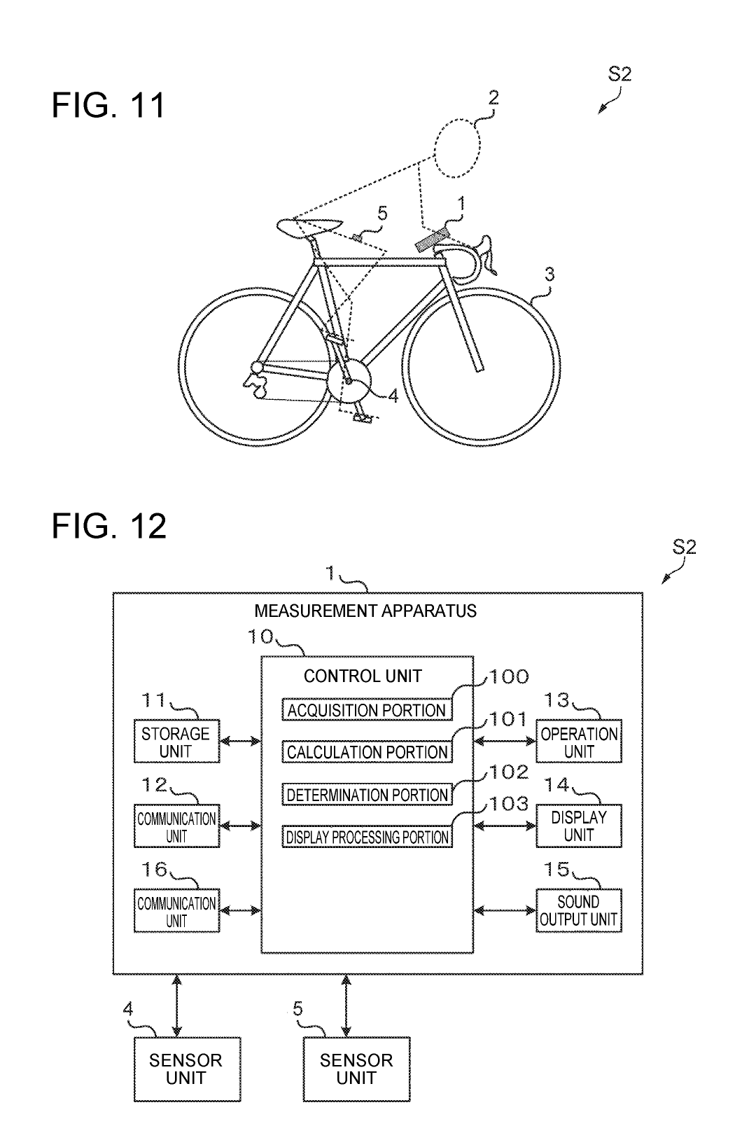

FIG. 11 is a diagram illustrating an example of a configuration of a pedaling measurement system according to the second embodiment. A pedaling measurement system S2 includes a measurement apparatus 1, a sensor unit 4, and a sensor unit 5. The sensor unit 5 is mounted on the user 2. The measurement apparatus 1 is communicably connected to the sensor unit 5.

The sensor unit 5 measures acceleration and angular velocity caused by motion of the user 2. The sensor unit 5 is mounted on, for example, the knee of the user 2, and measures motion of the knee of the user 2. The sensor unit 5 includes, for example, an acceleration sensor and an angular velocity sensor. The sensor unit 5 measures acceleration and angular velocity, for example, at a set sampling cycle, and transmits measured data including the measured acceleration and angular velocity to the measurement apparatus 1.

The measurement apparatus 1 receives the measured data from the sensor unit 5. The measurement apparatus 1 calculates motion of the knee of the user 2 in a predetermined direction on the basis of the received measured data. The predetermined direction is, for example, a leftward-and-rightward direction (a depth direction in FIG. 11) of the knee. For example, on a bicycle race, as motion of the knee in the leftward-and-rightward direction becomes larger, transmission of force to the crank is worsened. The measurement apparatus 1 calculates an index regarding motion of the knee. The measurement apparatus 1 displays an image including the index regarding motion of the knee in addition to the indexes such as angular velocity or angular acceleration at each rotation angle of the crank. Consequently, the user can intuitively and easily understand motion of a part of the user's body regarding a pedaling action.

FIG. 12 is a block diagram illustrating an example of a functional configuration of the pedaling measurement system.

The measurement apparatus 1 includes a communication unit 16. The communication unit 16 receives measured data from the sensor unit 5, and outputs the received measured data to the control unit 10. The communication unit 16 may be implemented by, for example, a communication interface controlling wireless communication.

The acquisition portion 100 receives the measured data from the sensor unit 5 via the communication unit 16. The calculation portion 101 calculates an index regarding motion of the knee of the user 2 on the basis of the measured data received from the sensor unit 5. The index is, for example, acceleration corresponding to motion of the knee in the leftward-and-rightward direction.

The calculation portion 101 calculates, for example, acceleration corresponding to motion of the knee in the leftward-and-rightward direction at each sampling timing. The sensor unit 5 may be mounted on the knee so that, for example, one axis of the acceleration sensor is along the leftward-and-rightward direction of the knee of the user 2.

The calculation portion 101 may add an acquisition time to the measured data from the sensor unit 4 and the measured data from the sensor unit 5. Consequently, the index such as angular velocity of the crank and the acceleration caused by motion of the knee may be correlated with each rotation angle on the basis of the acquisition time.

The determination portion 102 determines whether or not the calculated index regarding motion of the knee satisfies a predetermined condition. The determination portion 102 determines whether or not, for example, the magnitude of an absolute value of acceleration corresponding to motion of the knee in the leftward-and-rightward direction is greater than a predetermined threshold value. This threshold value may be set by the user via, for example, the operation unit 13. In a case where the acceleration is more than the predetermined threshold value, the determination portion 102 stores a determination result indicating the fact in the storage unit 11. The determination portion 102 may determine whether or not the acceleration is less than the predetermined threshold value.

The display processing portion 103 displays an image including the index regarding motion of the knee, calculated as described above.

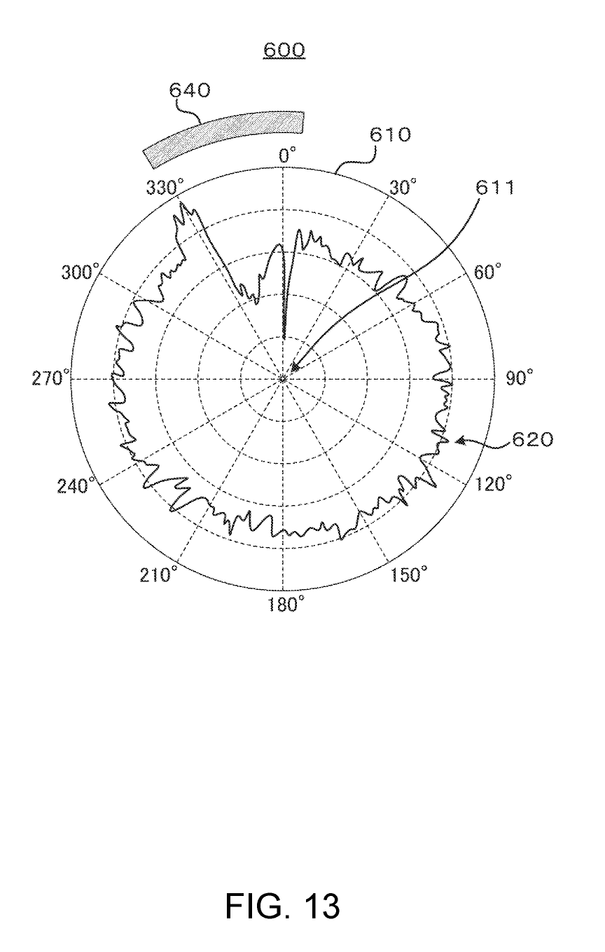

FIG. 13 is a diagram illustrating an example of a screen displayed by the measurement apparatus. A screen 600 in FIG. 13 includes the same images as in the screen 600 in FIG. 5, and further includes an image 640. Image 640 indicates a determination result (indicating that acceleration is more than the predetermined threshold value) of the acceleration caused by motion of the knee in the leftward-and-rightward direction. In FIG. 13, the image 640 is displayed around the image 610.

The display processing portion 103 acquires a determination result of acceleration caused by motion of the knee correlated with each rotation angle for each rotation, and generates the image 640 at a corresponding rotation angle position on a coordinate plane with respect to acceleration which is more than the predetermined threshold value. In the example illustrated in FIG. 13, the position of acceleration more than the threshold value is displayed, but a position of acceleration less than the threshold value may be displayed.

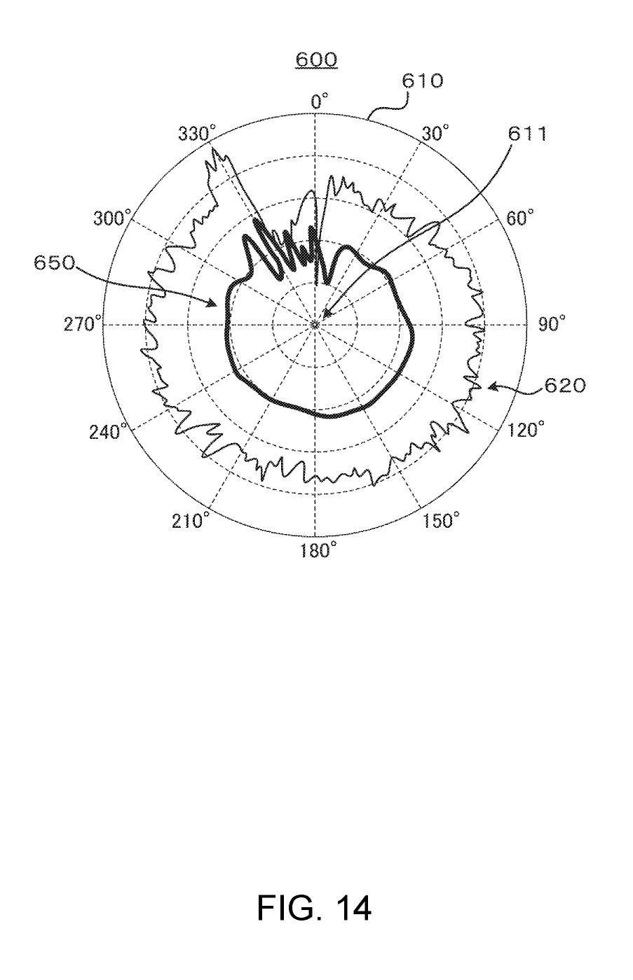

As illustrated in FIG. 14 (a diagram illustrating another example of a screen displayed by the measurement apparatus), the display processing portion 103 may acceleration caused by motion of the knee correlated with each rotation angle at a corresponding rotation angle position on the coordinate plane of the image 610 regardless of a determination result (an image 650 in FIG. 14). The display processing portion 103 may display acceleration caused by motion of the knee around the image 610.

For example, in a case where any rotation has acceleration caused by motion of the knee, which is more than (or less than) the threshold value on the basis of a determination result, the display processing portion 103 may generate a message for notifying that there is the rotation for which acceleration is more than (or less than) the threshold value, as sound data, and may output the sound data to the sound output unit 15 so as to output a sound. A message for notifying that there is a rotation angle at which acceleration caused by motion of the knee is more than (or less than) the threshold value may be generated as sound data. The display processing portion 103 may output the generated sound data to an external device such as a PC, a tablet PC, a smart phone, or an HMD. For example, the display processing portion 103 may cause a light emitting portion (for example, an LED) provided in the measurement apparatus 1 to emit light in a predetermined light emission color or a predetermined light emission pattern in order to notify the user 2 that there is a rotation for which acceleration caused by motion of the knee is more than (or less than) the threshold value, or that there is a rotation angle at which acceleration caused by motion of the knee is more than (or less than) the threshold value.

As mentioned above, the second embodiment of the invention has been described. The measurement apparatus of the second embodiment displays an index regarding motion of a part of the user's body in correlation with, for example, a rotation angle. Consequently, the user can understand motion of the part of the user's body regarding a pedaling action.

For example, the measurement apparatus of the second embodiment outputs a determination result of an index regarding motion of the part of the user's body for each rotation angle as an image or a sound. Consequently, for example, the user can easily recognize a rotation angle at which motion of a part of the user's body is abnormal.

The invention is not limited to the first and second embodiments, and may be realized in various aspects within the scope without departing from the spirit thereof. For example, the following modifications may be added to the above-described respective embodiments. Two or more of the respective embodiments and modification examples may be combined with each other as appropriate.

Each of the above-described screen examples shows a case where the sensor unit 4 is mounted on the crank shaft B1 on the right side (the right side of the user 2) of the bicycle 3. In a case where the sensor unit 4 is mounted on the left side of the bicycle 3, for example, a screen in which a rotation direction is a counterclockwise direction may be displayed. In both of the case of the right side and the case of the left side of the bicycle 3, a user may be allowed to freely set a rotation direction as a clockwise direction or a counterclockwise direction.

In the above-described embodiments, a case where a single sensor unit 4 is used has been described. In the above-described first and second embodiments, the sensor units 4 may be respectively mounted on portions (portions causing different motions on the left and right sides) other than the crank shaft B1, such as the left and right pedals of the bicycle 3, and the measurement apparatus 1 may out indexes regarding left and right pedaling actions on the basis of measured data of the left and right portions. A screen of the right pedaling action in the bicycle 3 and a screen of left pedaling action therein may be displayed to overlap each other, and may be displayed separately.

In the above-described first and second embodiments, the calculation portion 101 may calculate a median of angular velocity and a median of angular acceleration per unit rotation angle on the basis of angular velocity and angular acceleration at each rotation angle for a plurality of rotations. The calculation portion 101 may calculate a most frequent value of angular velocity and a most frequent value of angular acceleration per unit rotation angle. The determination portion 102 may determine whether or not the calculated median or most frequent value satisfies a predetermined condition. The display processing portion 103 may a median or a most frequent value per unit rotation angle obtained by subtracting an offset target value at a corresponding position on the coordinate plane.

In the above-described first and second embodiments, for example, the determination portion 102 may determine whether or not indexes at all or some rotation angles during one rotation are similar or identical to a predetermined change pattern. The predetermined change pattern is used as a reference value for determining whether or not a time-series change in angular velocity or angular acceleration is abnormal. In a case where the indexes are similar or identical to the predetermined change pattern, the determination portion 102 may store a determination result indicating the fact in the storage unit 11 in correlation with the rotation angles. The determination portion 102 may perform determination by using a plurality of change patterns. The display processing portion 103 may output a message (for example, advice information regarding pedaling) correlated with a change pattern according to the change pattern to which indexes are similar or identical. The above-described modification example is also applicable to average angular velocity or average angular acceleration.

In the above-described second embodiment, the sensor unit 5 is mounted on the user 2. The sensor unit 5 may be mounted on other parts of the user 2, for example, the foot, the arm, the hand, or the head thereof. The sensor unit 5 may be mounted on other parts of the bicycle 3, for example, a handlebar, a wheel, or a saddle thereof.

The configurations of the pedaling measurement systems S1 and S2 described in the first and second embodiments are classified into constituent elements according to the principal process content for better understanding of the configurations of the pedaling measurement systems S1 and S2. The invention of the present specification is not limited due to a method or a name for classifying of the constituent elements. The configurations of the pedaling measurement systems S1 and S2 may be classified into more constituent elements. A single constituent element may be classified to execute more processes. A process in each constituent element may be executed by a single item of hardware, and may be executed by a plurality of items of hardware. A process in each constituent element or sharing of functions thereof is not limited to the above description as long as the objects and effects of the invention can be achieved. For example, some functions of the measurement apparatus may be installed in the sensor unit, and vice versa.

The process in each of the pedaling measurement systems S1 and S2 is divided into the process units in the flowchart described in the first and second embodiments according to the principal process content for better understanding of the process. The invention of the present application is not limited due to a method or a name for division into the process units. The process in each of the pedaling measurement systems S1 and S2 may be divided into more process units according to the process content. The process may be divided so that a single process unit includes more process units. The process order in the flowchart is not limited to the illustrated example.

The screens and the data structures described in the first and second embodiments are only examples, and are not limited to the described examples as long as the objects of the invention can be achieved.

The invention is not limited to a movable bicycle, and is also applicable to a bicycle ergometer provided indoors.

### 3. Third Embodiment

### 3-1. Outline of Pedaling Analysis System

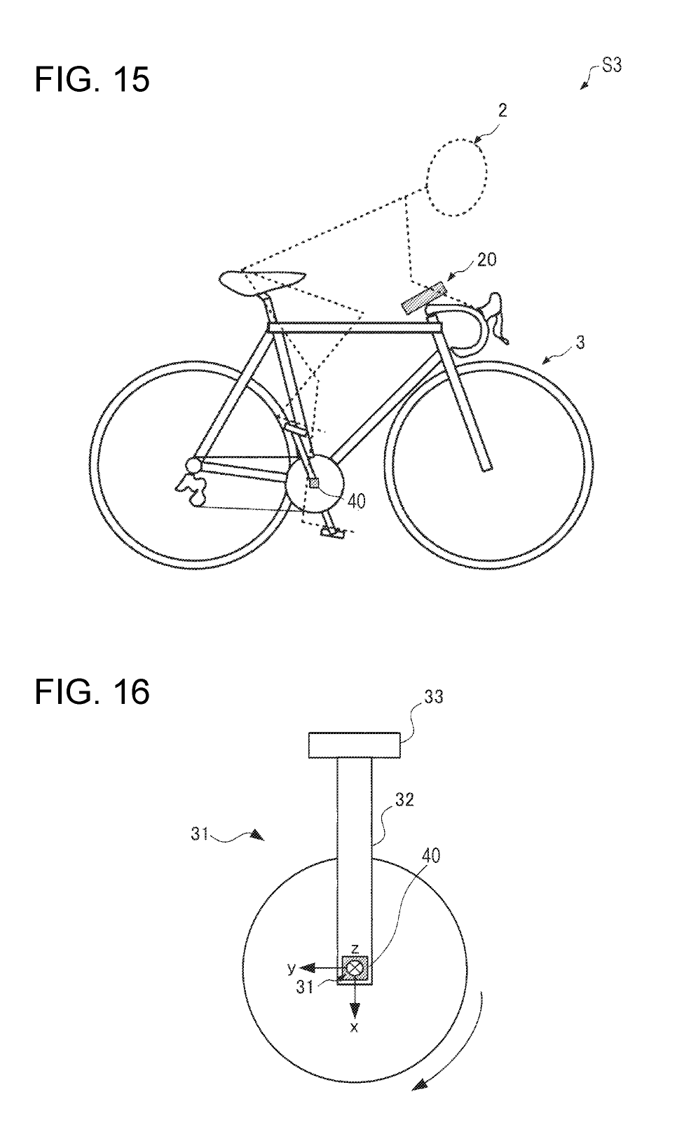

FIG. 15 is a diagram illustrating an example of an exterior of a pedaling analysis system according to a third embodiment.

As illustrated in FIG. 15, a pedaling analysis system S3 (an example of a pedaling measurement system) is configured to include a sensor unit 40 and a pedaling analysis apparatus 20 (an example of a pedaling measurement apparatus) which can perform communication with the sensor unit 40.

The sensor unit 40 is mounted on, for example, a crank of a bicycle 3 which can travel on a field. The sensor unit 40 has three detection axes (an x axis, a y axis, and a z axis) which are orthogonal to each other, and can measure accelerations generated in three directions along the x axis, the y axis, and the z axis, and an angular velocity generated about at least the z axis.

The pedaling analysis apparatus 20 is mounted on a handle lever of the bicycle 3 in an attitude in which a display section (which will be described later) of the pedaling analysis apparatus 20 faces the body side of the user 2. In this case, the user 2 can check a pedaling analysis result displayed on the display unit of the pedaling analysis apparatus 20 during driving (traveling) of the bicycle 3.

The pedaling analysis apparatus 20 may be constituted of a portable terminal such as a smart phone or a table terminal. The pedaling analysis apparatus 20 may be mounted on the body (for example, the wrist) of the user 2, and may be mounted on a location separated from the bicycle 3.

### 3-2. Mounting Example of Sensor Unit

FIG. 16 is a diagram illustrating examples of a position at which and a direction in which the sensor unit 40 is mounted on a crank 32.

Here, a case is assumed in which the sensor unit 40 is mounted on the crank 32 on the right side of the bicycle 3 (the right side of the user 2). A rotation direction of the crank 32 about a rotation shaft (crank shaft 31) of the crank 32 is a clockwise direction when viewed from the right side of the bicycle 3, and a pedal 33 is provided at an end of the crank 32 separated from the crank shaft 31.

First, a position where the sensor unit 40 is mounted on the crank 32 is a position on the crank shaft 31 or on an extension line of the crank shaft 31.

An attitude of the sensor unit 40 being mounted on the crank 32 is set to an attitude in which the z axis of the sensor unit 40 is disposed on the crank shaft 31, and the x axis of the sensor unit 40 is directed, for example, in a longitudinal direction of the crank 32.

Here, a positive direction of the z axis of the sensor unit 40 is assumed to be a direction from the right side (the right side of the user 2) toward the left side of the bicycle 32, and a positive direction of the x axis of the sensor unit 40 is assumed to be a direction from the pedal 33 toward the crank shaft 31.

Here, z-axis angular velocity data (hereinafter, simply referred to as a “z-axis angular velocity” or a “one-axis angular velocity”) output from the sensor unit 40 indicates an angular velocity ω of the crank 32 about the crank shaft 31, and time integration of the angular velocity ω indicates a rotation angle Θ of the crank 32 about the crank shaft 31.

If the bicycle 3 is in a stoppage state or a constant velocity traveling state, only the gravitational acceleration is applied to the sensor unit 40 as acceleration, and thus x-axis acceleration data (hereinafter, simply referred to as an “x-axis acceleration”) or y-axis acceleration data (hereinafter, simply referred to as an “y-axis acceleration”) output from the sensor unit 40 also indicates the rotation angle Θ of the crank 32 about the crank shaft 31 (hereinafter, the x-axis acceleration, the y-axis acceleration, and the z-axis acceleration will be simply referred to as “three-axis accelerations”).

### 3-3. User's Actions

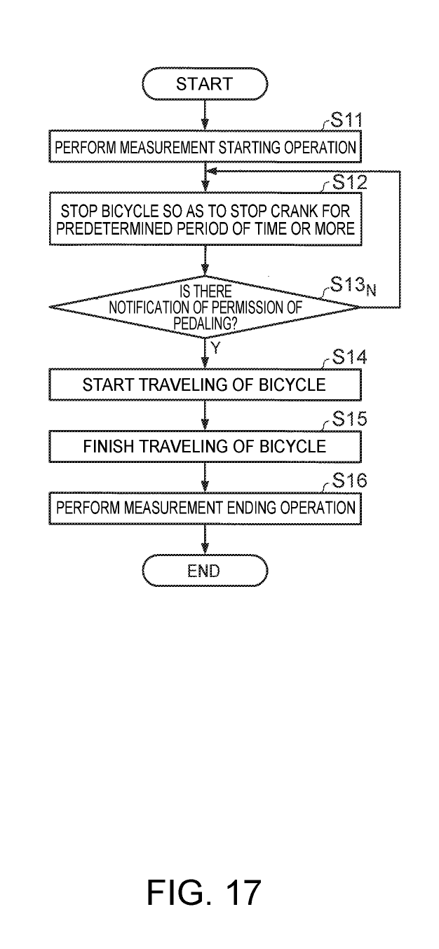

FIG. 17 is a diagram illustrating procedures of actions performed by the user 2. Hereinafter, respective steps in FIG. 17 will be described in order.

Step S11: The user 2 performs a measurement starting operation (an operation for causing the sensor unit 40 to start measurement) via the pedaling analysis apparatus 20. Then, the pedaling analysis apparatus 20 transmits a measurement starting command to the sensor unit 40, and the sensor unit 40 receives the measurement starting command so as to start measurement of three-axis accelerations and a one-axis angular velocity. The sensor unit 40 measures the three-axis accelerations and the one-axis angular velocity in a predetermined cycle Δt (for example, Δt=1 ms), and sequentially transmits measured data to the pedaling analysis apparatus 20. Communication between the sensor unit 40 and the pedaling analysis apparatus 20 is wireless communication or wired communication.

Step S12: The user 2 stops the bicycle 3 so as to stop the crank 32 for a predetermined period of time (for example, one second) or more.

Step S13: The user 2 determines whether or not a notification (for example, a notification using a sound) of permitting pedaling (traveling) is received from the pedaling analysis apparatus 20, proceeds to step S14 in a case where the notification is received (Y in step S13), and proceeds to step S12 in a case where the notification is not received (N in step S13).

Step S14: The user 2 starts traveling of the bicycle 3. The pedaling analysis apparatus 20 analyzes the pedaling action performed by the user 2 on the basis of the measured data from the sensor unit 40, and displays a result of the analysis.

Step S15: Then, the user 2 finishes traveling of the bicycle 3 at a desired timing.

Step S16: Next, the user 2 performs a measurement ending operation (an operation for causing the sensor unit 40 to finish measurement) via the pedaling analysis apparatus 20. Then, the pedaling analysis apparatus 20 transmits a measurement ending command to the sensor unit 40, and the sensor unit 40 receives the measurement ending command so as to finish measurement of three-axis accelerations and a one-axis angular velocity.

### 3-4. Configuration of Pedaling Analysis System

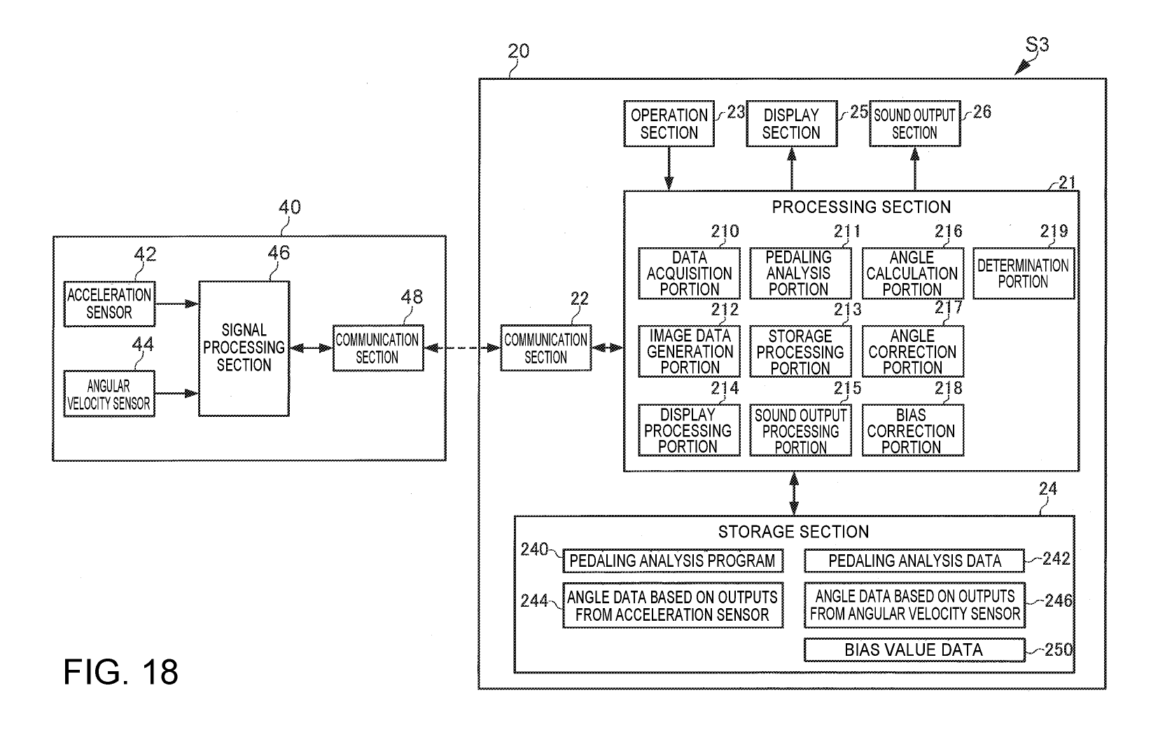

FIG. 18 is a diagram illustrating a configuration example of the pedaling analysis system S3 according to the third embodiment.

The pedaling analysis system S3 may include the sensor unit 40 and the pedaling analysis apparatus 20 as described above.

As illustrated in FIG. 18, the sensor unit 40 is configured to include an acceleration sensor 42, an angular velocity sensor 44, a signal processing section 46, a communication section 48, and the like. However, the sensor unit 40 may have a configuration in which some of the constituent elements are deleted or changed as appropriate, or may have a configuration in which other constituent elements are added thereto.

The acceleration sensor 42 measures accelerations generated in three-axis (the x axis, the y axis, and the z axis) directions which intersect (ideally, orthogonal to) each other, and outputs digital signals (acceleration data) corresponding to the magnitudes and directions of the measured three-axis accelerations.

The angular velocity sensor 44 measures an angular velocity generated about one axis (here, the z axis), and outputs a digital signal (angular velocity data) corresponding to the magnitude and direction of the measured angular velocity.

The signal processing section 46 receives the acceleration data and the angular velocity data from the acceleration sensor 42 and the angular velocity sensor 44, respectively, adds time information thereto, stores the data in a storage section (not illustrated), adds time information to the stored measured data (an example of attitude or position information) so as to generate packet data conforming to a communication format, and outputs the packet data to the communication section 48.

Ideally, the acceleration sensor 42 and the angular velocity sensor 44 are provided in the sensor unit 40 so that the three detection axes thereof match three axes (an x axis, a y axis, and a z axis) of an orthogonal coordinate system (sensor coordinate system) defined for the sensor unit 40, but, actually, errors occur in installation angles. Therefore, the signal processing section 46 performs a process of converting the acceleration data and the angular velocity data into data in the xyz coordinate system by using a correction parameter which is calculated in advance according to the installation angle errors.

The signal processing section 46 may perform a process of correcting the temperatures of the acceleration sensor 42 and the angular velocity sensor 44. The acceleration sensor 42 and the angular velocity sensor 44 may have a temperature correction function.

The acceleration sensor 42 and the angular velocity sensor 44 may output analog signals, and, in this case, the signal processing section 46 may A/D convert an output signal from the acceleration sensor 42 and an output signal from the angular velocity sensor 44 so as to generate measured data (acceleration data and angular velocity data), and may generate communication packet data by using the data.

The communication section 48 performs a process of transmitting packet data received from the signal processing section 46 to the pedaling analysis apparatus 20, or a process of receiving various control commands such as a measurement starting command from the pedaling analysis apparatus 20 and sending the control commands to the signal processing section 46. The signal processing section 46 performs various processes corresponding to the control commands.

As illustrated in FIG. 18, the pedaling analysis apparatus 20 is configured to include a processing section 21, a communication section 22, an operation section 23, a storage section 24, a display section 25, and a sound output section 26. However, the pedaling analysis apparatus 20 may have a configuration in which some of the constituent elements are deleted or changed as appropriate, or may have a configuration in which other constituent elements are added thereto.

The communication section 22 performs a process receiving packet data transmitted from the sensor unit 40 and sending the packet data to the processing section 21, or a process of transmitting control commands (including a measurement staring command and a measurement ending command) from the processing section 21 to the sensor unit 40.

The operation section 23 performs a process of acquiring data corresponding to an operation performed by the user 2 and sending the data to the processing section 21. The operation section 23 may be, for example, a touch panel type display, a button, a key, or a microphone.

The storage section 24 is constituted of, for example, various IC memories such as a read only memory (ROM), a flash ROM, and a random access memory (RAM), or a recording medium such as a hard disk or a memory card. The storage section 24 stores a program for the processing section 21 performing various computation processes or a control process, or various programs or data for realizing application functions.

In the present embodiment, the storage section 24 stores a pedaling analysis program 240 (an example of a pedaling measurement program) which is read by the processing section 21 in order to execute a pedaling analysis process. The pedaling analysis program 240 may be stored in a nonvolatile recording medium (computer readable recording medium) in advance, or the pedaling analysis program 240 may be received from a server (not illustrated) by the processing section 21 via a network, and may be stored in the storage section 24.

The storage section 24 stores pedaling analysis data 242, angle data 244 based on outputs from the acceleration sensor, angle data 246 based on outputs from the angular velocity sensor, and bias value data 250.

Here, the angle data 244 is a storage region in which an angle Θ′ based on outputs from the acceleration sensor 42 is stored along with time information (time point t). The angle data 246 is a storage region in which an angle Θ based on outputs from the angular velocity sensor 44 is stored along with time information (time point t). The pedaling analysis data 242 is a storage region in which analysis results (indexes such as the angle Θ, the angular velocity ω, and the angular acceleration ω′) of a pedaling action from the processing section 21 are stored along with the date and time (time point t) at which pedaling is performed, and identification information of the user 2.

The storage section 24 is used as a work area of the processing section 21, and temporarily stores data which is input from the operation section 23, results of calculation executed by the processing section 21 according to various programs, and the like. The storage section 24 may store data which is required to be preserved for a long period of time among data items generated through processing of the processing section 21.

The display section 25 displays a processing result in the processing section 21 as text, a graph, a table, animation, and other images. The display section 25 may be, for example, a cathode ray tube (CRT), a liquid crystal display (LCD), a touch panel type display, and a head mounted display (HMD). A single touch panel type display may realize functions of the operation section 23 and the display section 25.

The sound output section 26 displays a processing result in the processing section 21 as a sound such as a voice or a buzzer sound. The sound output section 26 may be, for example, a speaker or a buzzer.

The processing section 21 performs a process of transmitting a control command to the sensor unit 40 via the communication section 22, or various computation processes on data which is received from the sensor unit 40 via the communication section 22, according to various programs. The processing section 21 performs other various control processes.

Particularly, in the present embodiment, by executing the pedaling analysis program 240, the processing section 21 functions as a data acquisition portion 210, a pedaling analysis portion 211, an image data generation portion 212, a storage processing portion 213, a display processing portion 214, a sound output processing portion 215, an angle calculation portion 216, an angle correction portion 217, a bias correction portion 218, and a determination portion 219, and performs a process (pedaling analysis process) of analyzing a pedaling action of the user 2.

The data acquisition portion 210 performs a process of receiving packet data which is received from the sensor unit 40 by the communication section 22, acquiring time information and measured data from the received packet data, and sending the time information and the measured data to the storage processing portion 213.

The pedaling analysis portion 211 performs a process of analyzing a pedaling action of the user 2 by using the measured data (the measured data stored in the storage section 24) output from the sensor unit 40, the data from the operation section 23, or the like, so as to generate the pedaling analysis data 242 including a time point (date and time) at which the pedaling was performed, identification information of the user 2, and information regarding a pedaling action analysis result.

The image data generation portion 212 performs a process of generating image data corresponding to an image displayed on the display section 25. For example, the image data generation portion 212 generates image data on the basis of the pedaling analysis data.

The display processing portion 214 performs a process of displaying various images (including text, symbols, and the like in addition to an image corresponding to the image data generated by the image data generation portion 212) on the display section 25. For example, the display processing portion 214 displays various screens on the display section 25 on the basis of the image data generated by the image data generation portion 212. For example, the image data generation portion 212 may display an image, text, or the like for notifying the user 2 on the display section 25. For example, the display processing portion 214 may display text information such as text or symbols indicating the pedaling analysis data on the display section 25 in order during a pedaling action of the user 2, or automatically or in response to an input operation performed by the user 2 after the pedaling action is completed. Alternatively, a display section may be provided in the sensor unit 40, and the display processing portion 214 may transmit image data to the sensor unit 40 via the communication section 22, and various images, text, or the like may be displayed on the display section of the sensor unit 40.

The storage processing portion 213 performs read/write processes of various programs or various data for the storage section 24. The storage processing portion 213 performs not only the process of storing the time information and the measured data received from the data acquisition portion 210 in the storage section 24 in correlation with each other, but also a process of storing various pieces of information calculated by the pedaling analysis portion 211, the pedaling analysis data 242, or the like in the storage section 24.

The sound output processing portion 215 performs a process of outputting various sounds (including voices, buzzer sounds, and the like) from the sound output section 26. For example, the sound output processing portion 215 may output a sound for notifying the user 2 from the sound output section 26. For example, the sound output processing portion 215 may output a sound or a voice indicating an analysis result in the pedaling analysis portion 211 from the sound output section 26 automatically or in response to performed by the user 2 after a pedaling action of the user 2 is completed. Alternatively, a sound output section may be provided in the sensor unit 40, and the sound output processing portion 215 may transmit various items of sound data or voice data to the sensor unit 40 via the communication section 22, and may output various sounds or voices from the sound output section of the sensor unit 40.

A vibration mechanism may be provided in the pedaling analysis apparatus 20 or the sensor unit 40, and various pieces of information may be converted into various pieces of information by the vibration mechanism so as to be presented to the user 2.

The angle calculation portion 216 applies z-axis angular velocities ω(0), ω(Δt), ω(2Δt, . . . , and ω(t) which are output from the angular velocity sensor 44 in a period of time from an initial time point t=0 to a time point t after measurement is started, to, for example, the following Equation (1), so as to calculate a angle Θ(t) of the crank 32 about the crank shaft 31 at the time point t.

Θ(t)=Θ(t−Δt)+ω(t)·Δ(t) (1)

Here, as an angle Θ(0) at the initial time point t=0, a value of an angle Θ′(0) at the initial time point t=0 is used (the angle Θ′ will be described later).

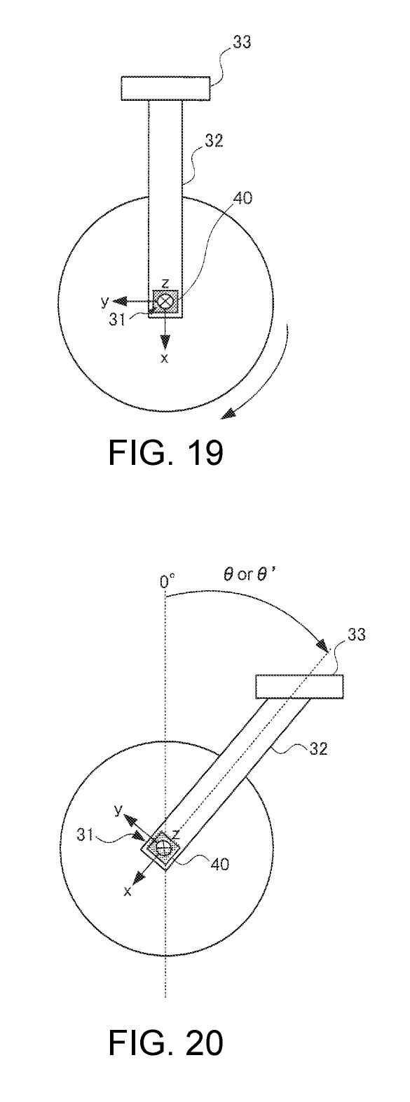

Here, as illustrated in FIGS. 19 and 20, a direction in which the angle Θ increases when the bicycle 3 advances is set as a positive direction of the angle θ.

Here, Equation (1) is useful regardless of whether the bicycle 3 is in a stoppage state or a constant velocity traveling state, but includes integration calculation (integration process), and thus has a problem that an error increases as an integration period is lengthened.

Therefore, the angle calculation portion 216 applies an x-axis acceleration aₓ(t) or a y-axis acceleration a_{y}(t) output from the acceleration sensor 42 at the time point t at which the bicycle 3 is in a stoppage state or a constant velocity traveling state, to, for example, the following Equation (2), so as to calculate an angle Θ′(t) of the crank 32 at the time point t.

$$( \begin{matrix}{a}_{x} ( t ) \\ {a}_{y} ( t )\end{matrix} ) = ( \begin{matrix}G cos {Θ}^{′} ( t ) \\ - G sin {Θ}^{′} ( t )\end{matrix} ) \qquad ( 2 )$$

Here, G indicates the gravitational acceleration. Here, as illustrated in FIGS. 19 and 20, the angle Θ′ of the crank 32 when the pedal 33 is located at the highest position is set to zero, and a direction in which the angle Θ′ increases when the bicycle 3 advances is set as a positive direction of the angle Θ′.

Equation (2) is an equation based on the z axis of the sensor unit 40 being parallel to a horizontal plane when the bicycle 3 is in a stoppage state or a constant velocity traveling state. In the present embodiment, instead of Equation (2), a predetermined equation may be used which is established even if the z axis of the sensor unit 40 is not parallel to the horizontal plane when the bicycle 3 is in a stoppage state or a constant velocity traveling state. The predetermined equation expresses the angle Θ(t) with functions of the x-axis acceleration aₓ(t), the y-axis acceleration a_{y}(t), and z-axis acceleration a_{z}(t).

However, Equation (2) or the predetermined equation is useful when the bicycle 3 is in a stoppage state or a constant velocity traveling state, but is not useful when the bicycle 3 is not in a stoppage state or a constant velocity traveling state. Thus, available timing of Equation (2) is restricted.

Therefore, the processing section 21 fundamentally reflects the angle Θ(t) calculated on the basis of Equation (1) in pedaling analysis data, and calculates the angle Θ′(t) when the bicycle 3 is in a stoppage state or a constant velocity traveling state, corrects the angle Θ(t) by using the angle Θ′(t), and reflects the corrected angle Θ(t) in the pedaling analysis data.

The angle correction portion 217 corrects the angle Θ(t) by using, for example, the following Equation (3).

$$Θ ( t ) = \frac{{Θ}^{′} ( t ) + Θ ( t )}{2} \qquad ( 3 )$$

The average expressed by Equation (3) is a simple average of the angle Θ(t) and the angle Θ′(t). However, the angle correction portion 217 may use a weighted average of the angle Θ(t) and the angle Θ′(t) as the average. In a case where the weighted average is used, the angle correction portion 217 may employ a ratio which is designated in advance by the user 2 as a ratio between a weight of the angle Θ′(t) and a weight of the angle Θ(t), and may adjust the ratio according to a difference between the angle Θ′(t) and the angle Θ(t).

The bias correction portion 218 performs bias correction of the angular velocity sensor 44 by using the angle Θ(t) when the bicycle 3 is in a stoppage state or a constant velocity traveling state. The bias correction is a process of predicting a bias value ω_{b} which overlaps in common to z-axis angular velocities ω(t+Δt), ω(t+2Δt), ω(t+Δt), . . . which are output from the angular velocity sensor 44 in order in the predetermined cycle Δt, and subtracting the bias value ω_{b} from each of the z-axis angular velocities ω(t+Δt), ω(t+2Δt), ω(t+3Δt), . . . .

The bias correction portion 218 obtains the angles Θ(t) and Θ′(t) at the time point t at which the bicycle 3 is in a stoppage state or a constant velocity traveling state, angles Θ(t−ΔT) and Θ′(t−ΔT) at the previous time point (t−ΔT) at which the bicycle 3 is in a stoppage state or a constant velocity traveling state, and a time interval ΔT between the two time points.

The bias correction portion 218 applies the angles Θ(t), Θ′(t), Θ(t−ΔT), Θ′(t−ΔT) and ΔT to, for example, the following Equation (4), so as to calculate the bias value ω_{b} which is subtracted from each of the z-axis angular velocities ω(t), ω(t+Δt), ω(t+2Δt, . . . .

$$\{ \begin{matrix}{ω}_{b} = \frac{{ΔΘ}^{′} ( t ) - ΔΘ ( t )}{Δ T} \\ {ΔΘ}^{′} ( t ) = {Θ}^{′} ( t ) - {Θ}^{′} ( t - Δ T ) \\ ΔΘ ( t ) = Θ ( t ) - Θ ( t - Δ T )\end{matrix} \qquad ( 4 )$$

The determination portion 219 determines whether or not the bicycle 3 is in a stoppage state or a constant velocity traveling state. For example, in a case where the magnitude of a difference between a combined value n₀(t) of the x-axis acceleration aₓ(t), the y-axis acceleration a_{y}(t), and z-axis acceleration a_{z}(t) output from the acceleration sensor 42, and the gravitational acceleration G is equal to or less than a predetermined threshold value, the determination portion 219 determines that the bicycle 3 is in a stoppage state or a constant velocity traveling state, and if otherwise, the determination portion 219 determines that the bicycle 3 is not in a stoppage state or a constant velocity traveling state.

For example, the predetermined threshold value is set to be equivalent to the maximum value of the magnitude of the difference, obtained when the bicycle 3 is actually in a stoppage state or a constant velocity traveling state.

The determination portion 219 calculates the combined value n₀(t) of the x-axis acceleration aₓ(t), the y-axis acceleration a_{y}(t), and z-axis acceleration a_{z}(t) by using, for example, the following Equation (5).

n₀(t)=\sqrt{aₓ(t)²+a_{y}(t)²+a_{z}(t)²} (5)

### 3-5. Display Screen of Pedaling Analysis Data

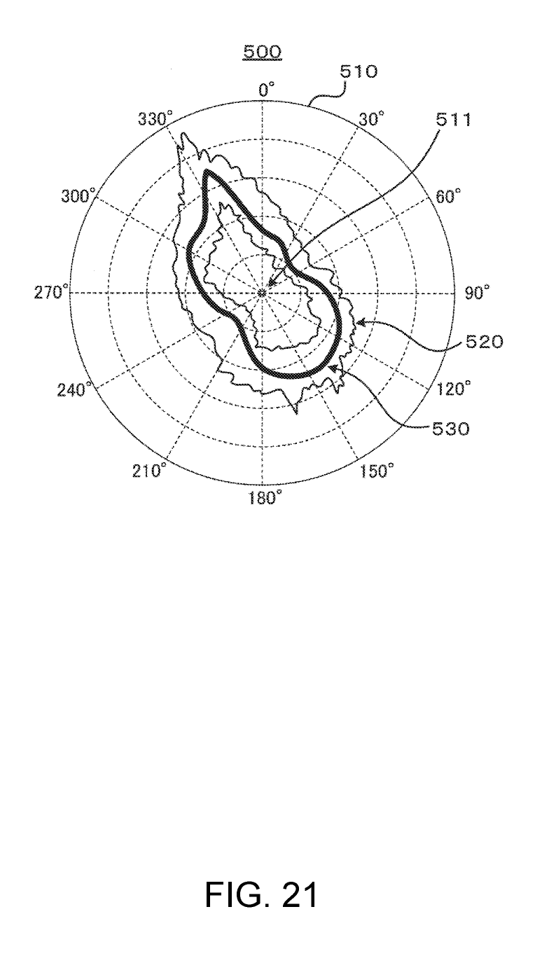

FIG. 21 is a diagram illustrating an example of a screen displayed on the display section 25.

A screen 500 includes an image 510, an image 520, and an image 530. The image 510 indicates a coordinate system. The image 510 is a circular region centering on the origin 511. The image 510 indicates a rotation angle with a position in a circumferential direction, and indicates the magnitude of a value with a distance from the origin 511. This coordinate system may also be referred to as a polar coordinate system. An upper end and a lower end of an axis in a vertical direction respectively correspond to 0 degrees and 180 degrees of the angle Θ of the crank 32, and a right end and a left end of an axis in a horizontal direction respectively correspond to 90 degrees and 270 degrees of the angle Θ of the crank 32. The image 520 indicating angular velocity ω(Θ) at the angle Θ and the image 530 indicating an average of angular velocities ω(Θ) at the angle Θ are plotted on a coordinate plane indicated by the image 510. In FIG. 21, scales of the angle Θ are added at intervals of 30 degrees in the image 510. In FIG. 21, two images 520 corresponding to two rotations of the crank 32 are displayed, but an image 520 corresponding to one rotation or images 520 corresponding to three or more rotations may be displayed.

FIG. 21 illustrates an example of displaying the pedaling analysis data mainly including the angle Θ as an index, but pedaling analysis data including the angular velocity ω(Θ), angular acceleration ω′(Θ), and the like may also be displayed.

### 3-6. Generation Process of Pedaling Analysis Data

The pedaling analysis portion 211 generates pedaling analysis data including the angle Θ, the angular velocity ω, and the angular acceleration ω′ as follows, and reflects the pedaling analysis data on the screen 500 in order via the image data generation portion 212 and the display processing portion 214.

The pedaling analysis portion 211 calculates an angular velocity ω(Θ) of the crank 32 at each angle Θ of the crank 32 on the basis of an angular velocity ω(t) of the crank 32 at each time point t and the angle Θ(t) of the crank 32 at each time point t. The pedaling analysis portion 211 differentiates the angular velocity ω(Θ) at each angle Θ with respect to angles so as to calculate an angular acceleration ω′(Θ).

The pedaling analysis portion 211 calculates offset target values of the angular velocity ω(Θ) and the angular acceleration ω′(Θ) for each angle Θ.

The pedaling analysis portion 211 selects the lowest value from among the angular velocities ω(Θ) at the respective angles Θ within a predetermined period of time such as the latest one minute, and sets the lowest value as the offset target value of the angular velocity ω(Θ).

The pedaling analysis portion 211 selects the lowest value from among the angular accelerations ω′(Θ) at the respective angles Θ within a predetermined period of time such as the latest one minute, and sets the lowest value as the offset target value of the angular acceleration ω′(Θ).

The offset target value is not limited to the lowest value, and may be, for example, a value such as an average value within a period of time, a set threshold value. The threshold value may be designated by the user 2 via, for example, the operation section 23.

The pedaling analysis portion 211 acquires the angular velocity ω(Θ) for each rotation, and subtracts the offset target value therefrom. The pedaling analysis portion 211 plots an angular velocity ω(Θ) obtained by subtracting the offset target value at a corresponding position on the coordinate plane, so as to generate the image 520 for each rotation.

The pedaling analysis portion 211 acquires an average angular velocity ω_{AVE}(Θ) at each angle Θ, and subtracts the offset target value therefrom. The pedaling analysis portion 211 plots an average angular velocity ω_{AVE}(Θ) obtained by subtracting the offset target value at a corresponding position on the coordinate plane, so as to generate the image 530. A value of the origin 511 corresponds to the offset target value of the angular velocity.

### 3-7. Pedaling Analysis Process

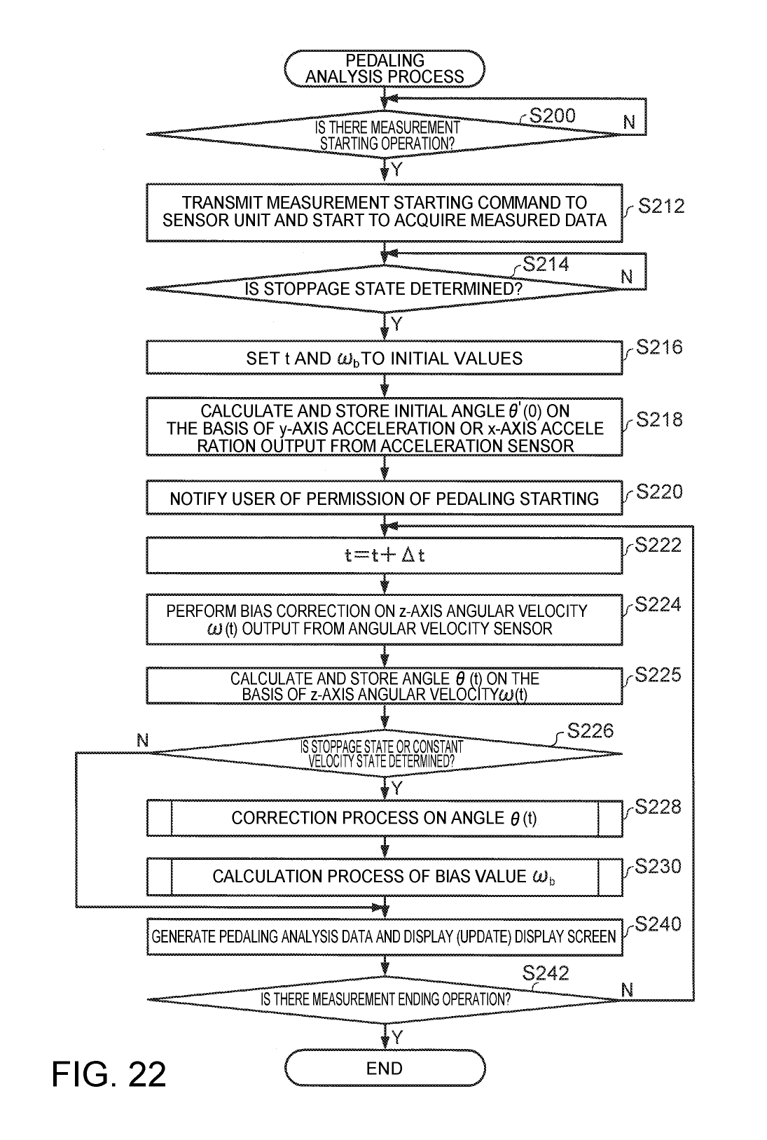

FIG. 22 is a flowchart illustrating examples of procedures of a pedaling analysis process (an example of a pedaling measurement method). The processing section 21 performs the pedaling analysis process, for example, according to the procedures shown in the flowchart of FIG. 22 by executing the pedaling analysis program 240 stored in the storage section 24. Hereinafter, the flowchart of FIG. 22 will be described.

Step S200: The processing section 21 waits for the user 2 to perform a measurement starting operation (N in step S200), and proceeds to step S212 if the measurement starting operation is performed (Y in step S200).

Step S212: The processing section 21 transmits a measurement starting command to the sensor unit 40, and starts to acquire measured data from the sensor unit 40.

Step S214: The processing section 21 determines whether or not the bicycle 3 is in a stoppage state by using three-axis accelerations included in the measured data acquired from the sensor unit 40, proceeds to step S216 if it is detected that the bicycle 3 is in a stoppage state (Y in step S214), and waits if otherwise (N in step S214). Determination of a stoppage state of the bicycle 3 may be performed in the same manner as in a process (which will be described later) of determining whether or not the bicycle 3 is in a stoppage state or a constant velocity traveling state.

Step S216: The processing section 21 sets a value of the present time point t to an initial value (zero), and sets a value of the bias value ω_{b} stored in the bias value data 250 to an initial value. As the initial value of the bias value ω_{b}, an output value of the angular velocity sensor at the time point t=0 is used without being changed.

Step S218: The processing section 21 calculates an angle Θ′(0) of the crank 32 at the initial time point t=0 on the basis of the three-axis accelerations output from the acceleration sensor 42, and stores the angle in the angle data 244 of the storage section 24 along with the time point t=0.

Step S220: The processing section 21 notifies the user 2 of permission of pedaling starting. The processing section 21 outputs, for example, a predetermined sound, or an LED is provided in the sensor unit 40, and the LED is lighted, so that the user 2 is notified of permission of pedaling starting. The user 2 confirms the notification and then starts a pedaling action.

Step S222: The processing section 21 waits for the sampling cycle Δt of the measured data from the execution timing of step S218, then increments the time point t by Δt, and proceeds to the next step S224. A time interval until this step S222 is executed next is set to be the same as the sampling cycle Δt. Therefore, a series of processes from this step S222 to step S242 which will be described later is repeatedly performed in the cycle Δt.

Step S224: The processing section 21 subtracts the value of the bias correction value ω_{b} stored in the bias value data 250 from the z-axis angular velocity ω(t) output from the angular velocity sensor 44, so as to perform bias correction on the z-axis angular velocity ω(t).

Step S225: The processing section 21 calculates the angle Θ(t) at the time point t on the basis of the z-axis angular velocity ω(t) having undergone the bias correction and the previous value Θ(t−Δt) of the angle Θ(t), and stores the angle in the angle data 246 of the storage section 24 along with the present time point t. In the first step S225, the value of the angle Θ′(0) calculated in step S218 is used as the previous value Θ(t−Δt) of the angle Θ(t).

Here, the processing section 21 in this step also calculates the angle Θ(t) (the angle Θ(t) not having undergone the bias correction) based on the z-axis angular velocity ω(t) not having undergone the bias correction in addition to the angle Θ(t) (the angle Θ(t) having undergone the bias correction) based on the z-axis angular velocity ω(t) having undergone the bias correction, and stores the angle in the angle data 246 of the storage section 24 along with the present time point t.

In the angle data 246, the angle Θ(t) having undergone the bias correction is differentiated from the angle Θ(t) not having undergone the bias correction. Above all, the angle Θ(t) having undergone the bias correction is used for the subsequent angle correction process (step S228), and the angle Θ(t) not having undergone the bias correction is used for the subsequent bias value calculation process (step S230).

Step S226: The processing section 21 performs a process (which will be described later) of determining whether or not the bicycle 3 is in a stoppage state or a constant velocity traveling state, proceeds to step S228 if it is determined that the bicycle 3 is in a stoppage state or a constant velocity traveling state (Y in step S226), and proceeds to step S240 if otherwise (N in step S226).

Step S228: The processing section 21 performs a process of correcting the angle Θ(t). The process of correcting the angle Θ(t) will be described later.

Step S230: The processing section 21 performs a process of calculating the bias value ω_{b}. The process of calculating the bias value ω_{b} will be described later.

Step S240: The processing section 21 generates pedaling analysis data on the basis of the indexes (the angle Θ(t) having undergone the bias correction, the angular velocity ω(t) having undergone the bias correction, and the like) acquired in steps S222 to S230, and displays (updates) a display screen on the basis of the pedaling analysis data.

In the flow illustrated in FIG. 22, an update cycle of the display screen is the same as the sampling cycle Δt, but the display screen may be updated when the crank 32 is rotated once (the angle Θ(t) having undergone angle correction reaches 360°).

Step S242: The processing section 21 determines whether or not the user 2 performs a measurement ending operation, finishes the flow if the measurement ending operation is performed (Yin step S242), and proceeds to step S222 if the measurement ending operation is not performed (N in step S242).

In the flowchart of FIG. 22, order of the respective steps may be changed as appropriate within an allowable range, some of the steps may be omitted or changed, and other steps may be added thereto.

### 3-8. Determination Process

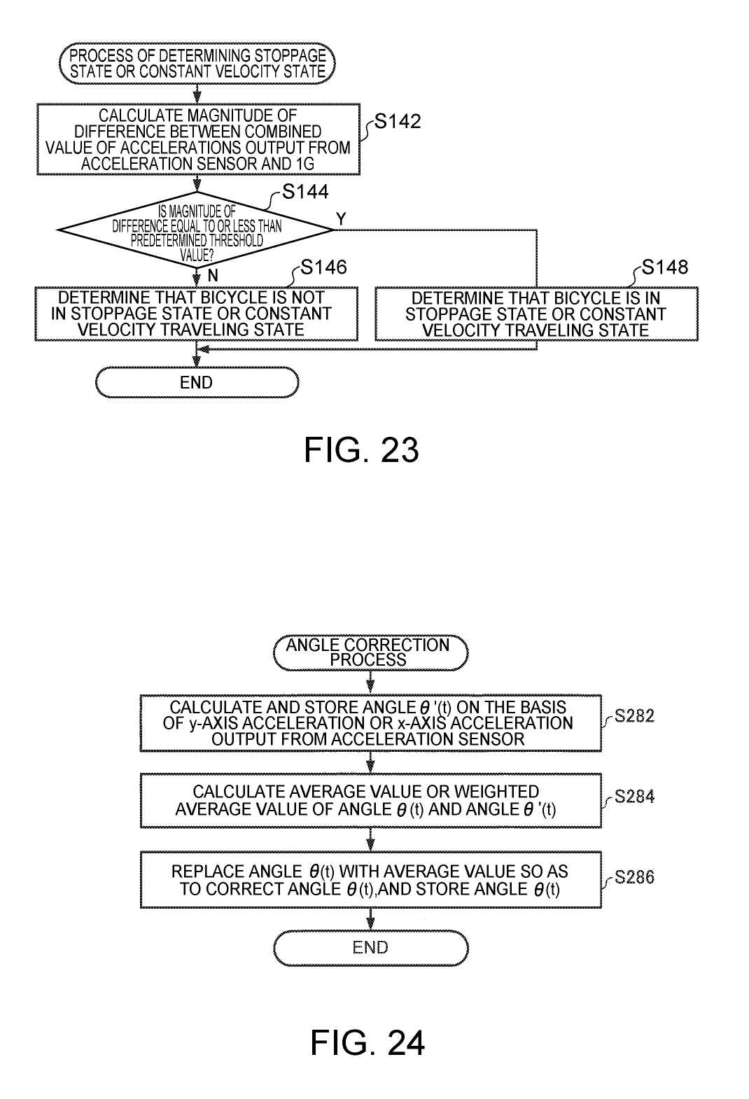

FIG. 23 is a flowchart illustrating examples of procedures of the process of determining stoppage or a constant velocity traveling state. The processing section 21 performs the process of determining stoppage or a constant velocity traveling state, for example, according to the procedures shown in the flowchart of FIG. 23 by executing the pedaling analysis program 240 stored in the storage section 24. Hereinafter, the flowchart of FIG. 23 will be described.

Step S142: The processing section 21 calculates the magnitude of a difference between the combined value n₀(t) of the three-axis accelerations output from the acceleration sensor 42 and the gravitational acceleration G.

Step S144: The processing section 21 determines whether or not the magnitude of the difference is equal to or less than a predetermined threshold value, proceeds to step S148 if the magnitude is equal to or less than the threshold value (Yin step S144), and proceeds to step S146 if otherwise (N in step S144).

Step S146: The processing section 21 determines that the bicycle 3 is not in a stoppage state or a constant velocity traveling state, and finishes the flow.

Step S148: The processing section 21 determines that the bicycle 3 is in a stoppage state or a constant velocity traveling state, and finishes the flow.

### 3-9. Angle Correction Process

FIG. 24 is a flowchart illustrating examples of procedures of an angle correction process. The processing section 21 performs the angle correction process, for example, according to the procedures shown in the flowchart of FIG. 24 by executing the pedaling analysis program 240 stored in the storage section 24. Hereinafter, the flowchart of FIG. 24 will be described.

Step S282: The processing section 21 calculates the angle Θ′(t) on the basis of the y-axis acceleration or the x-axis acceleration output from the acceleration sensor 42, and stores the angle in the angle data 244 of the storage section 24 along with the present time point t.

Step S284: The processing section 21 calculates an average value (or a weighted average value) of the angle Θ(t) and the angle Θ′(t). The angle Θ(t) used for this calculation is the angle Θ(t) having undergone the bias correction.

Step S286: The processing section 21 replaces the angle Θ(t) with the average value so as to correct (angle-correct) the angle Θ(t), and stores the angle Θ(t) having undergone the angle correction in the angle data 246 of the storage section 24 along with the present time point t. Consequently, the angle Θ(t) (here, the angle Θ(t) having undergone the bias correction) in the angle data 246 is updated.

### 3-10. Bias Value Calculation Process

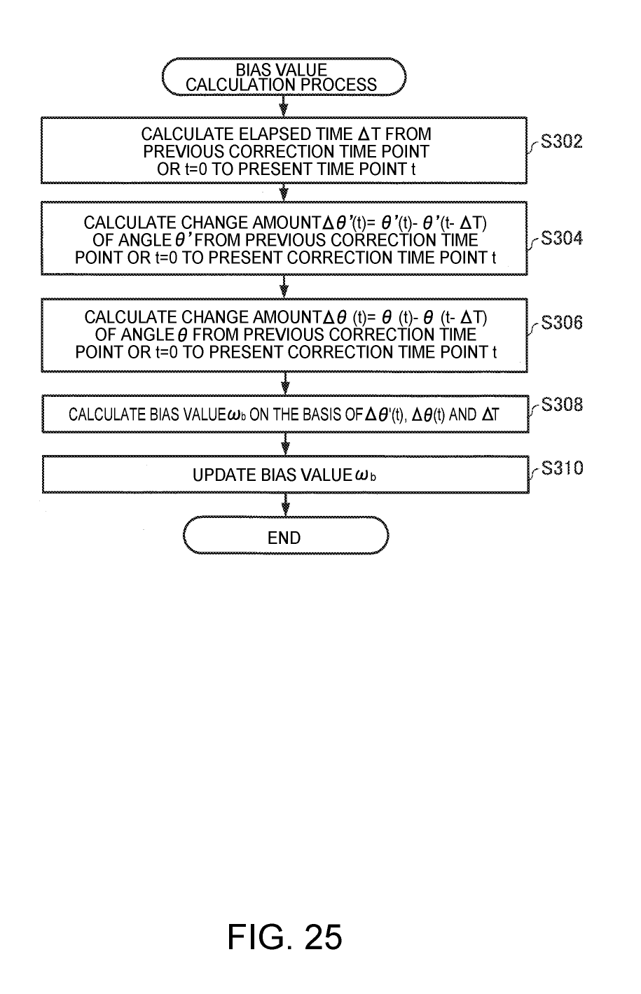

FIG. 25 is a flowchart illustrating examples of procedures of a bias value calculation process. The processing section 21 performs the bias value calculation process, for example, according to the procedures shown in the flowchart of FIG. 25 by executing the pedaling analysis program 240 stored in the storage section 24. Hereinafter, the flowchart of FIG. 25 will be described.

Step S302: The processing section 21 calculates an elapsed time ΔT from the previous correction time point (t−ΔT) to the present time point t.

At this time, the processing section 21 regards a time point t correlated with a second new angle Θ′ among the angles Θ′(t) stored in the angle data 244 of the storage section 24, as the previous correction time point (t−ΔT).

However, in a case where there is no second new angle Θ′ (that is, the number of angles Θ′ stored in the angle data 244 is one), the processing section 21 regards the initial time point t=0 as the previous correction time point (t−ΔT). In a case where the number of angles Θ′ stored in the angle data 244 is zero, the processing section 21 finishes the flow of FIG. 25.

Step S304: The processing section 21 calculates a change amount ΔΘ′(t)=Θ′(t)−Θ′(t−ΔT) of the angle Θ′ from the previous correction time point (t−ΔT) to the present correction time point t.

Step S306: The processing section 21 calculates a change amount ΔΘ(t)=Θ(t)−Θ(t−ΔT) of the angle Θ from the previous correction time point (t−ΔT) to the present correction time point t. The angle Θ used for this calculation is the angle Θ(t) not having undergone the bias correction.

Step S308: The processing section 21 calculates the bias value ω_{b} on the basis of the change amounts Δζ′(t), ΔΘ(t) and ΔT calculated in steps S302 to S306.

Step S310: The processing section 21 stores the calculated bias value ω_{b} in the bias value data 250 of the storage section 24. Consequently, the bias value ω_{b} in the bias value data 250 is updated. The updated bias value ω_{b} is used for bias correction is the subsequent step S224.

### 4. Fourth Embodiment

### 4-1. Outline of Pedaling Analysis System

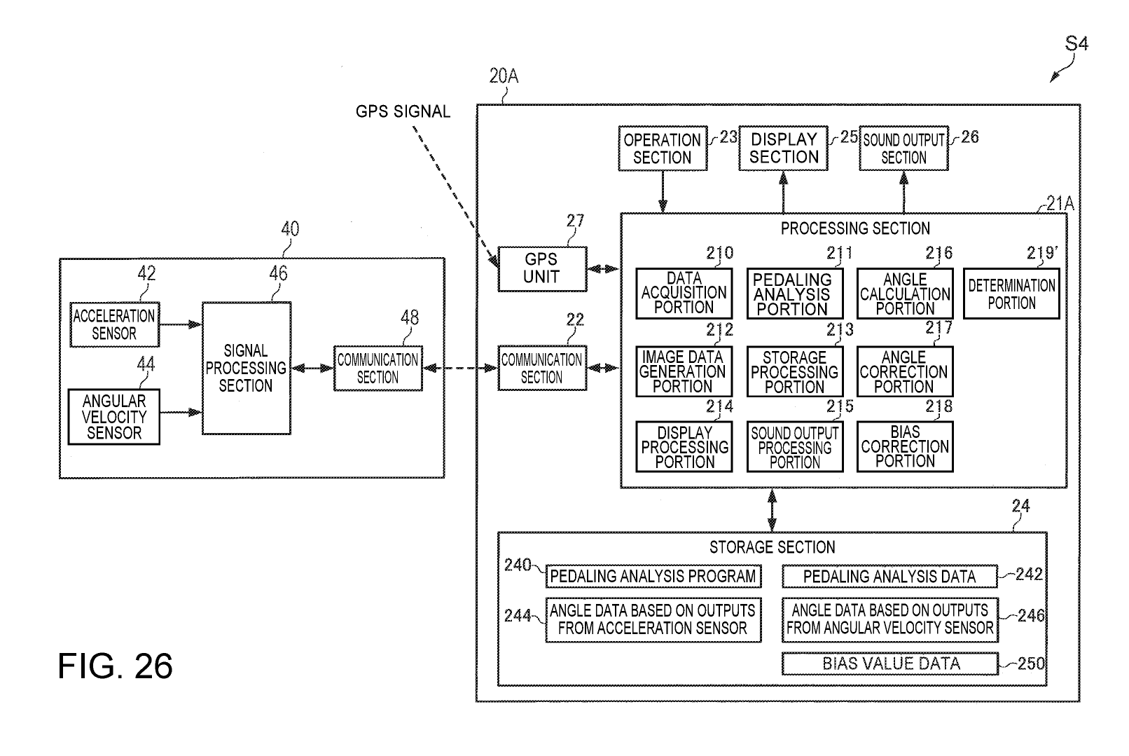

FIG. 26 is a diagram illustrating a configuration example of a pedaling analysis system S4 according to a fourth embodiment. Here, a description will be made focusing on differences from the third embodiment, and the same constituent elements as in the third embodiment are given the same reference numerals.

As illustrated in FIG. 26, the pedaling analysis system S4 of the present embodiment corresponds to including a pedaling analysis apparatus 20A instead of the pedaling analysis apparatus 20 in the pedaling analysis system S3 of the third embodiment. The pedaling analysis apparatus 20A of the present embodiment corresponds to further including a global positioning system (GPS) unit 27, and including a determination portion 219′ instead of the determination portion 219 in the pedaling analysis apparatus 20 of the third embodiment.

The pedaling analysis apparatus 20A of the present embodiment includes a processing section 21A, and the processing section 21A includes the determination portion 219′ instead of the determination portion 219 in the processing section 21 of the third embodiment.

The GPS unit 27 receives a GPS signal from one or a plurality of GPS satellites, generates positioning data such as a position (hereinafter, referred to as a “GPS position”) of the pedaling analysis apparatus 20A and a velocity vector (hereinafter, referred to as a “GPS velocity vector”) on the basis of the GPS signal, and transmits the positioning data to the data acquisition portion 210. The data acquisition portion 210 transmits the positioning data to the processing section 21A along with measured data.

The determination portion 219′ of the processing section 21A determines a stoppage state or a constant velocity state on the basis of the GPS velocity vector output from the GPS unit 27 without using outputs from the acceleration sensor 42.

Since the GPS velocity vector is expressed in a global coordinate system fixed on the earth, a velocity (GPS velocity) of the pedaling analysis apparatus 20A obtained on the basis of the GPS velocity vector indicates whether or not the bicycle 3 is in a stoppage state, and an acceleration (GPS acceleration) of the pedaling analysis apparatus 20A indicates that the bicycle 3 is in a constant velocity state. The GPS velocity may be calculated as, for example, the magnitude (a combined value of velocity components) of the GPS velocity vector. The GPS acceleration may be calculated as time differentiation of the GPS velocity.

For example, the determination portion 219′ determines that the bicycle 3 is in a stoppage state if the GPS velocity is equal to or less than a predetermined threshold value (for example, 0.1 m/s), and determines that the bicycle 3 is not in a stoppage state if otherwise.

The determination portion 219′ determines that the bicycle 3 is in a constant velocity state if the GPS acceleration is equal to or less than a predetermined threshold value (for example, 0.1 m/s/s), and determines that the bicycle 3 is not in a constant velocity state if otherwise.

### 4-2. Determination Process

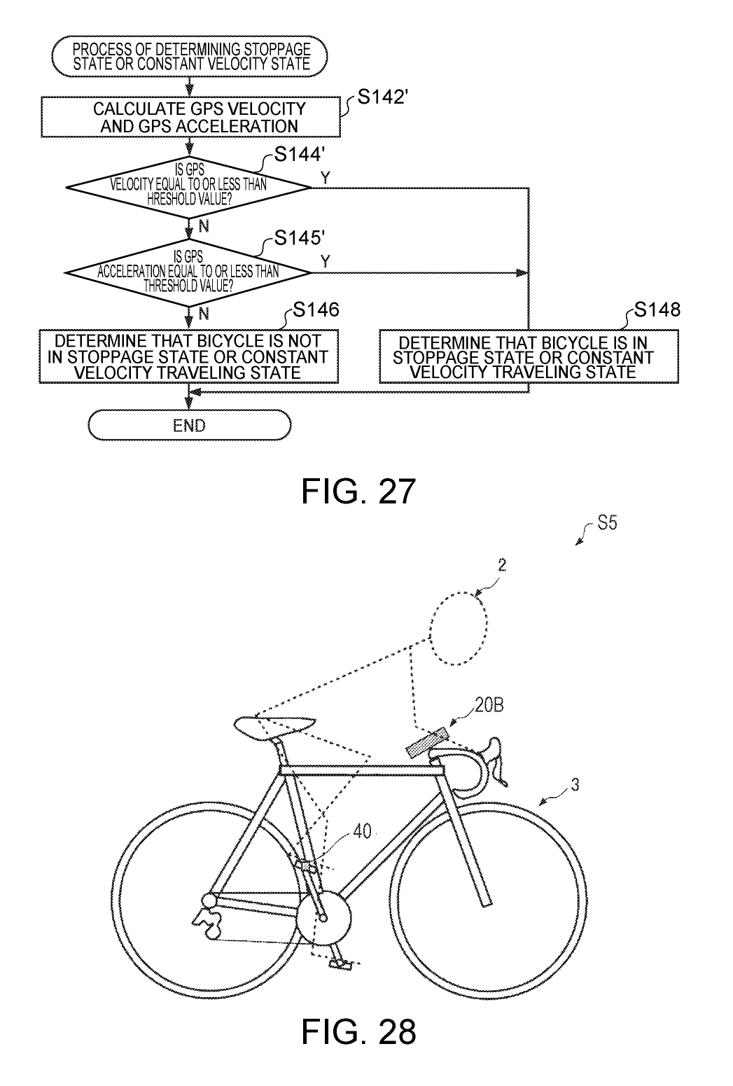

FIG. 27 is a flowchart illustrating examples of procedures of a process of determining a stoppage state or a constant velocity state. The processing section 21A performs the process of determining a stoppage state or a constant velocity state, for example, according to the procedures shown in the flowchart of FIG. 27 by executing the pedaling analysis program 240 stored in the storage section 24. Hereinafter, the flowchart of FIG. 27 will be described.

Step S142′: The processing section 21A calculates a GPS velocity and a GPS acceleration on the basis of a GPS velocity vector output from the GPS unit 27.

Step S144′: The processing section 21A determines whether or not the GPS velocity is equal to or less than a predetermined threshold value, proceeds to step S148 if the GPS velocity is equal to or less than the predetermined threshold value (Y in step S144′), and proceeds to step S145′ if otherwise (N in step S144′).

Step S145′: The processing section 21A determines whether or not the GPS acceleration is equal to or less than a predetermined threshold value, proceeds to step S148 if the GPS acceleration is equal to or less than the predetermined threshold value (Yin step S145′), and proceeds to step S146 if otherwise (N in step S145′).

Step S146: The processing section 21A determines that the bicycle 3 is not in a stoppage state or a constant velocity traveling state, and finishes the flow.

Step S148: The processing section 21A determines that the bicycle 3 is in a stoppage state or a constant velocity traveling state, and finishes the flow.

### 5. Appendix of Embodiments

The processing sections 21 and 21A may calculate a weighted average value as an average value of each of the angle Θ′(t) and the angle Θ′(t) in step S284. In a case where the weighted average is calculated, the processing section 21 may employ a ratio which is designated in advance by the user 2 as a ratio between a weight of the angle Θ′(t) and a weight of the angle Θ(t), and may adjust the ratio according to a difference between the angle Θ′(t) and the angle Θ(t).

As the weight of the angle Θ′ is increased, the correction intensity is heightened, but there is a higher probability that an unnatural step difference may occur in a temporal change curve of the corrected angle Θ. On the other hand, as the weight of the angle Θ′ is reduced, the correction intensity is lowered, but there is a lower probability that an unnatural step difference may occur in a temporal change curve of the corrected angle Θ.

Therefore, in step S284, the processing sections 21 and 21A may reduce the weight of the angle Θ′ in order to decrease a probability that an unnatural step difference may occur in a temporal change curve of the corrected angle Θ, for example, in a case where a difference between the angle Θ′(t) and the angle Θ(t) is greater than a predetermined threshold value, and may increase the weight of the angle Θ′ in order to increase correction intensity in a case where the difference is equal to or smaller than the predetermined threshold value.

In the above-described third embodiment, the number of detection axes of the angular velocity sensor 44 is one, and the number of detection axes of the acceleration sensor 42 is three, but the number of detection axes of the angular velocity sensor 44 may be one or larger, that is, plural, and the number of detection axes of the acceleration sensor 42 may be two. However, in a case where the number of detection axes of the acceleration sensor 42 is two, detection axes along an x axis direction and a y axis direction are not omitted.

In the above-described fourth embodiment, the number of detection axes of the angular velocity sensor 44 is one, and the number of detection axes of the acceleration sensor 42 is three, but the number of detection axes of the angular velocity sensor 44 may be one or larger, that is, plural, and the number of detection axes of the acceleration sensor 42 may be one or two. However, in a case where the number of detection axes of the acceleration sensor 42 is one or two, a detection axis along an x axis direction or a y axis direction is not omitted.

The processing section 21 or 21A according to the third embodiment or the fourth embodiment performs both of the angle correction process (FIG. 24) and the bias correction process (FIG. 25), but may omit one of the processes. For example, in a case where the bias correction process is omitted, steps S224 and S230 are omitted, and in a case where the angle correction process is omitted, step S228 is omitted.

A single pedaling analysis apparatus may be configured to include a processing section which can perform both of the determination process (FIG. 23) in the third embodiment and the determination process (FIG. 27) in the fourth embodiment. In this case, the processing section may perform comprehensive determination on the basis of a result of the determination process in the third embodiment and a result of the determination process in the fourth embodiment, and may separately use the result of the determination process in the third embodiment and the result of the determination process in the fourth embodiment depending on situations (the reception intensity of a GPS signal, or frequency in which the bicycle 3 is brought into a stoppage state or a constant velocity state).

In the fourth embodiment, a global positioning system (GPS) is used, but a global navigation satellite system (GNSS) may be used. For example, one or two or more of satellite positioning systems such as a European geostationary-satellite navigation overlay service (EGNOS), a quasi zenith satellite system (QZSS), a global navigation satellite system (GLONASS), GALILEO, a BeiDou navigation satellite system (BeiDou) may be used. As at least one of the satellite positioning systems, a satellite-based augmentation system (SBAS) such as European geostationary-satellite navigation overlay service (EGNOS) or a wide area augmentation system (WAAS) may be used.

### 6. Operations and Effects of Embodiments

(1) A pedaling measurement apparatus (pedaling analysis apparatuses 20 and 20A) according to the above-described embodiments includes an acquisition portion (data acquisition portion 210) that acquires outputs (measured data) from an acceleration sensor (acceleration sensor 42) and an angular velocity sensor (angular velocity sensor 44) detecting motion of a crank of a bicycle; a calculation portion (angle calculation portion 216) that calculates an angle (angle Θ) of the crank on the basis of the output (angular velocity ω) from the angular velocity sensor (angular velocity sensor 44); and an angle correction portion (angle correction portion 217) that corrects the angle (angle Θ) of the crank or a bias correction portion (bias correction portion 218) that performs bias correction on the output (angular velocity ω) from the angular velocity sensor (angular velocity sensor 44), on the basis of the outputs (three-axis accelerations) from the acceleration sensor (acceleration sensor 42) at stoppage or during constant velocity traveling of the bicycle.

The output (angular velocity ω) from the angular velocity sensor includes a bias. An angle based on outputs from the angular velocity sensor requires an integration process. Thus, if calculation of an angle is continuously performed (that is, the number of integration processes increases), an angle error is accumulated. On the other hand, the outputs (three-axis accelerations) from the acceleration sensor do not indicate an angle (angle Θ) of the crank when the bicycle is accelerated, but may accurately indicate an angle (angle Θ) of the crank or the extent of the bias when the bicycle is not accelerated. Therefore, the correction portion (the angle correction portion 217 or the bias correction portion 218) corrects the angle (angle Θ) of the crank or the output (angular velocity ω) from the angular velocity sensor (angular velocity sensor 44) on the basis of the outputs (three-axis accelerations) from the acceleration sensor (acceleration sensor 42) at stoppage or during constant velocity traveling of the bicycle. As a result, the pedaling measurement apparatus (the pedaling analysis apparatuses 20 and 20A) can reduce an angle error accumulated in the angle (angle Θ) or a bias occurring in the output from the angular velocity sensor (angular velocity sensor 44) at least at a timing at which the bicycle is stopped or is traveling at a constant velocity. Therefore, the pedaling measurement apparatus (the pedaling analysis apparatuses 20 and 20A) can measure rotation motion of the crank of the bicycle accompanied by acceleration, that is, rotation motion of the crank of the bicycle which is traveling on a field, with high accuracy.

(2) In the pedaling measurement apparatus (the pedaling analysis apparatuses 20 and 20A) according to the above-described embodiments, the angle correction portion (angle correction portion 217) obtains an average value or a weighted average value of an angle (angle Θ) of the crank calculated on the basis of the outputs from the acceleration sensor (acceleration sensor 42) and an angle (angle Θ′) of the crank calculated on the basis of the output from the angular velocity sensor (angular velocity sensor 44) at stoppage or during constant velocity traveling of the bicycle, as a corrected angle (angle Θ) of the crank.

As mentioned above, if an average value or a weighted average value of the angle (angle Θ) of the crank calculated on the basis of the outputs from the acceleration sensor (acceleration sensor 42) and an angle (angle Θ′) of the crank calculated on the basis of the output from the angular velocity sensor (angular velocity sensor 44) is obtained as a corrected angle (angle Θ) of the crank, it is possible to reduce the occurrence of a steep step difference in a temporal change curve of the angle (angle Θ) of the crank.

(3) In the pedaling measurement apparatus (the pedaling analysis apparatuses 20 and 20A) according to the above-described embodiments, the bias correction portion (bias correction portion 218) obtains a change amount (Equation (4)) per unit time of a difference between an angle (angle Θ′) of the crank calculated on the basis of the outputs (three-axis accelerations) from the acceleration sensor (acceleration sensor 42) and an angle (angle Θ) of the crank calculated on the basis of the output from the angular velocity sensor (angular velocity sensor 44) at stoppage or during constant velocity traveling of the bicycle, as a bias value (bias value ω_{b}) included in the output from the angular velocity sensor (angular velocity sensor 44).

As mentioned above, if a change amount (Equation (4)) per unit time of a difference between an angle (angle Θ′) of the crank calculated on the basis of the outputs (three-axis accelerations) from the acceleration sensor (acceleration sensor 42) and an angle (angle Θ) of the crank calculated on the basis of the output from the angular velocity sensor (angular velocity sensor 44) is obtained as a bias value (bias value ω_{b}), it is possible to perform bias correction with high accuracy.

(4) The pedaling measurement apparatus (pedaling analysis apparatus 20) according to the above-described third embodiment further includes a determination portion (determination portion 219) that determines that the bicycle is stopped or is traveling at a constant velocity in a case where it is detected that accelerations other than the gravitational acceleration are not generated in the crank on the basis of the outputs (three-axis accelerations) from the acceleration sensor (acceleration sensor 42).

Therefore, it is possible to use the outputs from the acceleration sensor for determination of whether or not the bicycle is stopped or is traveling at a constant velocity.

(5) In the pedaling measurement apparatus (pedaling analysis apparatus 20A) according to the above-described fourth embodiment, the acquisition portion (data acquisition portion 210) further acquires a velocity (GPS velocity) of the bicycle calculated on the basis of a positioning signal (GPS signal), and the pedaling measurement apparatus further includes a determination portion (determination portion 219′) that determines that the biological signal is stopped or is traveling at a constant velocity in a case of detecting that the velocity (GPS velocity) of the bicycle is equal to or less than a predetermined threshold value or an acceleration (GPS acceleration) of the bicycle is equal to or less than a predetermined threshold value.

Therefore, it is possible to use the positioning signal (GPS signal) for determination of whether or not the bicycle is stopped or is traveling at a constant velocity.

(6) In the pedaling measurement apparatus (the pedaling analysis apparatuses 20 and 20A) according to the above-described embodiments, a detection axis (z axis) of the acceleration sensor (acceleration sensor 42) or the angular velocity sensor (angular velocity sensor 44) is present on a rotation shaft (crank shaft 31) of the crank or an extension line of the rotation shaft.

Therefore, it is possible to obtain an angle of the crank based on outputs from the acceleration sensor, an angle of the crank based on outputs from the angular velocity sensor, or a state of the bicycle based on the outputs from the acceleration sensor, through simple computation.

(7) A pedaling measurement system (pedaling analysis systems S3 and S4) according to the above-described embodiments includes the pedaling measurement apparatus (pedaling analysis apparatuses 20 and 20A); and the acceleration sensor (acceleration sensor 42) and the angular velocity sensor (angular velocity sensor 44).

(8) A pedaling measurement method (pedaling analysis method) according to the above-described embodiments includes an acquisition procedure (step S212) of acquiring outputs (measured data) from an acceleration sensor (acceleration sensor 42) and an angular velocity sensor (angular velocity sensor 44) detecting motion of a crank of a bicycle; a calculation procedure (step S225) of calculating an angle (angle Θ) of the crank on the basis of the output (angular velocity ω) from the angular velocity sensor (angular velocity sensor 44); and an angle correction procedure (step S228) of correcting the angle (angle Θ) of the crank or a bias correction procedure (steps S230 and S224) of performing bias correction on the output (angular velocity ω) from the angular velocity sensor (angular velocity sensor 44), on the basis of the outputs (three-axis accelerations) from the acceleration sensor (acceleration sensor 42) at stoppage or during constant velocity traveling of the bicycle.

(9) A pedaling measurement program (pedaling analysis program) according to the above-described embodiments causes a computer (processing sections 21 and 21A) to execute an acquisition procedure (step S212) of acquiring outputs (measured data) from an acceleration sensor (acceleration sensor 42) and an angular velocity sensor (angular velocity sensor 44) detecting motion of a crank of a bicycle; a calculation procedure (step S225) of calculating an angle (angle Θ) of the crank on the basis of the output (angular velocity ω) from the angular velocity sensor (angular velocity sensor 44); and an angle correction procedure (step S228) of correcting the angle (angle Θ) of the crank or a bias correction procedure (steps S230 and S224) of performing bias correction on the output (angular velocity ω) from the angular velocity sensor (angular velocity sensor 44), on the basis of the outputs (three-axis accelerations) from the acceleration sensor (acceleration sensor 42) at stoppage or during constant velocity traveling of the bicycle.

(10) A recording medium according to the above-described embodiments records a pedaling measurement program (pedaling analysis program) causing a computer (processing sections 21 and 21A) to execute an acquisition procedure (step S212) of acquiring outputs (measured data) from an acceleration sensor (acceleration sensor 42) and an angular velocity sensor (angular velocity sensor 44) detecting motion of a crank of a bicycle; a calculation procedure (step S225) of calculating an angle (angle Θ) of the crank on the basis of the output (angular velocity ω) from the angular velocity sensor (angular velocity sensor 44); and an angle correction procedure (step S228) of correcting the angle (angle Θ) of the crank or a bias correction procedure (steps S230 and S224) of performing bias correction on the output (angular velocity ω) from the angular velocity sensor (angular velocity sensor 44), on the basis of the outputs (three-axis accelerations) from the acceleration sensor (acceleration sensor 42) at stoppage or during constant velocity traveling of the bicycle.

### 7. Other Modification Examples

The invention is not limited to the third and fourth embodiments, and may be variously modified within the scope of the spirit of the invention.

For example, in the third and fourth embodiments, the acceleration sensor 42 and the angular velocity sensor 44 are built into and are thus integrally formed as the sensor unit 40, but the acceleration sensor 42 and the angular velocity sensor 44 may not be integrally formed. Alternatively, the acceleration sensor 42 and the angular velocity sensor 44 may not be built into the sensor unit 40, and may be directly mounted on the bicycle 3.

### 8. Fifth Embodiment

### 8-1. Outline of Pedaling Analysis System

FIG. 28 is a diagram illustrating an example of an exterior of a pedaling analysis system according to a fifth embodiment.

As illustrated in FIG. 28, a pedaling analysis system S5 (an example of a pedaling measurement system) is configured to include a sensor unit 40 (an example of an inertial sensor) and a pedaling analysis apparatus 20B (an example of a pedaling measurement apparatus or an example of a display apparatus) which can perform communication with the sensor unit 40.

The sensor unit 40 is mounted on, for example, a pedal of a bicycle ergometer (hereinafter, simply referred to as a “bicycle 3”) provided indoors.

The sensor unit 40 has three detection axes (an x axis, a y axis, and a z axis) which are orthogonal to each other, and can measure accelerations (hereinafter, referred to as “two-axis accelerations” as appropriate) generated in at least two directions along the x axis and the y axis, and an angular velocity (hereinafter, referred to as a “one-axis angular velocity” or a “z-axis angular velocity” as appropriate) generated about at least the z axis. The x axis, the y axis and the z axis will be explained later.

The pedaling analysis apparatus 20B is mounted on a handle lever of the bicycle 3 in an attitude in which a display section (which will be described later) of the pedaling analysis apparatus 20B faces the body side of user 2. In this case, the user 2 can check a pedaling analysis result displayed on the display unit of the pedaling analysis apparatus 20B during driving (traveling) of the bicycle 3.

The pedaling analysis apparatus 20B may be constituted of a portable terminal such as a smart phone or a table terminal. The pedaling analysis apparatus 20B may be mounted on the body (for example, the wrist) of the user 2, and may be mounted on a location separated from the bicycle 3.

### 8-2. Mounting Example of Sensor Unit

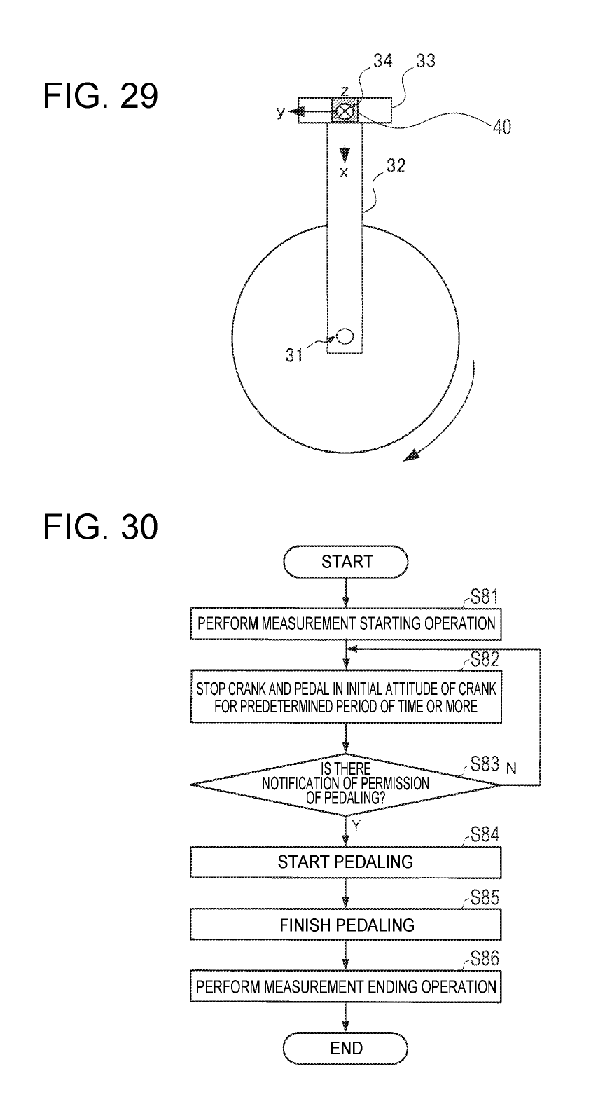

FIG. 29 is a diagram illustrating examples of a position at which and a direction in which the sensor unit 40 is mounted on a pedal 33.

Here, a case is assumed in which the sensor unit 40 is mounted on the pedal 33 on the right side of the bicycle 3 (the right side of the user 2). A rotation direction of the crank 32 about a rotation shaft (crank shaft 31) of the crank 32 is a clockwise direction when viewed from the right side of the bicycle 3, and the pedal 33 is provided at an end of the crank 32 separated from the crank shaft 31. The pedal 33 and the crank 32 are connected to each other via a rotation shaft 34 which is parallel to the crank shaft 31. The pedal 33 can be rotationally moved about the rotation shaft 34 with respect to the crank 32. Hereinafter, the rotation shaft 34 will be referred to as a “pedal shaft 34”.

First, a position where the sensor unit 40 is mounted on the pedal 33 is a position on the pedal shaft 34 or on an extension line of the pedal shaft 34.

An attitude of the sensor unit 40 being mounted on the pedal 33 is set to an attitude in which the z axis of the sensor unit 40 is disposed on the pedal shaft 34, and the x axis of the sensor unit 40 is directed in a longitudinal direction of the crank 32 (the y axis of the sensor unit 40 is horizontal) when the crank 32 and the pedal 33 are in initial attitudes as illustrated in FIG. 29.

In the present embodiment, as illustrated in FIG. 29, an attitude of the crank 32 when the pedal 33 is located uppermost is set as an initial attitude of the crank 32, and an attitude of the pedal 33 when a surface of the pedal 33 which is in contact with the sole of the user 2 becomes nearly horizontal is set as an initial attitude of the pedal 33.

Here, a positive direction of the z axis of the sensor unit 40 is assumed to be a direction from the right side of the bicycle 3 (the right side of the user 2) toward the left side of the bicycle 3, and a positive direction of the x axis of the sensor unit 40 is assumed to be a direction from the pedal 33 toward the crank shaft 31.

Here, z-axis angular velocity data (hereinafter, referred to as a “z-axis angular velocity ω” or a “one-axis angular velocity ω”) output from the sensor unit 40 indicates an angular velocity ωₚ of the pedal 33 about the z axis, and time integration of the z-axis angular velocity ω leads to an angle θₚ of the pedal 33 with the horizontal plane as a reference.

Acceleration data (hereinafter, referred to as “two-axis accelerations a” as appropriate) output from the sensor unit 40 reflects an acceleration applied to the pedal 33 therein. However, the two-axis accelerations a reflect not only an acceleration aₚ caused by motion of the pedal 33 but also the gravitational acceleration g therein. Time integration (secondary integration) of the acceleration aₚ caused by motion of the pedal 33 obtained by excluding the gravitational acceleration g from the two-axis accelerations a leads to a position xₚ of the pedal 33.

### 8-3. User's Actions

FIG. 30 is a diagram illustrating procedures of actions performed by the user 2. Hereinafter, respective steps in FIG. 30 will be described in order.

Step S81: The user 2 performs a measurement starting operation (an operation for causing the sensor unit 40 to start measurement) via the pedaling analysis apparatus 20B. Then, the pedaling analysis apparatus 20B transmits a measurement starting command to the sensor unit 40, and the sensor unit 40 receives the measurement starting command so as to start measurement of two-axis accelerations and a one-axis angular velocity. The sensor unit 40 measures the two-axis accelerations and the one-axis angular velocity in a predetermined cycle Δt (for example, Δt=1 ms), and sequentially transmits measured data to the pedaling analysis apparatus 20B. Communication between the sensor unit 40 and the pedaling analysis apparatus 20B is wireless communication or wired communication.

Step S82: The user 2 sets at least the crank 32 in an initial attitude (FIG. 29) and stops the crank 32 and the pedal 33 for a predetermined period of time (for example, one second) or more. In the present embodiment, in this step S82, the pedal 33 is not required to be set in an initial attitude.

Step S83: The user 2 determines whether or not a notification (for example, a notification using a sound) of permitting pedaling is received from the pedaling analysis apparatus 20B, proceeds to step S84 in a case where the notification is received (Y in step S83), and proceeds to step S82 in a case where the notification is not received (N in step S83).

Step S84: The user 2 starts pedaling. The pedaling analysis apparatus 20B analyzes the pedaling action performed by the user 2 on the basis of the measured data from the sensor unit 40, and displays a result of the analysis.

Step S85: Thereafter, the user 2 finishes of pedaling of the bicycle 3 at a desired timing.

Step S86: Next, the user 2 performs a measurement ending operation (an operation for causing the sensor unit 40 to finish measurement) via the pedaling analysis apparatus 20B. Then, the pedaling analysis apparatus 20B transmits a measurement ending command to the sensor unit 40, and the sensor unit 40 receives the measurement ending command so as to finish measurement of two-axis accelerations and a one-axis angular velocity.

### 8-4. Configuration of Pedaling Analysis System

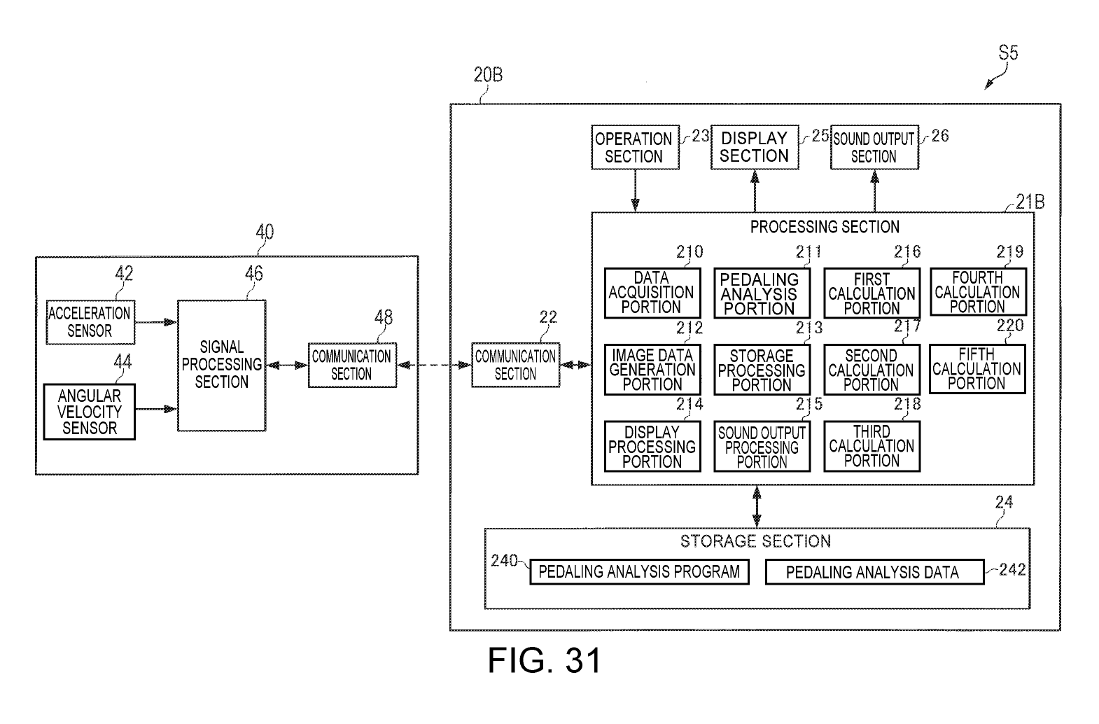

FIG. 31 is a diagram illustrating a configuration example of the pedaling analysis system S5 according to the fifth embodiment.

The pedaling analysis system S5 may include the sensor unit 40 and the pedaling analysis apparatus 20B as described above.

As illustrated in FIG. 31, the sensor unit 40 is configured to include an acceleration sensor 42, an angular velocity sensor 44, a signal processing section 46, a communication section 48, and the like. However, the sensor unit 40 may have a configuration in which some of the constituent elements are deleted or changed as appropriate, or may have a configuration in which other constituent elements are added thereto.

The acceleration sensor 42 measures accelerations generated in at least two-axis (the x axis and the y axis) directions which intersect (ideally, orthogonal to) each other, and outputs digital signals (acceleration data) corresponding to the magnitudes and directions of the measured two-axis accelerations.

The angular velocity sensor 44 measures an angular velocity generated about one axis (here, the z axis), and outputs a digital signal (angular velocity data) corresponding to the magnitude and direction of the measured angular velocity.

The signal processing section 46 receives the acceleration data and the angular velocity data from the acceleration sensor 42 and the angular velocity sensor 44, respectively, adds time information thereto, stores the data in a storage section (not illustrated), adds time information to the stored measured data (an example of attitude or position information) so as to generate packet data conforming to a communication format, and outputs the packet data to the communication section 48.

Ideally, the acceleration sensor 42 and the angular velocity sensor 44 are provided in the sensor unit 40 so that the three detection axes thereof match three axes (an x axis, a y axis, and a z axis) of an orthogonal coordinate system (sensor coordinate system) defined for the sensor unit 40, but, actually, errors occur in installation angles. Therefore, the signal processing section 46 performs a process of converting the acceleration data and the angular velocity data into data in the xyz coordinate system by using a correction parameter which is calculated in advance according to the installation angle errors.

The signal processing section 46 may perform a process of correcting the temperatures of the acceleration sensor 42 and the angular velocity sensor 44. The acceleration sensor 42 and the angular velocity sensor 44 may have a temperature correction function.

The acceleration sensor 42 and the angular velocity sensor 44 may output analog signals, and, in this case, the signal processing section 46 may A/D convert an output signal from the acceleration sensor 42 and an output signal from the angular velocity sensor 44 so as to generate measured data (acceleration data and angular velocity data), and may generate communication packet data by using the data.

The communication section 48 performs a process of transmitting packet data received from the signal processing section 46 to the pedaling analysis apparatus 20B, or a process of receiving various control commands such as a measurement starting command from the pedaling analysis apparatus 20B and sending the control commands to the signal processing section 46. The signal processing section 46 performs various processes corresponding to the control commands.

As illustrated in FIG. 31, the pedaling analysis apparatus 20B is configured to include a processing section 21B (an example of a computer), a communication section 22, an operation section 23, a storage section 24, a display section 25 (an example of a presentation portion or an example of a display portion), and a sound output section 26. However, the pedaling analysis apparatus 20B may have a configuration in which some of the constituent elements are deleted or changed as appropriate, or may have a configuration in which other constituent elements are added thereto.

The communication section 22 performs a process receiving packet data transmitted from the sensor unit 40 and sending the packet data to the processing section 21B, or a process of transmitting control commands (including a measurement staring command and a measurement stopping command) from the processing section 21B to the sensor unit 40.

The operation section 23 performs a process of acquiring data corresponding to an operation performed by the user 2 and sending the data to the processing section 21B. The operation section 23 may be, for example, a touch panel type display, a button, a key, or a microphone.

The storage section 24 is constituted of, for example, various IC memories such as a read only memory (ROM), a flash ROM, and a random access memory (RAM), or a recording medium such as a hard disk or a memory card. The storage section 24 stores a program for the processing section 21B performing various computation processes or a control process, or various programs or data for realizing application functions.

In the present embodiment, the storage section 24 stores a pedaling analysis program 240 (an example of a pedaling measurement program or an example of a display program) which is read by the processing section 21B in order to execute a pedaling analysis process (an example of a pedaling measurement method or an example of a display method). The pedaling analysis program 240 may be stored in a nonvolatile recording medium (computer readable recording medium) in advance, or the pedaling analysis program 240 may be received from a server (not illustrated) by the processing section 21B via a network, and may be stored in the storage section 24.

The storage section 24 stores pedaling analysis data 242. The pedaling analysis data 242 is a storage region in which analysis results (indexes such as an angle θ_{c} of the crank 32, an angular velocity ω_{c} of the crank 32, and the angle θₚ of the pedal 33) of a pedaling action from the processing section 21B are stored along with the date and time (time point t) at which pedaling is performed, and identification information of the user 2.

The storage section 24 is used as a work area of the processing section 21B, and temporarily stores data which is input from the operation section 23, results of calculation executed by the processing section 21B according to various programs, and the like. The storage section 24 may store data which is required to be preserved for a long period of time among data items generated through processing of the processing section 21B.

The display section 25 displays a processing result in the processing section 21B as text, a graph, a table, animation, and other images. The display section 25 may be, for example, a CRT, an LCD, a touch panel type display, and a head mounted display (HMD). A single touch panel type display may realize functions of the operation section 23 and the display section 25.

The sound output section 26 displays a processing result in the processing section 21B as a sound such as a voice or a buzzer sound. The sound output section 26 may be, for example, a speaker or a buzzer.

The processing section 21B performs a process of transmitting a control command to the sensor unit 40 via the communication section 22, or various computation processes on data which is received from the sensor unit 40 via the communication section 22, according to various programs. The processing section 21B performs other various control processes.

Particularly, in the present embodiment, by executing the pedaling analysis program 240, the processing section 21B functions as a data acquisition portion 210 (an example of an acquisition portion), a pedaling analysis portion 211, an image data generation portion 212, a storage processing portion 213, a display processing portion 214, a sound output processing portion 215, a first calculation portion 216, a second calculation portion 217, a third calculation portion 218, a fourth calculation portion 219, and a fifth calculation portion 220, and performs a process (pedaling analysis process) of analyzing a pedaling action of the user 2.

The data acquisition portion 210 performs a process of receiving packet data which is received from the sensor unit 40 by the communication section 22, acquiring time information and measured data from the received packet data, and sending the time information and the measured data to the storage processing portion 213.

The pedaling analysis portion 211 performs a process of analyzing a pedaling action of the user 2 by using the measured data (the measured data stored in the storage section 24) output from the sensor unit 40, the data from the operation section 23, or the like, so as to generate the pedaling analysis data 242 including a time point (date and time) at which the pedaling was performed, identification information of the user 2, and information regarding a pedaling action analysis result.

The image data generation portion 212 performs a process of generating image data corresponding to an image displayed on the display section 25. For example, the image data generation portion 212 generates image data on the basis of the pedaling analysis data.

The display processing portion 214 performs a process of displaying various images (including text, symbols, and the like in addition to an image corresponding to the image data generated by the image data generation portion 212) on the display section 25. For example, the display processing portion 214 displays various screens on the display section 25 on the basis of the image data generated by the image data generation portion 212. For example, the image data generation portion 212 may display an image, text, or the like for notifying the user 2 on the display section 25. For example, the display processing portion 214 may display text information such as text or symbols indicating the pedaling analysis data on the display section 25 in order during a pedaling action of the user 2, or automatically or in response to an input operation performed by the user 2 after the pedaling action is completed. Alternatively, a display section may be provided in the sensor unit 40, and the display processing portion 214 may transmit image data to the sensor unit 40 via the communication section 22, and various images, text, or the like may be displayed on the display section of the sensor unit 40.

The storage processing portion 213 performs read/write processes of various programs or various data for the storage section 24. The storage processing portion 213 performs not only the process of storing the time information and the measured data received from the data acquisition portion 210 in the storage section 24 in correlation with each other, but also a process of storing various pieces of information calculated by the pedaling analysis portion 211, the pedaling analysis data 242, or the like in the storage section 24.

The sound output processing portion 215 performs a process of outputting various sounds (including voices, buzzer sounds, and the like) from the sound output section 26. For example, the sound output processing portion 215 may output a sound for notifying the user 2 from the sound output section 26. For example, the sound output processing portion 215 may output a sound or a voice indicating an analysis result in the pedaling analysis portion 211 from the sound output section 26 automatically or in response to performed by the user 2 after a pedaling action of the user 2 is completed. Alternatively, a sound output section may be provided in the sensor unit 40, and the sound output processing portion 215 may transmit various items of sound data or voice data to the sensor unit 40 via the communication section 22, and may output various sounds or voices from the sound output section of the sensor unit 40.

A vibration mechanism may be provided in the pedaling analysis apparatus 20B or the sensor unit 40, and various pieces of information may be converted into various pieces of information by the vibration mechanism so as to be presented to the user 2.

The first calculation portion 216 performs time integration on a z-axis angular velocity ω(t) (an example of angular velocity information) output from the sensor unit 40 over a period from an initial time point t=0 to a time point t, so as to calculate an angle θₚ(t) (an example of an attitude of the pedal) at the time point t formed between the pedal 33 and the horizontal plane (refer to FIG. 32). Here, an example is described in which the attitude (the angle θₚ of the pedal) is calculated by time-integrating the z-axis angular velocity ω(t) output from the one-axis angular velocity sensor 44, but the attitude (the angle θₚ of the pedal) may be calculated by integrating an attitude by using a matrix such as a direction cosine matrix or a quaternion on the basis of three-axis angular velocities output from a three-axis angular velocity sensor.

The second calculation portion 217 specifies a direction of the gravitational acceleration g(t) viewed from the sensor unit 40 at the time point t on the basis of the angle θₚ(t) of the pedal 33 at the time point t.

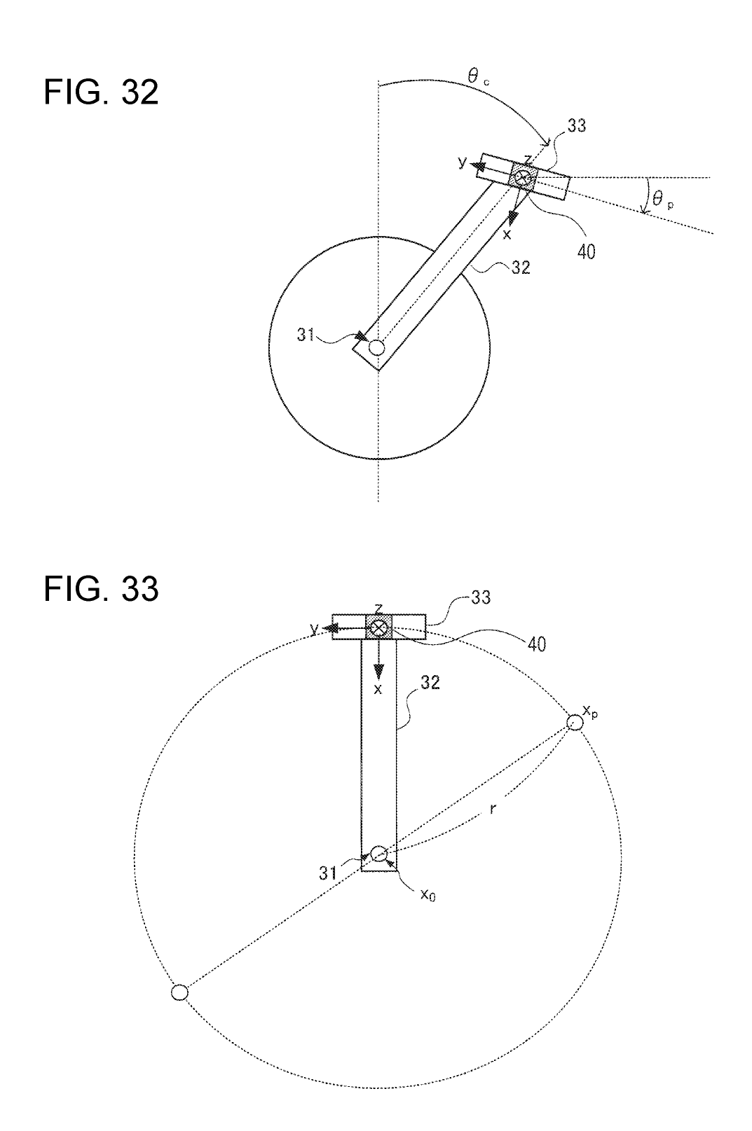

The second calculation portion 217 calculates an acceleration aₚ(t) caused by motion of the pedal 33 at the time point t by subtracting the gravitational acceleration g(t) at the time point t from two-axis accelerations a(t) (an example of acceleration information) output from the sensor unit 40 at the time point t, and performs time integration on the acceleration aₚ(t) over a period from the initial time point t=0 to the time point t so as to calculate a position xₚ(t) of the pedal 33 at the time point t (refer to FIG. 33).

The third calculation portion 218 calculates a rotation center position x₀ (an example of the rotation center) of the crank 32 on the basis of a plurality of positions xₚ(0), xₚ(Δt), xₚ(2Δt), . . . , and xₚ(t) (examples of positions of the pedal at a plurality of time points) of the pedal 33 calculated by the first calculation portion 216 (refer to FIG. 33). The rotation center position x₀ corresponds to a position where the crank shaft 31 is present. For example, the third calculation portion 218 may calculate a midpoint between two positions which are farthest from each other among the plurality of positions xₚ(0), xₚ(Δt), xₚ(2Δt), . . . , and xₚ(t), as the rotation center position x₀, and may calculate the center of a circle obtained through function fitting of the plurality of positions xₚ(0), xₚ(Δt), xₚ(2Δt), . . . , and xₚ(t), as the rotation center position x₀.

In a case where a distance (rotation radius) r from the crank shaft 31 to the sensor unit 40 is stored in the storage section 24 in advance, the third calculation portion 218 may use the value of the rotation radius r for calculation of the rotation center position x₀. The value of the rotation radius r stored in the storage section 24 in advance is, for example, a value which is measured by the user 2 in advance and is input to the pedaling analysis apparatus 20B via the operation section 23, and is stored in the storage section 24 by the processing section 21B.

The fourth calculation portion 219 calculates a rotation angle θ_{c}(t) (an example of an attitude of the crank) of the crank 32 at the time point t about the crank shaft 31 on the basis of the rotation center position x₀ of the crank 32 and the position xₚ(t) of the pedal 33 at the time point t (refer to FIG. 34). For example, the fourth calculation portion 219 calculates an angle formed between a first line segment connecting the rotation center position x₀ to the position xₚ(t) and a second line segment connecting the rotation center position x₀ to the position xₚ(0), as the angle θ_{c}(t).

The fifth calculation portion 220 calculates a rotation angular velocity ω_{c}(t) of the crank 32 at the time point t about the crank shaft 31 by performing time differentiation on the rotation angle θ_{c}(t) of the crank 32 at the time point t. For example, the fifth calculation portion 220 applies the rotation angle θ_{c}(t) at the time point t and a rotation angle θ_{c}(t−Δt) at a time point (t−Δt) to an equation of ωc(t)=(θ_{c}(t)−θ_{c}(t−Δt)/t, so as to calculate the rotation angular velocity ω_{c}(t).

### 8-5. Display Screen of Pedaling Analysis Data

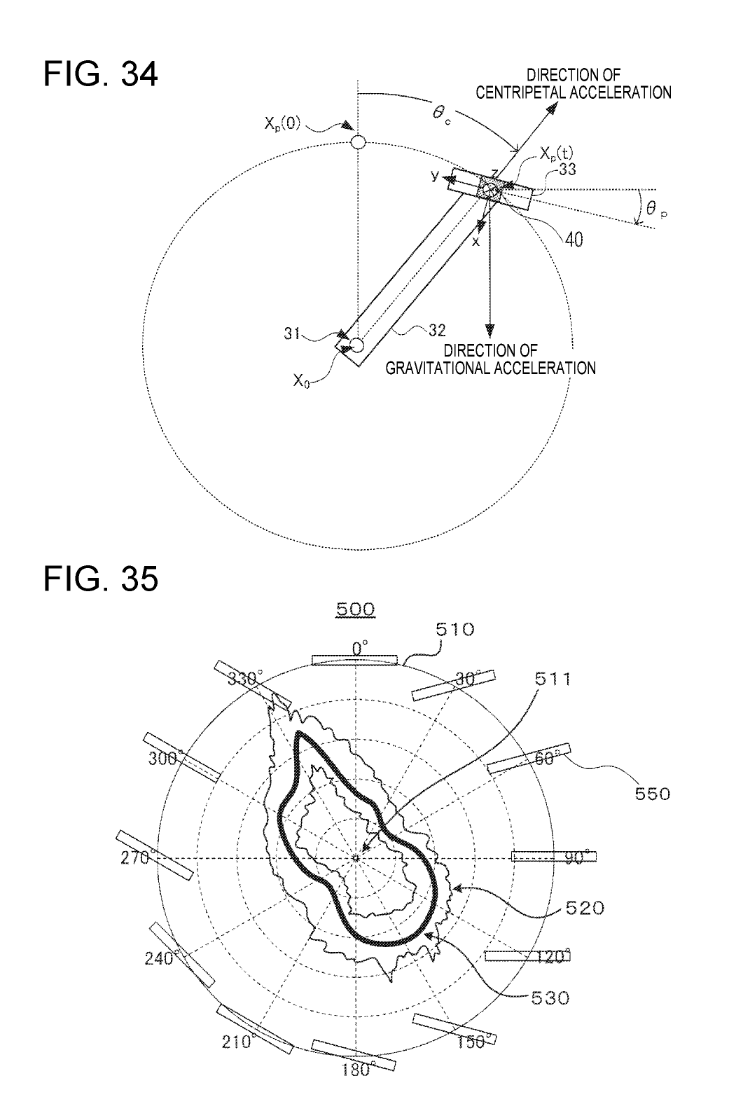

FIG. 35 is a diagram illustrating an example of a screen displayed on the display section 25.

A screen 500 includes an image 510, an image 520, an image 530, and an image 550. The image 510 indicates a coordinate system. The image 510 is a circular region centering on the origin 511. The image 510 indicates a rotation angle with a position in a circumferential direction, and indicates the magnitude of a value with a distance from the origin 511. This coordinate system may also be referred to as a polar coordinate system. An upper end and a lower end of an axis in a vertical direction respectively correspond to 0 degrees and 180 degrees of the angle θ_{c} of the crank 32, and a right end and a left end of an axis in a horizontal direction respectively correspond to 90 degrees and 270 degrees of the angle θ_{c} of the crank 32. The image 520 indicating angular velocity ω_{c}(θ_{c}) at the angle θ_{c} and the image 530 indicating an average of angular velocities ω_{c}(θ_{c}) at the angle θ_{c} are plotted on a coordinate plane indicated by the image 510. In FIG. 35, scales of the angle θ_{c} are added at intervals of 30 degrees in the image 510. In FIG. 35, two images 520 corresponding to two rotations of the crank 32 are displayed, but an image 520 corresponding to one rotation or images 520 corresponding to three or more rotations may be displayed.

In other words, the circumferential distribution of the image 520 visually indicates angular velocity unevenness (an example of rotation unevenness of the crank 32) caused by an angle of the crank 32. The diametral distribution of the image 520 visually indicates angular velocity unevenness (an example of rotation unevenness of the crank 32) for each angle of the crank 32 when the crank 32 is rotated multiple times. The image 530 visually indicates the center of angular velocity unevenness (an example of rotation unevenness of the crank 32) for each angle of the crank 32 when the crank 32 is rotated multiple times.

FIG. 35 illustrates an example of displaying the pedaling analysis data mainly including the angle θ_{c} as an index, but pedaling analysis data including the angular velocity ω_{c}(θ_{c}), angular acceleration ω′_{c}(θ_{c}), and the like may also be displayed. Angular acceleration unevenness caused by an angle of the crank 32 is also one of the indexes indicating the rotation unevenness of the crank 32.

The image 550 indicates the angle θₚ of the pedal 33 at the angle θ_{c} of the crank 32 with a strip-shaped mark. Hereinafter, the image 550 will be referred to as a “strip-shaped mark 550”.

An arrangement angle in a longitudinal direction of the strip-shaped mark 550 with respect to a lower edge (an edge which is parallel to the 90-degree line and the 270-degree line of the polar coordinate system) of the display screen indicates the angle θₚ of the pedal 33 with respect to the horizontal plane, and an arrangement position of the strip-shaped mark 550 in the circumferential direction of the polar coordinate system indicates the angle θ_{c} of the crank 32. In other words, the strip-shaped mark 550 visually indicates an attitude of the pedal 33 at each angle of the crank 32.

The angle θₚ of the pedal 33 displayed by the strip-shaped mark 550 may be an angle θₚ corresponding to one rotation of the crank 32, and may be an angle θₚ corresponding to two or more rotations of the crank 32.

In FIG. 35, the strip-shaped mark 550 is a transmissive mark, and thus the scales can be viewed even if the strip-shaped marks 550 overlap numerical value images (“0°”, “30°”, “60°”, . . . ) indicating the scales of the angle θ_{c}. Therefore, in a case where the numerical value images and the strip-shaped marks 550 are spatially separated from each other, the strip-shaped mark 550 may be a non-transmissive mark.

In FIG. 35, the strip-shaped mark 550 is used to indicate the angle θₚ of the pedal 33, but other images may be used instead of the strip-shaped mark 550. For example, a sectional image of the pedal 33 may be used, a linear mark indicating a surface of the pedal 33 may be used, an image of the foot (for example, an image of a part from the ankle to the toe) may be used, and an image of a shoe may be used.

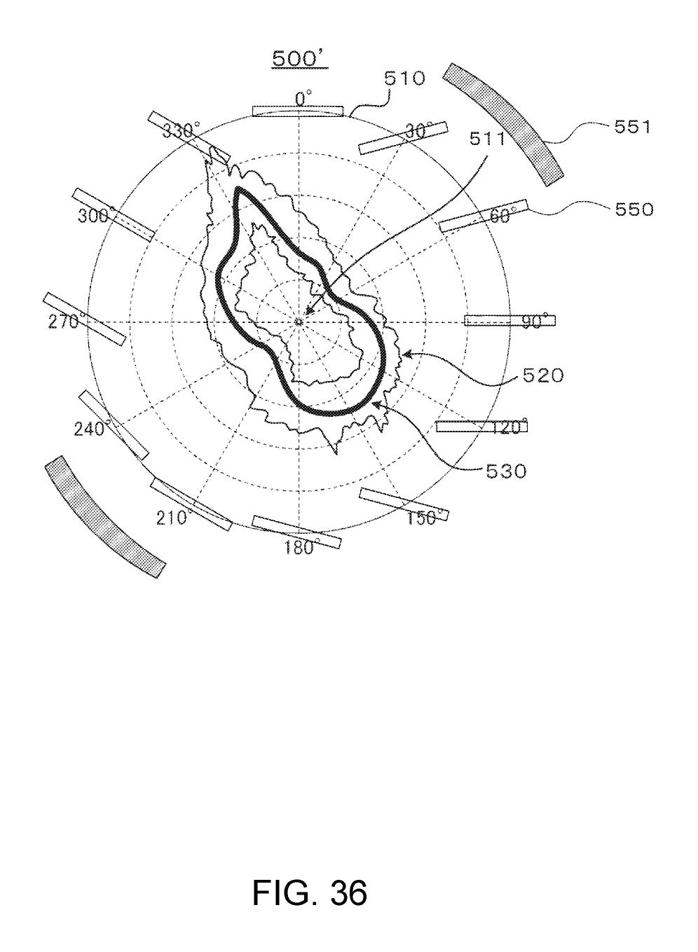

FIG. 36 is a diagram illustrating another example of a screen displayed on the display section 25. In the example illustrated in FIG. 36, a partial arc-shaped mark 551 is further displayed in a range of the angle θ_{c} at which fluctuation of an angle θₚ)(θ_{c}) of the pedal 33 is considerably large, and thus emphasizes the range, in the example illustrated in FIG. 35.

Here, the range of the angle θ_{c} at which fluctuation of an angle θₚ(θ_{c}) is considerably large is, for example, a range in which a change ratio of the angle θₚ to the angle θ_{c} is more than a threshold value.

FIGS. 35 and 36 illustrate an example in which the angle θₚ)(θ_{c}) of the pedal 33 is displayed on the same display screen as other indexes, but the angle θₚ)(θ_{c}) of the pedal 33 may be displayed on a display screen which is different from other indexes, and the user 2 may designate in advance an index to be displayed on the same display screen as the angle θₚ)(θ_{c}) of the pedal 33. The content designated by the user 2 is input to the pedaling analysis apparatus 20B via the operation section 23, for example.

### 8-6. Generation Process of Pedaling Analysis Data

The pedaling analysis portion 211 generates pedaling analysis data including the angle θ_{c} of the crank 32, the angle θₚ of the pedal 33, the angular velocity ω_{c} of the crank 32, and the angular acceleration ω_{c}′ of the crank 32 as follows, and reflects the pedaling analysis data in the above-described screen 500 in order via the image data generation portion 212 and the display processing portion 214.

The pedaling analysis portion 211 calculates an angular velocity ω_{c}(θ_{c}) of the crank 32 at each angle θ_{c} of the crank 32 on the basis of the angular velocity ω_{c}(t) of the crank 32 at each time point t and the angle θ_{c}(t) of the crank 32 at each time point t. The pedaling analysis portion 211 differentiates the angular velocity ω_{c}(θ_{c}) at each angle θ_{c} with respect to angles so as to calculate an angular acceleration ω_{c}′(θ_{c}).

The pedaling analysis portion 211 calculates an angle θₚ(θ_{c}) of the pedal 33 at the angle θ_{c} of the crank 32 on the basis of the angle θₚ(t) of the pedal 33 at each time point t and the angle θ_{c}(t) of the crank 32 at each time point t.

The pedaling analysis portion 211 calculates offset target values of the angular velocity ω_{c}(θ_{c}) for each angle θ_{c} and the angular acceleration ω_{c}′(θ_{c}) at each angle θ_{c}.

The pedaling analysis portion 211 selects the lowest value from among the angular velocities ω_{c}(θ_{c}) at the respective angles θ_{c} within a predetermined period of time such as the latest one minute, and sets the lowest value as the offset target value of the angular velocity ω_{c}(θ_{c}).

The pedaling analysis portion 211 selects the lowest value from among the angular accelerations ω_{c}′(θ_{c}) at the respective angles θ_{c} within a predetermined period of time such as the latest one minute, and sets the lowest value as the offset target value of the angular acceleration ω_{c}′(θ_{c}).

The offset target value is not limited to the lowest value, and may be, for example, a value such as an average value within a period of time, a set threshold value. The threshold value may be designated by the user 2 via, for example, the operation section 23.

The pedaling analysis portion 211 acquires the angular velocity ω_{c}(θ_{c}) for each rotation, and subtracts the offset target value therefrom. The pedaling analysis portion 211 plots an angular velocity ω_{c}(θ_{c}) obtained by subtracting the offset target value at a corresponding position on the coordinate plane, so as to generate the image 520 for each rotation.

The pedaling analysis portion 211 acquires an average angular velocity ω_{AVE}(θ_{c}) at each angle θ_{c}, and subtracts the offset target value therefrom. The pedaling analysis portion 211 plots an average angular velocity ω_{AVE}(θ_{c}) obtained by subtracting the offset target value at a corresponding position on the coordinate plane, so as to generate the image 530. A value of the origin 511 corresponds to the offset target value of the angular velocity.

### 8-7. Pedaling Analysis Process

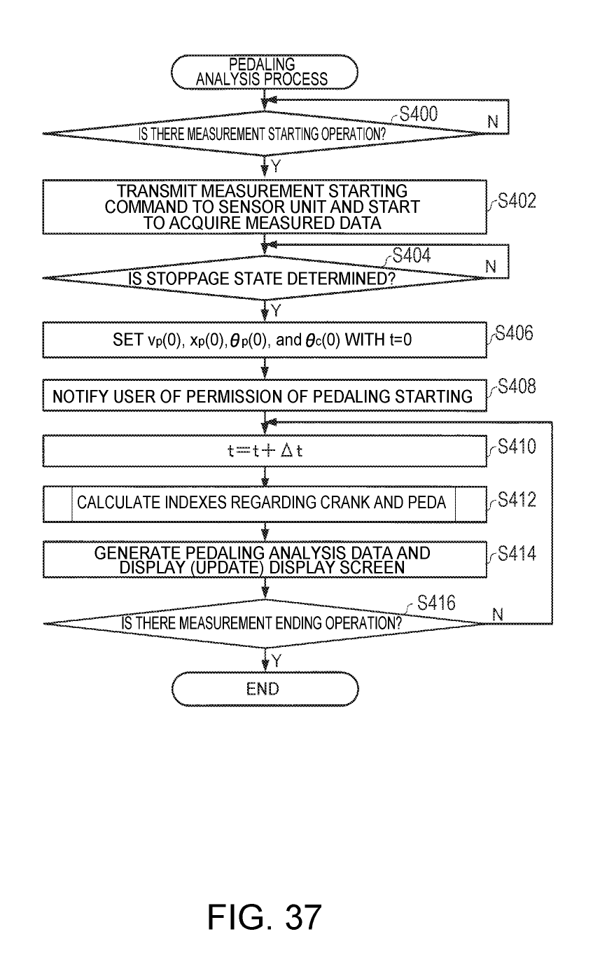

FIG. 37 is a flowchart illustrating examples of procedures of a pedaling analysis process (an example of a pedaling measurement method). The processing section 21B performs the pedaling analysis process, for example, according to the procedures shown in the flowchart of FIG. 37 by executing the pedaling analysis program 240 stored in the storage section 24. Hereinafter, the flowchart of FIG. 37 will be described.

Step S400: The processing section 21B waits for the user 2 to perform a measurement starting operation (N in step S400), and proceeds to step S402 if the measurement starting operation is performed (Y in step S400).

Step S402: The processing section 21B transmits a measurement starting command to the sensor unit 40, and starts to acquire measured data from the sensor unit 40.

Step S404: The processing section 21B determines whether or not the pedal 33 and the crank 32 are in a stoppage state by using two-axis accelerations included in the measured data acquired from the sensor unit 40, proceeds to step S406 if it is detected that the pedal 33 and the crank 32 are in a stoppage state (Y in step S404), and waits if otherwise (N in step S404).

The determination in step S404 is performed as follows. In other words, the processing section 21B calculates the magnitude of a difference between a combined value n₀(t) of the two-axis accelerations output from the acceleration sensor 42 and the gravitational acceleration G The processing section 21B determines whether or not the magnitude of the difference is equal to or less than a predetermined threshold value, determines that the pedal 33 and the crank 32 are in a stoppage state if the magnitude is equal to or less than the threshold value, and determines that the pedal 33 and the crank 32 are not in a stoppage state if otherwise.

Step S406: The processing section 21B initializes values of a velocity vₚ(0) of the pedal 33, a position xₚ(0) of the pedal 33, an angle θₚ(0) of the pedal 33, and an angle θ_{c}(0) of the crank 32 with the time point t=0. Here, it is assumed that the velocity vₚ(0) of the pedal 33, a position xₚ(0) of the pedal 33, and the angle θ_{c}(0) of the crank 32 are respective set to zeros. In this step S406, for example, the processing section 21B specifies a direction of the gravitational acceleration g(0) viewed from the sensor unit 40 on the basis of two-axis accelerations a(0) output from the sensor unit 40 when the crank 32 and the pedal 33 are in a stoppage state, calculates a value of the angle θₚ of the pedal 33 relative to the horizontal plane on the basis of the direction, and sets the value to a value of the initial angle θₚ(0) of the pedal 33.

Step S408: The processing section 21B notifies the user 2 of permission of pedaling starting. The processing section 21 outputs, for example, a predetermined sound, or an LED is provided in the sensor unit 40, and the LED is lighted, so that the user 2 is notified of permission of pedaling starting. The user 2 confirms the notification and then starts a pedaling action.

Step S410: The processing section 21B waits for the sampling cycle Δt of the measured data from the execution timing of step S406, then increments the time point t by Δt, and proceeds to the next step S412. A time interval until this step S410 is executed next is set to be the same as the sampling cycle Δt. Therefore, a series of processes from this step S410 to step S416 which will be described later is repeatedly performed in the cycle Δt.

Step S412: The processing section 21B performs a process of calculating indexes regarding the crank and the pedal. A flow of the process of calculating indexes regarding the crank and the pedal will be described later.

Step S414: The processing section 21B generates pedaling analysis data on the basis of the angle θ_{c} of the crank 32, the angle θₚ of the pedal 33, and the angular velocity ω_{c} of the crank 32 calculated in step S412, and reflects the pedaling analysis data in a display screen of the display section 25.

Step S416: The processing section 21B determines whether or not the user 2 performs a measurement ending operation, finishes the flow if the measurement ending operation is performed (Yin step S416), and proceeds to step S410 if the measurement ending operation is not performed (N in step S416).

In the flowchart of FIG. 37, order of the respective steps may be changed as appropriate within an allowable range, some of the steps may be omitted or changed, and other steps may be added thereto.

### 8-8. Flow of Process of Calculating Indexes Regarding Crank and Pedal

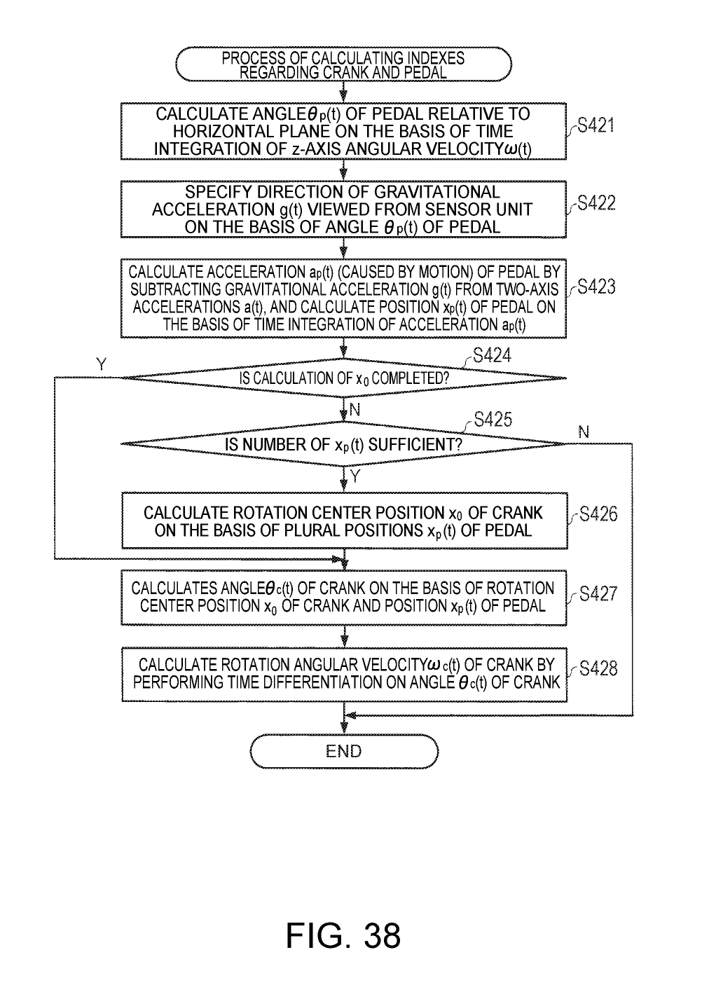

FIG. 38 is a flowchart illustrating examples of procedures of the process of calculating indexes regarding the crank and the pedal. The processing section 21B performs the process of calculating indexes regarding the crank and the pedal, for example, according to the procedures shown in the flowchart of FIG. 38 by executing the pedaling analysis program 240 stored in the storage section 24. Hereinafter, the flowchart of FIG. 38 will be described.

Step S421 (an example of a first calculation procedure): The processing section 21B calculates the angle θₚ(t) of the pedal 33 relative to the horizontal plane on the basis of time integration of the z-axis angular velocity ω(t).

Step S422: The processing section 21B specifies a direction of the gravitational acceleration g(t) viewed from the sensor unit 40 on the basis of the angle θₚ(t) of the pedal.

Step S423: The processing section 21B calculates an acceleration aₚ(t) caused by motion of the pedal 33 by subtracting the gravitational acceleration g(t) from the two-axis accelerations a(t), and calculates a position xₚ(t) of the pedal 33 on the basis of time integration of the acceleration aₚ(t).

Step S424: The processing section 21B determines whether or not calculation of the rotation center position x₀ of the crank 32 is completed, proceeds to step S427 if the calculation is completed (Y in step S424), and proceeds to step S425 if the calculation is not completed (N in step S424).

Step S425: The processing section 21B determines whether or not the number of calculated positions xₚ(t) of the pedal 33 reaches a sufficient number (predetermined threshold value), proceeds to step S426 if the number reaches the sufficient number (Y in step S425), and finishes the flow if the number does not reaches the sufficient number (N in step S425).

Step S426: The processing section 21B calculates the rotation center position x₀ of the crank 32 on the basis of the plurality of positions xₚ(t) of the pedal 33.

Step S427: The processing section 21B calculates the angle θ_{c}(t) of the crank 32 on the basis of the rotation center position x₀ of the crank 32 and the position xₚ(t) of the pedal 33.

Step S428: The processing section 21B calculates the rotation angular velocity ω_{c}(t) of the crank 32 by performing time differentiation on the angle θ_{c}(t) of the crank 32.

### 9. Sixth Embodiment

Hereinafter a sixth embodiment will be described. Here, a description will be made focusing on differences from the fifth embodiment, and the same constituent elements as in the fifth embodiment are given the same reference numerals.

### 9-1. Configuration Example of Pedaling Analysis System

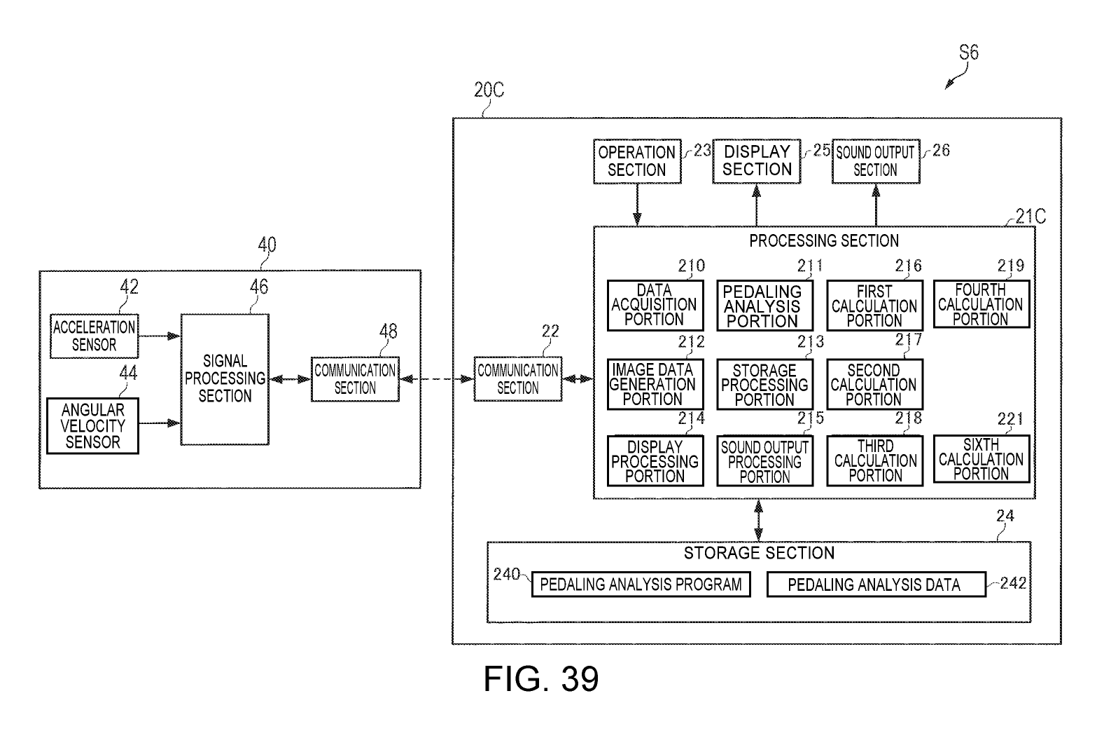

FIG. 39 is a diagram illustrating a configuration example of a pedaling analysis system S6 (an example of a pedaling measurement system) according to the sixth embodiment. As illustrated in FIG. 39, the pedaling analysis system S6 of the present embodiment corresponds to including a pedaling analysis apparatus 20C (an example of a pedaling measurement apparatus or an example of a display apparatus) instead of the pedaling analysis apparatus 20B in the pedaling analysis system S5 of the fifth embodiment. The pedaling analysis apparatus 20C of the present embodiment corresponds to further including a sixth calculation portion 221 instead of the fifth calculation portion 220 in the pedaling analysis apparatus 20B of the fifth embodiment.

The pedaling analysis apparatus 20C of the present embodiment includes a processing section 21C, and the processing section 21C includes the sixth calculation portion 221 instead of the fifth calculation portion 220 in the processing section 21B of the fifth embodiment.

The sixth calculation portion 221 calculates the angular velocity ω_{c}(t) of the crank 32 in the same manner as the fifth calculation portion 220. However, procedures of calculating angular velocity ω_{c}(t) in the sixth calculation portion 221 are different from the procedures of calculating angular velocity ω_{c}(t) in the fifth calculation portion 220. An operation of the sixth calculation portion 221 is as follows.

The sixth calculation portion 221 specifies a direction of a centripetal acceleration a₀(t) applied to the pedal 33 at the time point t on the basis of the angle θ_{c}(t) of the crank 32 and the angle θₚ(t) of the pedal 33 at the time point t (refer to FIG. 34), and calculates the magnitude |a₀(t)| of the centripetal acceleration a₀(t) at the time point t on the basis of the acceleration aₚ(t) of the pedal 33 at the time point t and the direction.

The sixth calculation portion 221 applies the magnitude |a₀(t)| of the centripetal acceleration a₀(t) and the rotation radius r to an equation of ω_{c}(t)=√(|a₀(t)|/r), so as to calculate the rotation angular velocity ω_{c}(t) of the crank 32 at the time point t.

The sixth calculation portion 221 may use a half of a distance between two positions which are farthest from each other among the plurality of positions xₚ(0), xₚ(Δt), xₚ(2Δt), . . . , and xₚ(t) calculated by the first calculation portion 216 (described in the fifth embodiment), as a value of the rotation radius r. Alternatively, the sixth calculation portion 221 may use a radius of a circle obtained through function fitting of the plurality of positions xₚ(0), xₚ(Δt), xₚ(2Δt), . . . , and xₚ(t), as a value of the rotation radius r. Alternatively, the sixth calculation portion 221 may use a value of the rotation radius r stored in the storage section 24 in advance. The value of the rotation radius r stored in the storage section 24 in advance is, for example, a value which is measured by the user 2 in advance and is stored in the storage section 24.

### 9-2. Flow of Process of Calculating Indexes Regarding Crank and Pedal

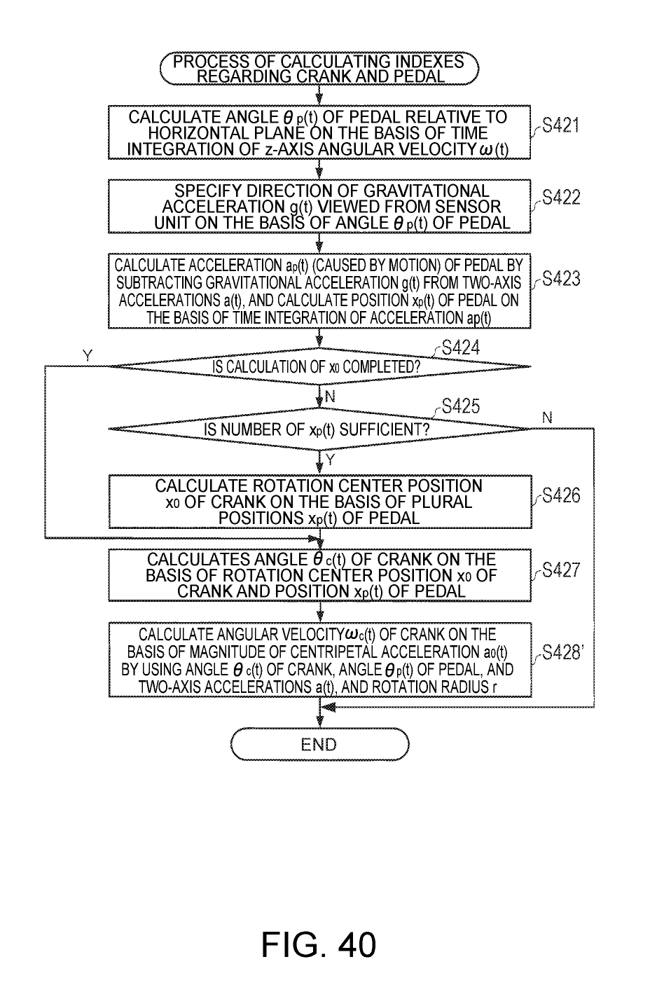

FIG. 40 is a flowchart illustrating examples of procedures of the process of calculating indexes regarding the crank and the pedal. The processing section 21C performs the process of calculating indexes regarding the crank and the pedal, for example, according to the procedures shown in the flowchart of FIG. 40 by executing the pedaling analysis program 240 stored in the storage section 24.

As illustrated in FIG. 40, in the process of calculating indexes regarding the crank and the pedal, step S428′ is executed instead of step S428 in process of calculating indexes regarding the crank and the pedal (FIG. 38) of the fifth embodiment.

Step S428′: The processing section 21C calculates the angular velocity ω_{c}(t) of the crank 32 on the basis of the magnitude |a₀(t)| of the centripetal acceleration a₀(t) by using the angle θ_{c}(t) of the crank 32, the angle θₚ(t) of the pedal 33, and the two-axis accelerations a(t), and the rotation radius r, and finishes the flow. An operation of the processing section 21C in step S428′ is the same as the operation of the processing section 21C as the sixth calculation portion 221.

### 10. Seventh Embodiment

Hereinafter, a seventh embodiment will be described. The seventh embodiment is a modification example of the fifth embodiment or the sixth embodiment. A modification example of the fifth embodiment is the same as a modification example of the sixth embodiment, and thus the seventh embodiment will be described here as the modification example of the fifth embodiment. Description of the seventh embodiment as the modification example of the sixth embodiment will be omitted. Here, the same constituent elements as the constituent elements in the fifth embodiment are given the same reference numerals.

### 10-1. Mounting Examples of Sensor Unit 40

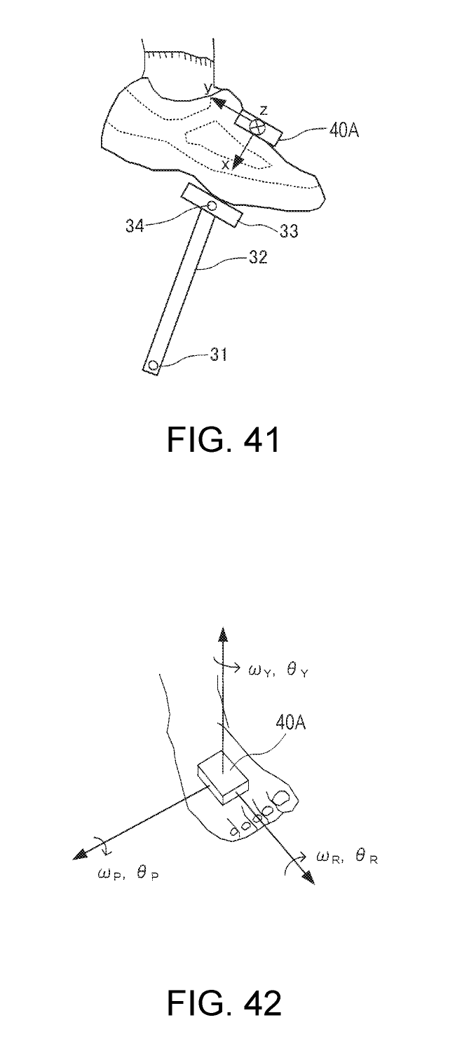

FIG. 41 is a diagram illustrating a mounting example of a sensor unit 40A (an example of an inertial sensor) in the seventh embodiment.

As illustrated in FIG. 41, in the present embodiment, the sensor unit 40A is mounted not on the pedal 33 of the bicycle 3 but on the instep (an upper of a shoe) of the user 2.

First, a position where the sensor unit 40A is mounted on the foot of the user 2 is, for example, the vicinity of a position where the crank 32 is extended in the longitudinal direction thereof.

An attitude in which the sensor unit 40A is mounted on the foot of the user 2 is, for example, an attitude in which the z axis of the sensor unit 40A is parallel to the pedal shaft 34, and the x axis of the sensor unit 40A is directed in the longitudinal direction of the crank 32 (the y axis of the sensor unit 40A is horizontal) when the crank 32 and the pedal 33 are in initial attitudes as illustrated in FIG. 29.

In the present embodiment, in order to measure an angle θ_{R} of the ankle of the user 2 in a roll direction, an angle θ_{Y} of the ankle of the user 2 in a yaw direction, and an angle θ_{P} of the ankle of the user 2 in a pitch direction, angular velocity detection axes of the sensor unit 40A (that is, detection axes of the angular velocity sensor 44) are provided not only in the z direction but also in the y direction and the x direction. In other words, the sensor unit 40A of the present embodiment includes a three-axis angular velocity sensor (not illustrated) instead of the one-axis angular velocity sensor 44 in the sensor unit 40 of the fifth embodiment. Here, the three detection axes of the angular velocity sensor 44 are set to three axes such as the x axis, the y axis, and the z axis described in the fifth embodiment.

Therefore, an x-axis angular velocity output from the sensor unit 40A indicates an angular velocity ω_{Y} of the ankle of the user 2 in the yaw direction, a y-axis angular velocity output from the sensor unit 40A indicates an angular velocity ω_{R} of the ankle of the user 2 in the roll direction, and a z-axis angular velocity output from the sensor unit 40A indicates an angular velocity ω_{P} of the ankle of the user 2 in the pitch direction (refer to FIG. 42).

Time integration of the x-axis angular velocity leads to an angle θ_{Y} of the ankle of the user 2 in the yaw direction with the horizontal plane as a reference, time integration of the y-axis angular velocity leads to an angle θ_{R} of the ankle of the user 2 in the roll direction with the horizontal plane as a reference, and time integration of the z-axis angular velocity leads to an angle θ_{P} of the ankle of the user 2 in the pitch direction with the horizontal plane as a reference (the angle θ_{P} of the ankle in the present embodiment corresponds to the angle θₚ of the pedal 33 in the fifth embodiment).

The two-axis accelerations output from the sensor unit 40 reflect an acceleration applied to the pedal 33 therein in the same manner as in the fifth embodiment. The two-axis accelerations reflect not only an acceleration aₚ caused by motion of the pedal 33 but also the gravitational acceleration g therein. Time integration of the remaining acceleration aₚ obtained by excluding the gravitational acceleration g from the two-axis accelerations leads to a position of the sensor unit 40A. The position of the sensor unit 40A indirectly indicates a position xₚ of the pedal 33.

In the pedaling analysis apparatus of the present embodiment, it is assumed that a distance r′ from the pedal 33 to the sensor unit 40A is measured by the user 2 in advance, and is input to the pedaling analysis apparatus 20B via the operation section 23. It is assumed that the processing section 21B of the pedaling analysis apparatus 20B stores the input distance r′ in the storage section 24. In this case, the processing section 21B of the present embodiment can appropriately compensate for (correct) deviation between the position of the sensor unit 40A and the position xₚ of the pedal 33 or can convert the position of the sensor unit 40A into the position xₚ of the pedal 33 by using the distance r′ stored in the storage section 24.

### 10-2. Configuration and Operation of System

A configuration and an operation of the pedaling analysis system of the present embodiment are fundamentally the same as the configuration and the operation of the system S5 of the fifth embodiment. In other words, the pedaling analysis apparatus 20B of the present embodiment calculates and displays indexes such as the angle θ_{c} of the crank 32, the angular velocity ω_{c} of the 32, and the angle θₚ of the pedal 33 with the horizontal plane as a reference according to the same procedures as those in the pedaling analysis apparatus 20B of the fifth embodiment.

However, in the pedaling analysis system of the present embodiment, since a mounting location of the sensor unit 40A is the instep of the user 2, and the number of detection axes of the angular velocity sensor 44 is increased, the processing section 21B of the pedaling analysis apparatus 20B of the present embodiment calculates an angle θ_{R}(t) of the ankle of the user 2 in the roll direction, an angle θ_{Y}(t) of the ankle of the user 2 in the yaw direction, and an angle θ_{P}(t) of the ankle of the user 2 in the pitch direction in step S421 (refer to FIG. 38).

Above all, the angle θ_{P}(t) in the pitch direction at the time point t may be calculated on the basis of the z-axis angular velocity ω(t) output from the sensor unit 40A in the same manner as in a case of calculating the angle θₚ(t) of the pedal 33 by using the z-axis angular velocity ω(t) output from the sensor unit 40 in the fifth embodiment.

On the other hand, the angle θ_{R}(t) in the roll direction at the time point t may be calculated by performing time integration on a y-axis angular velocity output from the sensor unit 40A over a period from the initial time point t=0 to the time point t (an angle θ_{R}(0) in the roll direction at the initial time point t=0 is set to, for example, zero).

The angle θ_{Y}(t) in the yaw direction at the time point t may be calculated by performing time integration on an x-axis angular velocity output from the sensor unit 40A over a period from the initial time point t=0 to the time point t (an angle θ_{Y}(0) in the yaw direction at the initial time point t=0 is set to, for example, zero).

The processing section 21B of the pedaling analysis apparatus 20B of the present embodiment displays the angle θ_{R} in the roll direction, the angle θ_{Y} in the yaw direction, and the angle θ_{P} in the pitch direction on the display section 25 by using, for example, the strip-shaped mark 550 in the same manner as in a case where the processing section 21B of the pedaling analysis apparatus 20B of the fifth embodiment displays the angle θ_{P} of the pedal 33 (refer to FIGS. 35 and 36).

However, since the angle θ_{R} in the roll direction, the angle θ_{Y} in the yaw direction, and the angle θ_{P} in the pitch direction are respectively angles of the foot viewed from different directions, the processing section 21B of the present embodiment may display the angle θ_{R} in the roll direction, the angle θ_{Y} in the yaw direction, and the angle θ_{P} in the pitch direction on the display section 25, for example, at different timings.

In this case, for example, the processing section 21B of the present embodiment may change a display target index among the angle θ_{R} in the roll direction, the angle θ_{Y} in the yaw direction, and the angle θ_{P} in the pitch direction in response to an instruction for switching of a viewpoint, given by the user 2. The instruction for switching of a viewpoint, given by the user 2 is input to the pedaling analysis apparatus 20B from the user 2 via the operation section 23.

### 11. Appendix of Embodiments

In the above-described fifth embodiment or sixth embodiment, an attitude in which the sensor unit 40 is mounted on the pedal 33 is not limited to the above-described attitude. If the mounting attitude is known in advance, the pedaling analysis apparatus 20B or 20C can calculate each of the above-described indexes on the basis of outputs from the sensor unit 40.

Similarly, in the above-described seventh embodiment, an attitude in which the sensor unit 40A is mounted on the foot of the user 2 is not limited to the above-described attitude. If the mounting attitude is known in advance, the pedaling analysis apparatus 20B can calculate each of the above-described indexes on the basis of outputs from the sensor unit 40A.

In the above-described fifth or sixth embodiment, the number of detection axes of the angular velocity sensor 44 is one, and the number of detection axes of the acceleration sensor 42 is two, but the number of detection axes of the angular velocity sensor 44 may be increased to two or larger, and the number of detection axes of the acceleration sensor 42 may be increased to three.

In the above-described seventh embodiment, the number of detection axes of the acceleration sensor 42 is two, but the number of detection axes of the acceleration sensor 42 may be increased to three. In this case, for example, the processing section 21 may measure the angle θ_{R}(0) in the roll direction at the initial time point t=0 on the basis of outputs from the acceleration sensor 42.

In the above-described fifth to seventh embodiments, a mounting location of the sensor units 40 and 40A is the right foot side, but may be both of the right foot side and the left foot side. In this case, the processing section 21 (the processing sections 21B and 21C) may measure a pedaling variation (variation in each index) between the left foot and the right foot and display the variation on the display section 25.

In a case where a mounting location of the sensor units 40 and 40A is both of the right foot side and the left foot side, at least the angle θ_{c}′ of the crank 32, the angular velocity ω_{c} of the crank 32, and the angular acceleration ω_{c}′ of the crank 32 are common to the left foot side and the right foot side. Therefore, the processing section 21 (processing sections 21B and 21C) may omit measurement of some indexes for one of the right foot side and the left foot side, and may minimize measurement errors included in the indexes by averaging indexes (at least one of θ_{c}, ω_{c}, and ω_{c}′) of the right foot side and indexes (at least any one of θ_{c}, ω_{c}, and ω_{c}′) of the left foot side.

### 12. Operations and Effects of Embodiments

(1) A pedaling measurement apparatus (pedaling analysis apparatuses 20B and 20C) according to the above-described fifth to seventh embodiments includes an acquisition portion (data acquisition portion 210) that acquires outputs from an inertial sensor which detects motion of a pedal of a bicycle; and a first calculation portion that calculates an attitude (angle θₚ(t)) of the pedal by using angular velocity information (z-axis angular velocity ω(t) which is output from the inertial sensor.

Rotation unevenness of a crank occurring during pedaling of the bicycle may be related to fluctuation in an attitude of the ankle occurring during the pedaling. There is a strong relation between an attitude of the ankle and an attitude of the pedal. Therefore, the first calculation portion calculates an attitude (angle θₚ(t)) of the pedal by using outputs from the inertial sensor. Thus, the pedaling measurement apparatus (the pedaling analysis apparatuses 20B and 20C) can acquire an index useful for analysis of pedaling. A mounting location (fixation location) of the inertial sensor is, for example, the pedal of the bicycle or the foot of a user.

(2) The pedaling measurement apparatus (pedaling analysis apparatuses 20B and 20C) according to the above-described embodiments further includes a second calculation portion that calculates a position (position xₚ(t)) of the pedal on the basis of the attitude (angle θₚ(t)) of the pedal and acceleration information (two-axis accelerations a(t)) which is output from the inertial sensor.

Therefore, the pedaling measurement apparatus (pedaling analysis apparatuses 20B and 20C) can calculate not only an attitude of the pedal but also a position of the pedal.

(3) The pedaling measurement apparatus (pedaling analysis apparatuses 20B and 20C) according to the above-described embodiments further includes a third calculation portion that calculates a rotation center (rotation center position x₀) of a crank of the bicycle on the basis of positions (positions xₚ(Δt), xₚ(2Δt), . . . , and xₚ(2t)) of the pedal at a plurality of time points.

Therefore, the pedaling measurement apparatus (pedaling analysis apparatuses 20B and 20C) can calculate the rotation center of the crank without using an inertial sensor which directly detects motion of the crank.

(4) The pedaling measurement apparatus (pedaling analysis apparatuses 20B and 20C) according to the above-described embodiments further includes a fourth calculation portion that calculates an attitude (angle θ_{c}(t)) of the crank on the basis of the rotation center (rotation center position x₀) and the position (position xₚ(t)) of the pedal.

Therefore, the pedaling measurement apparatus (pedaling analysis apparatuses 20B and 20C) can calculate an attitude of the crank without using an inertial sensor which directly detects motion of the crank.

(5) The pedaling measurement apparatus (pedaling analysis apparatus 20B) according to the above-described embodiments further includes a fifth calculation portion that calculates a rotation angular velocity (angular velocity ω_{c}(t) of the crank on the basis of time differentiation of the attitude (angle θ_{c}(t)) of the crank.

Therefore, the pedaling measurement apparatus (pedaling analysis apparatuses 20B and 20C) can calculate a rotation angular velocity of the crank without using an inertial sensor which directly detects motion of the crank.

(6) The pedaling measurement apparatus (pedaling analysis apparatus 20C) according to the above-described embodiments further includes a sixth calculation portion that calculates a rotation angular velocity (angular velocity ω_{c}(t)) of the crank on the basis of a centripetal acceleration (the centripetal acceleration a₀(t)) obtained by using the acceleration information (two-axis accelerations a(t)) which is output from the inertial sensor, the attitude (angle θ_{c}(t)) of the crank, and the attitude (angle θₚ(t)) of the pedal, and a distance (rotation radius r) from the rotation center to the inertial sensor.

Therefore, the pedaling measurement apparatus (pedaling analysis apparatus 20C) can calculate a rotation angular velocity of the crank without using an inertial sensor which directly detects motion of the crank.

(7) The pedaling measurement apparatus (pedaling analysis apparatuses 20B and 20C) according to the above-described embodiments further includes a presentation portion (display section 25) that presents at least some pieces of information calculated by the calculation portions to the user.

Therefore, the pedaling measurement apparatus (pedaling analysis apparatuses 20B and 20C) can present at least one of the attitude of the pedal, the position of the pedal, the rotation center of the crank, the attitude of the crank, and the rotation angular velocity of the crank to the user.

(8) A pedaling measurement system (pedaling analysis systems S5 and S6) according to the above-described embodiments includes a pedaling measurement apparatus (pedaling analysis apparatuses 20B and 20C) and the inertial sensor (sensor units 40 and 40A).

Therefore, for example, if a user mounts the inertial sensor on the pedal or the foot of the user, the pedaling measurement system (pedaling analysis systems S5 and S6) can acquire an index (an attitude of the pedal) useful for analysis of pedaling.

(9) A pedaling measurement method (pedaling analysis process) according to the above-described embodiments includes an acquisition procedure (step S402) of acquiring outputs from an inertial sensor which detects motion of a pedal of a bicycle; and a first calculation procedure (step S421) of calculating an attitude (angle θₚ(t)) of the pedal by using angular velocity information (z-axis angular velocity ω(t) which is output from the inertial sensor.

Rotation unevenness of a crank occurring during pedaling of the bicycle may be related to fluctuation in an attitude of the ankle occurring during the pedaling. There is a strong relation between an attitude of the ankle and an attitude of the pedal. Therefore, in the first calculation procedure, an attitude (angle θₚ(t)) of the pedal is calculated by using outputs from the inertial sensor. Thus, according to the pedaling measurement method (the pedaling analysis apparatuses 20B and 20C), it is possible to acquire an index useful for analysis of pedaling.

(10) A pedaling measurement program (pedaling analysis program) according to the above-described embodiments causes a computer (processing sections 21B and 21C) to execute an acquisition procedure (step S402) of acquiring outputs from an inertial sensor which detects motion of a pedal of a bicycle; and a first calculation procedure (step S421) of calculating an attitude (angle θₚ(t)) of the pedal by using angular velocity information (z-axis angular velocity ω(t)) which is output from the inertial sensor.

Rotation unevenness of a crank occurring during pedaling of the bicycle may be related to fluctuation in an attitude of the ankle occurring during the pedaling. There is a strong relation between an attitude of the ankle and an attitude of the pedal. Therefore, in the first calculation procedure, an attitude (angle θₚ(t)) of the pedal is calculated by using outputs from the inertial sensor. Thus, the computer (processing sections 21B and 21C) can acquire an index useful for analysis of pedaling.

(11) A recording medium according to the above-described embodiments records a pedaling measurement program (pedaling analysis program) causing a computer (processing sections 21B and 21C) to execute an acquisition procedure (step S402) of acquiring outputs from an inertial sensor which detects motion of a pedal of a bicycle; and a first calculation procedure (step S421) of calculating an attitude (angle θₚ(t)) of the pedal by using angular velocity information (z-axis angular velocity ω(t)) which is output from the inertial sensor.

Rotation unevenness of a crank occurring during pedaling of the bicycle may be related to fluctuation in an attitude of the ankle occurring during the pedaling. There is a strong relation between an attitude of the ankle and an attitude of the pedal. Therefore, in the first calculation procedure, an attitude (angle θₚ(t)) of the pedal is calculated by using outputs from the inertial sensor. Thus, the computer (processing sections 21B and 21C) can acquire an index useful for analysis of pedaling.

(12) A display apparatus (pedaling analysis apparatuses 20B and 20C) according to the above-described embodiments includes a display portion (display section 25) that simultaneously displays information (strip-shaped mark 550) indicating an attitude (angle θₚ(t)) of a pedal of a bicycle and information (images 520 and 530) indicating rotation unevenness of a crank of the bicycle on the same screen, by using angular velocity information (z-axis angular velocity ω(t) which is output from an inertial sensor detecting motion of the pedal of the bicycle.

Rotation unevenness of a crank occurring during pedaling of the bicycle may be related to fluctuation in an attitude of the ankle occurring during the pedaling. There is a strong relation between an attitude of the ankle and an attitude of the pedal. Therefore, the display portion simultaneously displays the rotation unevenness of the crank and the attitude of the pedal on the same screen by using the outputs from the inertial sensor. Thus, the display apparatus of the present embodiment can present an index useful for analysis of pedaling.

(13) A display method (pedaling analysis process) according to the above-described embodiments includes a display procedure (step S414) of simultaneously displaying information (strip-shaped mark 550) indicating an attitude (angle θₚ(t)) of a pedal of a bicycle and information (images 520 and 530) indicating rotation unevenness of a crank of the bicycle on the same screen, by using angular velocity information (z-axis angular velocity ω(t)) which is output from an inertial sensor detecting motion of the pedal of the bicycle.

Rotation unevenness of a crank occurring during pedaling of the bicycle may be related to fluctuation in an attitude of the ankle occurring during the pedaling. There is a strong relation between an attitude of the ankle and an attitude of the pedal. Therefore, in the display procedure (step S414), the rotation unevenness of the crank and the attitude of the pedal are simultaneously displayed on the same screen by using the outputs from the inertial sensor. Thus, according to the display method of the present embodiment, it is possible to present an index useful for analysis of pedaling.

(14) A display program (pedaling analysis process) according to the above-described embodiments causes a computer (processing sections 21B and 21C) to execute a display procedure (step S414) of simultaneously displaying information (strip-shaped mark 550) indicating an attitude (angle θₚ(t)) of a pedal of a bicycle and information (images 520 and 530) indicating rotation unevenness of a crank of the bicycle on the same screen, by using angular velocity information (z-axis angular velocity ω(t)) which is output from an inertial sensor detecting motion of the pedal of the bicycle.

Rotation unevenness of a crank occurring during pedaling of the bicycle may be related to fluctuation in an attitude of the ankle occurring during the pedaling. There is a strong relation between an attitude of the ankle and an attitude of the pedal. Therefore, in the display procedure (step S414), the rotation unevenness of the crank and the attitude of the pedal are simultaneously displayed on the same screen by using the outputs from the inertial sensor. Thus, the computer (processing sections 21B and 21C) can present an index useful for analysis of pedaling.

(15) A recording medium according to the above-described embodiments records a display program causing a computer (processing sections 21B and 21C) to execute a display procedure (step S414) of simultaneously displaying information (strip-shaped mark 550) indicating an attitude (angle θₚ(t)) of a pedal of a bicycle and information (images 520 and 530) indicating rotation unevenness of a crank of the bicycle on the same screen, by using angular velocity information which is output from an inertial sensor detecting motion of the pedal of the bicycle.

Rotation unevenness of a crank occurring during pedaling of the bicycle may be related to fluctuation in an attitude of the ankle occurring during the pedaling. There is a strong relation between an attitude of the ankle and an attitude of the pedal. Therefore, in the display procedure (step S414), the rotation unevenness of the crank and the attitude of the pedal are simultaneously displayed on the same screen by using the outputs from the inertial sensor. Thus, the computer (processing sections 21B and 21C) can present an index useful for analysis of pedaling.

### 13. Other Modification Examples

The invention is not limited the above-described embodiments, and may be variously modified within the scope of the spirit of the invention.

For example, in the above-described embodiments, the acceleration sensor and the angular velocity sensor are built into and are thus integrally formed as the sensor unit, but the acceleration sensor and the angular velocity sensor may not be integrally formed. Alternatively, the acceleration sensor and the angular velocity sensor may not be built into the sensor unit, and may be directly mounted on the pedal or the foot of the user.

In the above-described embodiment, the sensor unit and the pedaling analysis apparatus are separately provided, but may be integrally formed so as to be mounted on the pedal or the foot of the user. The sensor unit may have some of the constituent elements of the pedaling analysis apparatus along with the inertial sensor (for example, the acceleration sensor or the angular velocity sensor).

In other words, some or all of the functions of the pedaling analysis apparatus may be installed on the sensor unit side, and some functions of the sensor unit may be installed on the pedaling analysis apparatus side.

The above-described embodiments and modification examples are only examples, and the invention is not limited thereto. For example, the respective embodiments and the respective modification examples may be combined with each other as appropriate.

The invention includes substantially the same configuration (for example, a configuration in which functions, methods, and results are the same, or a configuration in which objects and effects are the same) as the configuration described in the embodiments. The invention includes a configuration in which an inessential part of the configuration described in the embodiments is replaced with another part. The invention includes a configuration which achieves the same operation and effect or a configuration capable of achieving the same object as in the configuration described in the embodiments. The invention includes a configuration in which a well-known technique is added to the configuration described in the embodiments.

The entire disclosure of Japanese Patent Application No. 2015-161614, filed Aug. 19, 2015 and No. 2015-187914, filed Sep. 25, 2015 and No. 2015-196621, filed Oct. 2, 2015 are expressly incorporated by reference herein.

What is claimed is:

1. A pedaling measurement apparatus comprising:
an acquisition portion that acquires measured data regarding rotation motion of pedaling;
a calculation portion that calculates indexes based on the measured data in correlation with information regarding a rotation angle of the rotation motion; and
a display processing portion that displays the indexes in a coordinate system which indicates the rotation angle by using a position in a circumferential direction of a circle centering on the origin, and which indicates the magnitude of a value by using a distance from the origin.

2. The pedaling measurement apparatus according to claim 1,
wherein a reference position for a rotation angle of a crank matches a reference position for a rotation angle in the coordinate system.

3. The pedaling measurement apparatus according to claim 1,
wherein the indexes include an angular velocity, and
wherein the distance from the origin indicates the angular velocity.

4. The pedaling measurement apparatus according to claim 1,
wherein the indexes include an angular acceleration, and
wherein the distance from the origin indicates the angular acceleration.

5. The pedaling measurement apparatus according to claim 1,
wherein the calculation portion calculates at least one of an average value, a median, and a most frequent value of the indexes at each rotation angle for a plurality of rotations, and
wherein the display processing portion disposes at least one of the average value, the median, and the most frequent value of the indexes in the coordinate system.

6. The pedaling measurement apparatus according to claim 1, further comprising:
a determination portion that determines a first index which is more than or less than a predetermined threshold value among the indexes for the respective rotation angles,
wherein the display processing portion performs a notification of a position of the first index in the coordinate system.

7. The pedaling measurement apparatus according to claim 6,
wherein the display processing portion displays an image for specifying a rotation angle corresponding to the position of the first index.

8. The pedaling measurement apparatus according to claim 6,
wherein the display processing portion displays the first index in an aspect which is different from aspects of other indexes.

9. The pedaling measurement apparatus according to claim 1,
wherein the acquisition portion acquires a comparative target index for a rotation, and
wherein the display processing portion disposes the comparative target index in the coordinate system.

10. The pedaling measurement apparatus according to claim 1,
wherein the calculation portion calculates the indexes for a plurality of rotations, and
wherein the display processing portion disposes the indexes for the plurality of rotations in the coordinate system.

11. The pedaling measurement apparatus according to claim 1,
wherein the calculation portion calculates an offset target value on the basis of the indexes, and offsets the indexes by using the offset target value, and
wherein the display processing portion correlates the origin with the offset target value.

12. The pedaling measurement apparatus according to claim 1,
wherein the calculation portion calculates variation extents of the indexes at each rotation angle for a plurality of rotations, and
wherein the display processing portion displays the variation extents in correlation with the rotation angles.

13. The pedaling measurement apparatus according to claim 12, further comprising:
a determination portion that determines a first variation extent which is larger than or less than a predetermined threshold value among the variation extents,
wherein the display processing portion performs a notification of a position of a rotation angle corresponding to the first variation extent.

14. The pedaling measurement apparatus according to claim 1, further comprising:
a determination portion that determines whether or not at least some of the plurality of indexes satisfy a predetermined condition,
wherein the display processing portion outputs advice information corresponding to the predetermined condition in a case where there is an index satisfying the predetermined condition.

15. The pedaling measurement apparatus according to claim 6,
wherein the acquisition portion acquires second measured data related to motion of a user or a bicycle,
wherein the calculation portion calculates a second index regarding the motion of the user or the bicycle on the basis of the second measured data, and
wherein the display processing portion displays the second index.

16. The pedaling measurement apparatus according to claim 15,
wherein the calculation portion correlates the indexes at the rotation angles and the second index with time points, and
wherein the display processing portion displays a position of the second index in correlation with the position of the first index on the basis of the time points.

17. A pedaling measurement method comprising:
acquiring measured data regarding rotation motion of pedaling;
calculating indexes based on the measured data in correlation with information regarding a rotation angle of the rotation motion; and
displaying the indexes in a coordinate system which indicates the rotation angle by using a position in a circumferential direction of a circle centering on the origin, and which indicates the magnitude of a value by using a distance from the origin.

18. A pedaling measurement system comprising:
a sensor unit that measures rotation motion of pedaling; and
a measurement apparatus,
wherein the measurement apparatus includes
an acquisition portion that acquires measured data regarding the rotation motion from the sensor unit;
a calculation portion that calculates indexes based on the measured data in correlation with information regarding a rotation angle of the rotation motion; and
a display processing portion that displays the indexes in a coordinate system which indicates the rotation angle by using a position in a circumferential direction of a circle centering on the origin, and which indicates the magnitude of a value by using a distance from the origin.

19. A recording medium storing a program causing a computer to execute:
a procedure of acquiring measured data regarding rotation motion of pedaling;
a procedure of calculating indexes based on the measured data in correlation with information regarding a rotation angle of the rotation motion; and
a procedure of displaying the indexes in a coordinate system which indicates the rotation angle by using a position in a circumferential direction of a circle centering on the origin, and which indicates the magnitude of a value by using a distance from the origin.
